(19) United States
(12) Patent Application Publication
(10) Pub. No.: US 2024/0028599 A1
(43) Pub. Date: Jan. 25, 2024

(54) SYSTEM AND METHOD FOR TRANSPARENT GREENHOUSE GAS EMISSIONS VALIDATION AND REPORTING FOR AN END PRODUCT

(71) Applicant: Dell Products, LP, Round Rock, TX (US)

(72) Inventors: Deeder M. Aurongzeb, Austin, TX (US); Malathi Ramakrishnan, Madurai (IN); Parminder Singh Sethi, Punjab (IN)

(73) Assignee: Dell Products, LP, Round Rock, TX (US)

(21) Appl. No.: 17/866,018

(22) Filed: Jul. 15, 2022

(51) Int. Cl. G06F 16/2457; G06F 16/25; G06F 16/2452; G06Q 50/26

(52) U.S. Cl. CPC G06F 16/24575; G06F 16/252; G06F 16/24524; G06Q 50/26

(57) ABSTRACT

A system and a method of reporting greenhouse gas (GHG) emissions based on transparently gathered and verified data may comprise receiving a query, via a graphical user interface (GUI), identifying an end-product, retrieving from a database repository an overall GHG emission value determined based on a GHG emission equation and a plurality of data field values of reported GHG emissions stored in the database repository and having a secure source and chain of possession as verified by a database management system (DBMS) platform orchestrating access to the database repository, determining a distributed GHG emission value describing GHG emitted during manufacture of the end-product, based on the overall GHG emission value and a number of the end-products manufactured and supply chain reporting over a reporting period, and displaying the distributed GHG emission value via the GUI.

### FIELD OF THE DISCLOSURE

The present disclosure generally relates to gathering and validation of data for reporting of greenhouse gases (GHG) emitted by a manufacturer. More specifically, the present disclosure relates to a system for transparently gathering and validating data from multiple manufacturers in a supply chain for a final product and reporting GHG emissions across the supply chain specifically attributable to that final product to end users.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, video communication capabilities, and audio capabilities.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2A is a block diagram illustrating raw materials and product manufacturing portions of a supply chain according to an embodiment of the present disclosure;

FIG. 2B is a block diagram illustrating product manufacturing and consumer portions of a supply chain according to an embodiment of the present disclosure;

FIG. 2C is a block diagram illustrating a database management system (DBMS) control platform in communication with multiple entities in a supply chain according to an embodiment of the present disclosure;

FIG. 3 is a block diagram illustrating the DBMS control platform retrieving and verifying data from supply chain entities according to an embodiment of the present disclosure;

FIG. 4 is a block diagram illustrating a global data repository storing data retrieved from a plurality of supply chain entities according to an embodiment of the present disclosure;

FIG. 5A is a graphical diagram illustrating a greenhouse gas (GHG) type selector of a graphical user interface (GUI) according to an embodiment of the present disclosure;

FIG. 5B is a graphical diagram illustrating a GHG emission determination filter of a GUI according to an embodiment of the present disclosure;

FIG. 6A is a graphical diagram illustrating a GUI reporting GHG emitted during manufacture of a product in a pie chart view according to an embodiment of the present disclosure;

FIG. 6B is a graphical diagram illustrating a GUI reporting GHG emitted during manufacture of a product in a timeline view according to an embodiment of the present disclosure;

FIG. 6C is a graphical diagram illustrating a GUI reporting GHG emitted during manufacture of a product in a network view according to an embodiment of the present disclosure;

FIG. 6D is a graphical diagram illustrating a GUI reporting GHG emitted during manufacture of a product in a map view according to an embodiment of the present disclosure;

FIG. 7 is a flow diagram illustrating a method of gathering and verifying information necessary to determine GHG emissions generated pursuant to manufacture of a product according to an embodiment of the present disclosure;

FIG. 8 is a flow diagram illustrating a method of determining GHG emissions generated pursuant to manufacture of a single product according to an embodiment of the present disclosure; and

FIG. 9 is a flow diagram illustrating a method of determined GHG emissions generated pursuant to manufacture of a product for according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

The ability to quickly, efficiently, and accurately determine how much greenhouse gases are emitted during manufacture and transport of consumer products is becoming increasingly important as governments around the world contemplate or enact laws requiring auditing of such information. For example, at least 40 countries around the globe, including parties to the Paris Agreement, require manufacturing, waste, utilities, and resource mining facilities or companies to measure and report their greenhouse gas (GHG) emissions periodically. These reports create a data pool that leaders can use to inform environmental policy decisions and track their enforcement progress. Further, consumers are placing an ever increasing value on minimizing GHG emissions generated during manufacture of products they purchase. In other words, the size of GHG emissions generated during manufacture of a product is projected to sway an end consumer's purchasing decision to an increasingly large degree over the coming years.

Determination of GHGs emitted during manufacture of a product is a complex process that includes data gathering and analysis of procedures followed at every step of the supply chain, between the raw materials supplier and the end consumer of a single product. Such processes may include natural resource extraction, chemical or materials (e.g., plastics) manufacturing, subcomponent manufacturing, product manufacturing (e.g., through integration of multiple subcomponents), packaging, transport (e.g., of raw materials, subcomponents and end products), generation of waste, and consumption of electricity, petroleum products, water by each facility within the supply chain (e.g., raw materials supplier, one or more manufacturing plants, storage facilities, etc.). The determination of GHG emitted at any step of the supply chain may also be impacted by pro-environmental or green policies enforced by one or more entities within the supply chain. For example, recycling and refurbishment programs may decrease the volume of solid waste sent to landfills and the volume of new subcomponents or products generated by a given manufacturing plant, thus directly decreasing the volume of GHG emitted by that plant during a particular reporting period.

The Environmental Protection Agency of the United States currently only provides verified public information for greenhouse gases emitted by facilities and companies involved with the edges of the supply chain, such as resource extraction, chemical and mineral refining, waste management, and suppliers of electricity, water, petroleum and natural gases. However, more information may be available or required in the future. Thus, information on GHG emissions by several portions of the supply chain involved in manufacture of a given product may be made available to the public voluntarily, without undergoing external auditing and verification. Finally, even when companies within the supply chain of a final product for end consumer consumption accurately and voluntarily publicly provide a gauge of their GHG emissions, it is unclear what volume of those GHG emissions are attributable to the manufacture of a single product for end-user consumption.

This may be the case because manufacturing companies usually determine GHG emissions on a per-plant or per-facility basis, rather than a per-product or end unit basis. This may also be the case because the company providing such a gauge of their individual GHG emissions is only one step in the supply chain for manufacture of that product, and that company does not have access to the GHG emissions from other steps within the supply chain. For example, a manufacturer that integrates multiple subcomponents from various vendors into a final product for direct sale to the end consumer may not have access to accurate reporting of GHG emissions by each of these various vendors or suppliers. Such GHG emissions by parties earlier in the supply chain may be referred to herein as “indirect emissions” by the end product manufacturer. As another example, a manufacturer of subcomponents may not gauge, report, or verify which portion of GHG emissions generated at a given subcomponent manufacturing plant are attributable to the specific subcomponents shipped to the final product manufacturer for integration within the final product. A system is needed to gather and verify accurate information for determination of GHG emissions by each entity within the supply chain and to determine which portion of such an overall GHG emission (e.g., as generated throughout the entire supply chain for a given end product) is attributable to manufacture and transportation of a single end-user product.

The transparent GHG emissions validation and reporting service system in embodiments of the present disclosure address this issue by gathering, verifying, and reporting information from each entity within the supply chain necessary to determine GHG emissions generated pursuant to manufacture of a single end product for consumers. In embodiments described herein, the transparent GHG emissions validation and reporting service system may operate within a database management system (DBMS) control platform that gathers, verifies, sorts, stores, queries, and retrieves operational data in databases for one or more entities within the supply chain for a single end-user product. For example, the DBMS control platform in an embodiment may operate as a cloud-based service to store sensor data, shipping and tracking information, accounting information, inventory data, utility billing information, customer and vendor contact information, invoices, or any other form of data routinely collected or generated during the normal course of business for a manufacturing facility or resource extraction facility within the supply chain. In other embodiments, the DBMS control platform may access similar information stored locally or in a separate cloud-based service by one or more entities within the supply chain, pursuant to agreements between parties within the supply chain. In some cases, each entity within the supply chain may use the same DBMS control platform to manage data.

Data used to determine GHG emissions in embodiments may be routinely gathered and stored at the DBMS control platform or other databases accessible by the DBMS control platform in existing systems. The transparent GHG emissions validation and reporting service system in embodiments may additionally identify a sub-portion of such data that can be used to determine GHG emissions, verify the authenticity of that data, and store the verified data in a global data repository accessible by the DBMS control platform for determination of GHG emissions for any of the entities within the supply chain. In other words, the global data repository may contain data gathered from each of the entities within the supply chain such that GHG emissions for all of the entities within the supply chain may be determined and reported to any of those entities.

The transparent GHG emissions validation and reporting service system in embodiments may further ensure security and accuracy of data stored within the global data repository according to authorizations preset by each of the entities within the supply chain prior to gathering of data. For example, multiple subcomponent manufacturers may enter into an agreement with a product manufacturer that integrates those subcomponents into a final product. Such an agreement may allow the DBMS control platform to determine and report to the product manufacturer the portion of GHG emissions generated during manufacture of subcomponents, by each of the subcomponent manufacturers, that are later integrated within the final product. Data gathered from each of the subcomponent manufacturers may include immutable blockchain information ensuring the data has not been tampered with, or, if the data has been tampered with, providing a simple method of identifying the time and identity of the person or entity attempting to tamper with the data.

Further, the transparent GHG emissions validation and reporting service system may gather data measuring the same values from multiple sources and compare those values to confirm all sources are reporting accurately. For example, information regarding shipment times, distances, and fuel consumption used to determine GHG emissions during transport of subcomponents to an end product manufacturer may be drawn from a manifest controlled by the subcomponent manufacturer and from another manifest controlled by the product manufacturer. Because both manifests describe the same trip, the data values gathered from these two manifests should match or fall within a relative variance that may be expected. However, a subcomponent manufacturer attempting to artificially deflate or otherwise alter its GHG emissions may alter the data within the manifest controlled by it. In such a case, or in any case where data values from two separate sources do not match or fall within a reasonable variance, the transparent GHG emissions validation and reporting service system may report this mismatch and identify the time of entry of mismatched data, as well as the entities (e.g., employee name) that provided the mismatched information.

Still further, the transparent GHG validation and reporting service system may compare determined GHG emissions values for multiple manufacturers of the same or similar components in embodiments of the present disclosure. For example, the transparent GHG validation and reporting service system may notify a product manufacturer when the GHG emissions for one of a group of manufacturers for the same subcomponent do not match or differ markedly from the GHG emissions for the remainder of the group of subcomponent manufacturers. This may indicate that the outlier subcomponent manufacturer, or one or more reporting persons there, has tampered with or misreported data used during determination of its GHG emissions. In other instances, this may indicate the outlier subcomponent manufacturer has developed a more environmentally-friendly manufacturing process. In either case, identification of the outlier subcomponent manufacturer in embodiments may assist the product manufacturer in determining which subcomponent manufacturers to engage in the future (e.g., preferring a more environmentally-friendly subcomponent manufacturer or avoiding a subcomponent manufacturer erroneously reporting GHG emissions).

The same agreement between entities at multiple stages of the supply chain (e.g., between the subcomponent manufacturer and the product manufacturer) may restrict or disallow the product manufacturer to access or change data owned by the subcomponent manufacturer, stored within the global data repository, and used by the DBMS to determine the portion of GHG emissions generated during manufacture of the subcomponents integrated within the final product. In such a way, the transparent GHG emissions validation and reporting service system and the DBMS control platform in embodiments described herein may gather from multiple entities within the supply chain and verify the authenticity of data used to determine GHG emissions generated during manufacture of a specific subcomponent or end product, while preventing tampering or misreporting.

The transparent GHG emissions validation and reporting service system in embodiments described herein may further provide reporting of GHG emissions generated during manufacture of a specific subcomponent or end product to any portion of the supply chain authorized to view such information, regardless of whether that entity is authorized to access the data underlying such a determination. For example, the transparent GHG emissions validation and reporting service system may report to a product manufacturer the volume of GHG emitted during manufacture of a specific subcomponent within the final product without reporting the total volume of GHG emitted by the subcomponent manufacturing facility vendor, any financial data for the vendor (e.g., number of subcomponents manufactured per month/year), or information regarding subcomponents not used in the final product or sold to competing product manufacturers. The transparent GHG emissions validation and reporting service system may provide several different formats for such reporting in various embodiments described herein, including a pie chart differentiating GHG emissions at each step of the supply chain, a network view or a map view comparing GHG emissions from each entity of the supply chain, or a timeline showing a cumulative measure of GHG emissions over the entire manufacturing time period. In such a way, the transparent GHG emissions validation and reporting service system and the DBMS control platform in embodiments described herein may report to multiple entities within the supply chain GHG emissions generated during manufacture of a specific subcomponent or end product, without compromising security of the underlying data used to determine such GHG emissions.

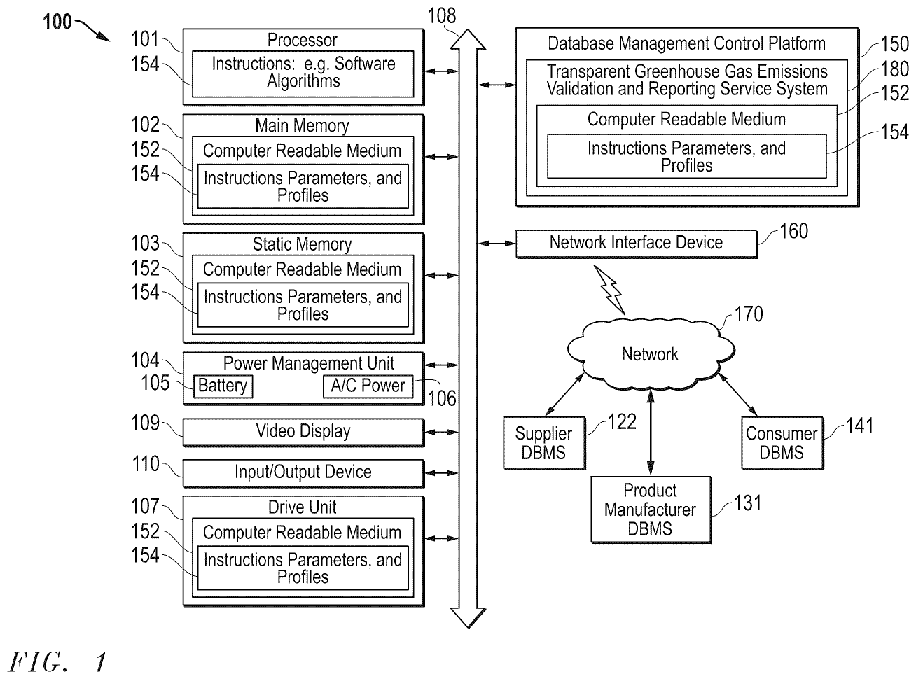

FIG. 1 illustrates an information handling system 100 according to several aspects of the present disclosure. In particular, in the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), a server (e.g., blade server or rack server), a wired or wireless docking station for a mobile information handling system, a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a tablet computer, a desktop computer, an augmented reality system, a virtual reality system, a communications device, an access point (AP), a base station transceiver, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a server or as a client computer in a server-client network environment, or as a peer computer system in a peer-to-peer (or distributed) network environment. In a particular embodiment, the information handling system 100 may be implemented using electronic devices that provide voice, video or data communication. Further, while a single information handling system 100 is illustrated, the term “system” shall also be taken to include any collection of systems or sub-systems that individually or jointly execute a set, or multiple sets, of instructions to perform one or more computer functions.

The information handling system 100 may include a memory 102, (with computer readable medium 152 that is volatile (e.g. random-access memory, etc.), nonvolatile memory (read-only memory, flash memory etc.) or any combination thereof), one or more processing resources, such as a central processing unit (CPU), a graphics processing unit (GPU), a Visual Processing Unit (VPU) or a Hardware Accelerator, any one of which may be the processor 101 illustrated in FIG. 1, hardware or software control logic, or any combination thereof. Additional components of the information handling system 100 may include one or more storage devices 103 or 107, a wireless network interface device 160, one or more communications ports for communicating with external devices, as well as various input and output (I/O) devices 110, such as a keyboard, a mouse, touchpad or any combination thereof. A power management unit 104 supplying power to the information handling system 100, via a battery 105 or an alternating current (A/C) power adapter 106 may supply power to one or more components of the information handling system 100, including the processor 101, the wireless network interface device 160, a static memory 103 or drive unit 107, a database management control platform 150, a video display 109 or other components of an information handling system. The video display 109 in an embodiment may function as a liquid crystal display (LCD), an organic light emitting diode (OLED), a flat panel display, or a solid-state display. The information handling system 100 may also include one or more buses (e.g., 108) operable to transmit communications between the various hardware components. Portions of an information handling system 100 may themselves be considered information handling systems 100 in the embodiments presented herein.

Information handling system 100 may include devices or modules that embody one or more of the devices or execute instructions for the one or more systems and modules described herein, and operates to perform one or more of the methods described herein. The information handling system 100 may execute code instructions 154 that may operate on servers or systems, remote data centers, or on-box in individual client information handling systems 100 according to various embodiments herein. In some embodiments, it is understood any or all portions of code instructions 154 may operate on a plurality of information handling systems 100.

The information handling system 100 may include a processor 101 such as a central processing unit (CPU), a GPU, a Visual Processing Unit (VPU), or a hardware accelerator, embedded controllers or control logic or some combination of the same. Any of the processing resources may operate to execute code that is either firmware or software code. Moreover, the information handling system 100 may include memory such as main memory 102, static memory 103, containing computer readable medium 152 storing instructions 154. In an embodiment, information handling system 100, or portions thereof, may represent an end-user product that results from vendor-supplied subcomponents assembled and delivered to a consumer. In other embodiments, information handling system 100 may be a server or system executing instructions 154 that may include a transparent greenhouse gas (GHG) emissions validation and reporting service system 140, database management (DBMS) control platform 150, operating system (OS) software, application software, BIOS software, or other software applications or drivers detectable by processor type 101.

The disk drive unit 107 and static memory 103 may also contain space for data storage in a computer readable medium 152. The instructions 154 in an embodiment may reside completely, or at least partially, within the main memory 102, the static memory 103, and/or within the disk drive 107 during execution by the processor 101. The information handling system 100 may also include one or more buses 108 operable to transmit communications between the various hardware components such as any combination of various input and output (I/O) devices 110, or the like.

The network interface device 160 may provide connectivity of the information handling system 100 to the network 170 via a dedicated link, a network AP or base station in an embodiment. The network 170 in other embodiments may be a wired local area network (LAN), a wireless personal area network (WPAN), a wireless Local Area Network (WLAN), such as a public Wi-Fi communication network, a private Wi-Fi communication network, or other non-cellular communication networks. In other embodiments, the network 170 may be a wired wide area network (WAN), a wireless wide area network (WWAN), such as a 4G LTE public network, or a 5G communication network, or other cellular communication networks, including future protocol communication networks such as upcoming 6G protocols under development. Connectivity to any of a plurality of networks 170, one or more APs for those networks, or to a docking station in an embodiment may be via wired or wireless connection. In some aspects of the present disclosure, the network interface device 160 may operate two or more wireless links. In other aspects of the present disclosure, the information handling system 100 may include a plurality of network interface devices, each capable of establishing a separate wireless link to network 170, such that the information handling system 100 may be in communication with network 170 via a plurality of wireless links.

The network interface device 160 may operate in accordance with any cellular wireless data communication standards. To communicate with a wireless local area network, standards including IEEE 802.11 WLAN standards, IEEE 802.15 WPAN standards, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax including Wi-Fi 6 and Wi-Fi 6e. It is understood that any number of available channels may be available in WLAN under the 2.4 GHz, 5 GHz, or 6 GHz bands which may be shared communication frequency bands with WWAN protocols in some embodiments.

The network interface device 160, in other embodiments, may connect to any combination of cellular wireless connections including 2G, 2.5G, 3G, 4G, 5G or the like from one or more service providers or privately administered by an enterprise. Utilization of radiofrequency communication bands according to several example embodiments of the present disclosure may include bands used with the WWAN standards, which may operate in both licensed and unlicensed spectrums. More specifically, the network interface device 160 in an embodiment may transceive within radio frequencies associated with the 5G New Radio (NR) Frequency Range 1 (FR1) or Frequency Range 2 (FR2). NRFR1 may include radio frequencies below 6 GHz, also sometimes associated with 4G LTE and other standards predating the 5G communications standards. NRFR2 may include radio frequencies above 6 GHz, made available within the emerging 5G communications standard. Frequencies related to the 5G networks may include high frequency (HF) band, very high frequency (VHF) band, ultra-high frequency (UHF) band, L band, S band, C band, X band, Ku band, K band, Ka band, V band, W band, and millimeter wave bands.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations may include distributed processing, component/object distributed processing, and parallel processing. Alternatively, virtual computer system processing may be constructed to implement one or more of the methods or functionalities as described herein.

The present disclosure contemplates a computer-readable medium that includes instructions, parameters, and profiles 154 or receives and executes instructions, parameters, and profiles 154 responsive to a propagated signal, so that a device connected to a network 170 may communicate voice, video or data over the network 170. Further, the instructions 154 may be transmitted or received over the network 170 via the network interface device 160. The information handling system 100 may include a set of instructions 154 that may be executed to cause the computer system to perform any one or more of the methods or computer-based functions disclosed herein, such as gathering, analyzing, verifying, and reporting GHG emissions associated with manufacture or an end-product information handling system in some embodiments. For example, instructions 154 may include a particular example of a transparent GHG emissions validation and reporting service system 140, or other aspects or components. Various software modules comprising application instructions 154 may be coordinated by an operating system (OS), and/or via an application programming interface (API). An example operating system may include Windows®, Android®, and other OS types. Example APIs may include Win 32, Core Java API, or Android APIs. Application instructions 154 may also include any application processing drivers, or the like executing on information handling system 100.

The transparent GHG emissions validation and reporting service system 140 may utilize a computer-readable medium 152 in which one or more sets of instructions 154 may operate in part as software or firmware instructions executed on the information handling system 100. The instructions 154 may embody one or more of the methods or logic as described herein. For example, instructions relating to the wireless communication device pairing system 140, firmware or software algorithms, processes, and/or methods may be stored here. Such instructions 154 may comprise gathering, verifying, and reporting information from each entity within a supply chain for manufacture of a final product that is necessary to determine GHG emissions generated pursuant to manufacture of that single end product. The transparent GHG emissions validation and reporting service system 140 may operate within a database management system (DBMS) control platform 150 that gathers, verifies, sorts, stores, queries, and retrieves operational data in databases for one or more entities within the supply chain for a single end-user product. For example, the DBMS control platform 150 in an embodiment may operate as a cloud-based service to store data within memory 102, static memory 103, or computer readable medium 152 received via network 170 and the network interface device 160 from the final product consumer, the product manufacturer, a sub-component manufacturer, or a raw material supplier. As another example, the DBMS control platform 150 in an embodiment may operate to query and retrieve data stored remotely from the information handling system 100 via the network interface device 160 and network 170. More specifically, such data may be stored at, queried, and retrieved from a supplier DBMS 121, a product manufacturer DBMS 131, or an end-consumer DBMS 141.

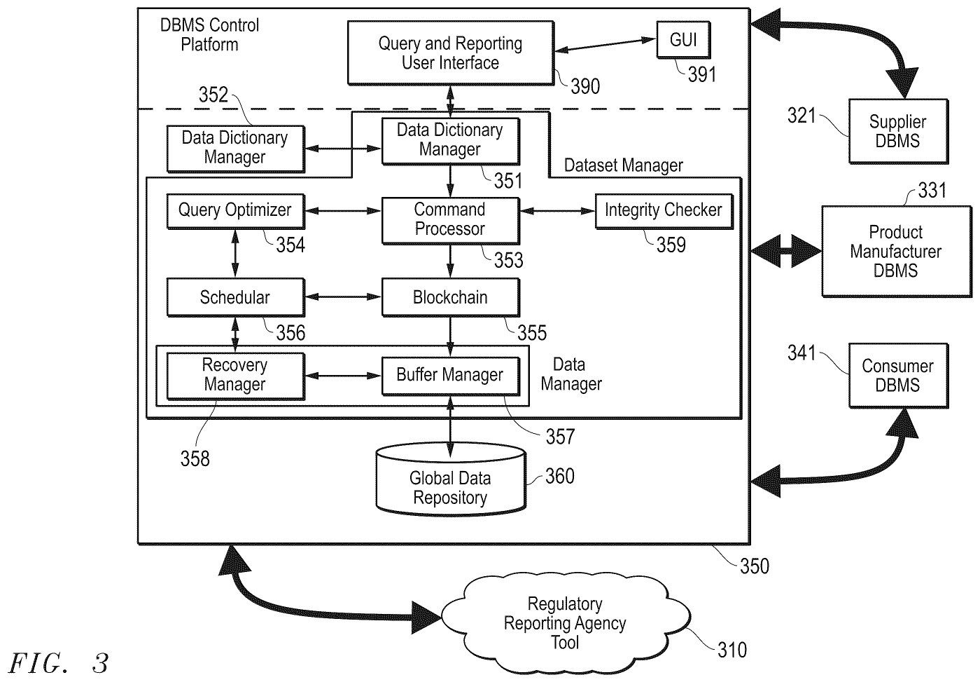

Main memory 102 may contain computer-readable medium (not shown), such as RAM in an example embodiment. An example of main memory 102 includes random access memory (RAM) such as static RAM (SRAM), dynamic RAM (DRAM), non-volatile RAM (NV-RAM), or the like, read only memory (ROM), another type of memory, or a combination thereof. Static memory 103 may contain computer-readable medium (not shown), such as NOR or NAND flash memory in some example embodiments. The instructions, parameters, and profiles 154 of the transparent GHG emissions validation and reporting service system 140 may be stored in static memory 103, or the drive unit 107 on a computer-readable medium 152 such as a flash memory or magnetic disk in an example embodiment. More specifically, computer readable medium 152 in an embodiment may store protocols, authorizations, or data field name identifiers that dictate which entities can access certain data field values, either directly, or indirectly in the form of GHG emission values determined based on those data field values, as described in greater detail with respect to FIG. 3, below.

While the computer-readable medium is shown to be a single medium, the term “computer-readable medium” includes a single-medium or multiple-media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to store information received via carrier wave signals such as a signal communicated over a transmission medium. Furthermore, a computer readable medium may store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In some embodiments, dedicated hardware implementations such as application specific integrated circuits, programmable logic arrays and other hardware devices may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein may be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module may include software, including firmware embedded at a device, such as an Intel® Core class processor, ARM® brand processors, Qualcomm® Snapdragon processors, or other processors and chipsets, or other such device, or software capable of operating a relevant environment of the information handling system. The system, device, controller, or module may also include a combination of the foregoing examples of hardware or software. In an embodiment an information handling system 100 may include an integrated circuit or a board-level product having portions thereof that may also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another may communicate directly or indirectly through one or more intermediaries.

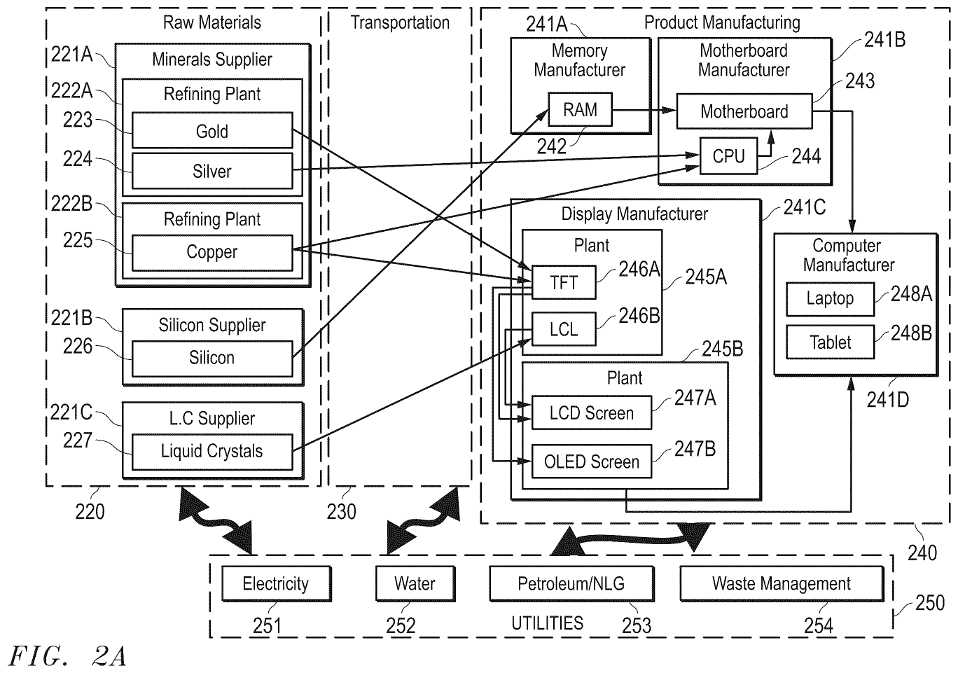

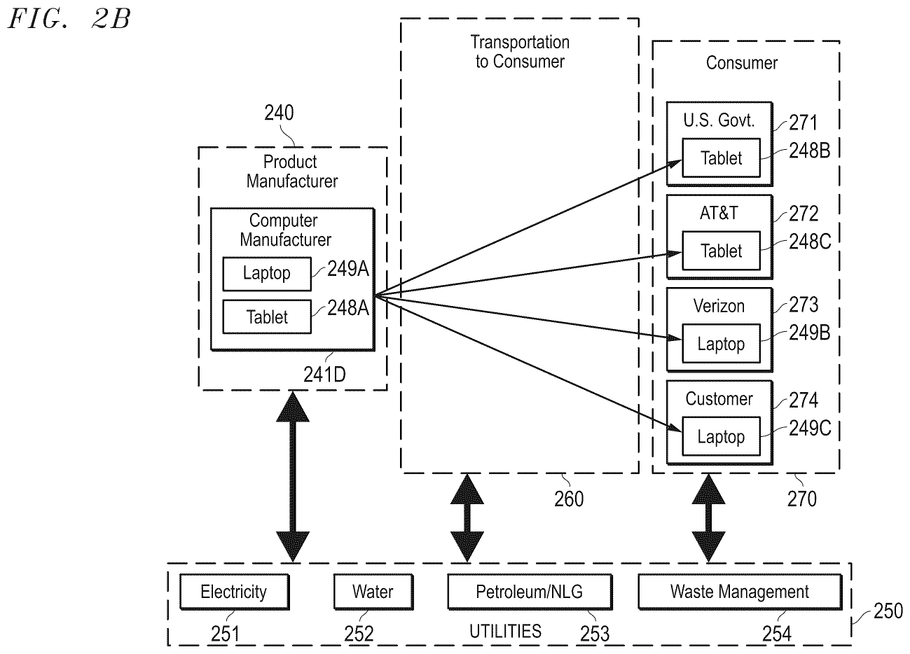

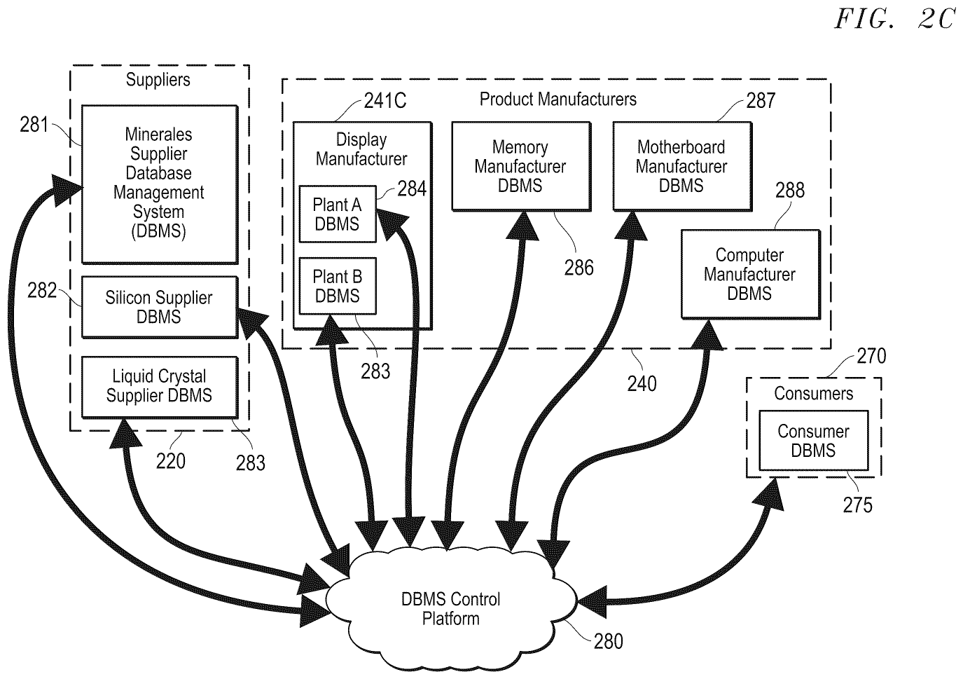

FIG. 2A is a block diagram illustrating several entities in the raw materials and product manufacturing portions of a supply chain for an end product, such as an information handling system 248A or 248B according to an embodiment of the present disclosure. The beginning of a supply chain for manufacture of a product, such as an information handling system 248A or 248B, or information handling system subcomponents in an embodiment, as described with reference to FIG. 2A may include a raw materials supply sector 220, a first transportation sector 230 operating to transport raw materials to a product manufacturing sector 240. Further, each of these sectors (e.g., 220, 230, and 240) may access and consume one or more resources or services from a utilities sector 250. Each of these sectors (e.g., 220, 230, 240, and 250) may emit greenhouse gases (GHGs) during their course of business.

The raw materials sector 220 in an example embodiment may include suppliers of one or more types of raw materials, such as minerals, chemicals, or polymers. For example, the raw materials sector 220 may include a minerals suppler 221A, a silicon supplier 221B, and a liquid crystal supplier 221C. Each supplier may operate one or more plants. For example, silicon supplier 221B may produce silicon 226 via a single plant, liquid crystal supplier 221C may produce liquid crystals 227 via a single plant, while minerals suppler 221A operates a first refining plant 222A and a second refining plant 222B. Each plant in an embodiment may produce one or more raw materials. For example, minerals supplier refining plant 222B may produce only copper 225 while minerals supplier refining plant 222A produces both gold 223 and silver 224.

Production of each of these raw materials (e.g., gold 223, silver 224, copper 225, silicon 226, and liquid crystals 227) results in the emission of greenhouse gases (GHGs) through a variety of means. First, the extraction process and refinement process result in direct GHG emissions from heavy machinery burning fossil fuels to remove unrefined ore from the earth and from generation of byproducts of the refinement processes themselves. Second, each plant operating to perform these processes requires electricity 251, water 252, and possible petroleum or natural gas 253 (e.g., to heat the facility). Consumption of each of these utilities 250 in an embodiment also results in GHG emissions (e.g., from fossil fuel burning at electrical plants to produce electricity or from transportation of water, petroleum, or natural gas to a raw materials supplier). Third, each raw material (e.g., gold 223, silver 224, copper 225, silicon 226, liquid crystals 227) may be shipped to a remotely located entity within the product manufacturing sector 240 for incorporation of the raw materials into a final product. Transport of these raw materials through a first transportation sector 230 may directly emit GHGs through the burning of fossil of fuels (e.g., trains, planes, trucks, ships, etc.), or through consumption of electricity (e.g., hybrid vehicles, electric trains, etc.).

Most raw materials suppliers (e.g., 221A, 221B, and 221C) are required to routinely determine, verify, and report all GHG emissions generated during manufacturing, extraction, and refining processes to some governmental agency described above. For example, the Environmental Protection Agency (EPA) for the U.S. Government provides GHG emissions statistics publicly for most resource extraction (e.g., mined or quarried products like metals, sand, gravel, stone, clay), mineral producers (e.g., cement, glass, lime, soda ash, and other nonmetallic mineral products), chemical and petroleum refiners, and plastics manufacturers. However, these statistics are reported on a per company (e.g., minerals supplier 221A) basis, or a per-facility (e.g., refining plant 222A) basis. In other words, the publicly provided statistics for the raw materials sector 220 do not describe GHG emissions for a particular product for end consumer use. Further, these publicly available statistics do not incorporate GHG emissions produced during transport 230 between the raw materials sector 220 and the product manufacturing sector 240. However, GHG emissions produced during such transportation may be determined based on the type of transportation used (e.g., plane, train, ship, truck), type of fuel consumed (e.g., ethanol, gasoline, diesel), and the mileage of shipment. Again, because these shipments routinely contain bulk volumes of a given material (e.g., copper 225), the calculated GHG emissions for a given delivery within the transportation sector 230 may not describe the portion of those GHG emissions that are attributable to a final product manufactured using a small subset of that bulk volume.

Determining GHG emissions for the product manufacturing sector 240 presents further complications due to the internal complexity of the product manufacturing sector 240 entities. The product manufacturing sector 240 in an embodiment may itself include subsets of a supply chain. For example, what one manufacturer would consider its “end product” may be further incorporated by another manufacturer within what this second manufacturer would consider its “end product.” More specifically, a memory manufacturer 241A may consider a unit of Random Access Memory (RAM) 242 as its end product. However, a motherboard manufacturer 241B may incorporate these RAM units 242 into motherboards 243, which the motherboard manufacturer 241B may consider its end product. Finally, a computer manufacturer 241D may incorporate these motherboards 243 into laptop 248A, which the computer manufacturer 241D may consider its end product. Products that are manufactured for later incorporation into another product may be considered to be subcomponents of the later integrated product.

In the simplest case for determination of GHG emissions, a single product manufacturer (e.g., memory manufacturer 241A) directly produces what it considers to be an end product (e.g., RAM 242) using raw materials (e.g., silicon 226) received from the raw materials sector 220. In such a scenario, the memory manufacturer 241A may generate direct GHG emissions during the manufacture of RAM 242. For example, GHG may be generated through burning of fossil fuels by heavy machinery, consumption of electricity and other utilities by manufacturing facilities (e.g., even in portions of a plant not specifically dedicated to manufacturing processes, such as personnel administration, security, storage, computing servers, air conditioning, heating, etc.), certain manufacturing processes (e.g., chemical etching, laser ablation, other chemical reactions, etc.), and generation of waste (e.g., solid and liquid). Data used to determine such direct GHG emissions may be gathered through various sensors, meters, utility bills, inventory records, and shipping and tracking labels (e.g., identifying a location of a product or component within a facility over time), for example. Some utilities sector 250 entities (e.g., electricity provider 251) may be required to report GHG emissions for generation of electricity (e.g., through burning of fossil fuels) to the EPA or another governmental agency. Again, when this occurs, reports for GHG emissions are provided on a per-facility or per-company basis untethered to the end product of the supply chain.

In order to determine the GHG emitted during manufacture of RAM 242 in an embodiment, data must be gathered and analyzed to determine the GHG emitted not only during direct manufacture of the RAM 242 at the memory manufacturer 241A, but also through extraction, refinement, and transportation of silicon 226 to memory manufacturer 241A. All GHG emissions generated prior to beginning the manufacturing process for the RAM 242 at memory manufacturer 241A in an embodiment (e.g., extraction, refinement, and transportation of silicon 226) may be referred to herein as indirect emissions with respect to manufacture of the RAM 242. Indirect emissions incorporate all emissions generated at earlier stages of the supply chain for a given product. As described above, such indirect emissions (as labeled with respect to the manufacture of RAM 242 by memory manufacturer 241A) may be determined via access to publicly available GHG emissions data for the raw materials sector 220, and through analysis of transportation sector 230 transport type, fuel type, and mileage.

Many product manufacturing sector 240 manufacturers (e.g., memory manufacturer 241A) routinely monitor, calculate, validate, and report their GHG emissions, either as required by the EPA (e.g., for electronics manufacturers) or voluntarily to stock holders or internally among board members. However, such GHG emissions reports tend to provide GHG emissions on a per-company (e.g., memory manufacturer 241A), or a per facility basis. In some cases, it may be possible to determine a proportion of direct emissions (e.g., excluding indirect emissions occurring earlier in the supply chain) that may be attributable to a single product (e.g., one unit of RAM 242). The GHG emissions attributable to a single unit of RAM 242 may be determined, for example, by dividing the overall direct GHG emissions generated at the memory manufacturer 241A over a set reporting period by the number of RAM 242 units manufactured during that time. This is assuming that the only product manufactured by the memory manufacturer 241A is RAM 242.

However, in order for memory manufacturer 241A to determine a proportion of GHG emissions generated during transportation of raw materials used to manufacture a single unit of RAM 242, the memory manufacturer 241A must know the ratio of silicon 226 used to manufacture a single unit of RAM 242 to the total volume of cargo on the transport vessel that delivered the silicon 226 to the memory manufacturer 241A. The memory manufacturer 241A may not have access to this information, since it may include information about materials delivered by the silicon supplier 221B to other silicon customers within the product manufacturing sector 240.

In order for memory manufacturer 241A to determine a proportion of GHG emissions generated by the raw materials sector 220 that may attributable to a single RAM unit 242, the memory manufacturer 241A must know the percentage of overall GHG emissions publicly reported for silicon supplier 221B that are attributable to the small volume of silicon 226 used in a single RAM unit 242. The memory manufacturer 241A may not have access to this information, since it may include information about silicon 226 sold to other silicon customers within the product manufacturing sector 240.

In some cases, a product manufacturer may produce a final product by integrating and packaging several subcomponents from a plurality of vendor manufacturers. For example, computer manufacturer 241D may produce laptop 248A or tablet 248B by integrating together a motherboard 243 received from motherboard manufacturer 241B and an OLED screen 247B received from plant 245B of display manufacturer 241C, along with other various components not specifically described herein (e.g., I/O devices, network radios, chassis, etc.). In such a scenario, direct GHG emissions generated by the computer manufacturer 241D may be generated through burning of fossil fuels by heavy machinery, consumption of electricity and other utilities by manufacturing facilities (e.g., even in portions of a plant not specifically dedicated to manufacturing processes, such as personnel administration, packaging, delivery services, security, storage, computing servers, air conditioning, heating, etc.), and generation of waste (e.g., solid and liquid). Data used to determine such direct GHG emissions may be gathered through various sensors, meters, utility bills, inventory records, and shipping and tracking labels (e.g., identifying a location of a product or component within a facility over time), for example.

GHG emissions considered to be indirect for the purposes of the computer manufacturer 241D in an embodiment may include all GHG emissions occurring prior to integration of the motherboard 243 and OLED screen 247B within the laptop 248A at the computer manufacturer 241D. For example, indirect emissions for manufacture of a single laptop 248A that incorporates a single motherboard 243 and a single OLED Screen 247B may include all GHG emissions by the motherboard manufacturer 241B that are attributable to a single motherboard 243, GHG emissions attributable to transportation of such a single motherboard 243 to the computer manufacturer 241D, all GHG emissions by the display manufacturer 241C that are attributable to a single OLED screen 247B, and GHG emissions attributable to transportation of such a single OLED screen 247B to the computer manufacturer 241D.

In order for computer manufacturer 241D to determine a proportion of GHG emissions generated during transportation of a single unit motherboard 243, the computer manufacturer 241D must know the ratio of the weight of a single motherboard 243 to the total weight of cargo on the transport vessel that delivered the motherboard 243 to the computer manufacturer 241D. The computer manufacturer 241D may not have access to this information, since it may include information about materials delivered by the motherboard manufacturer 241B to other customers within the product manufacturing sector 240.

In order for computer manufacturer 241D to determine a proportion of GHG emissions generated by the motherboard manufacturer 241B that may be attributable to a single motherboard 243, the computer manufacturer 241D must know the overall GHG emissions generated by the motherboard manufacturer 241B, which may or may not be publicly available. Further, the computer manufacturer 241D would need to know the number of motherboards and other final products manufactured at the motherboard plant 243 over a given reporting period for GHG emissions. The computer manufacturer 241D may not have access to this information since it may include sensitive business information for the motherboard manufacturer 241B.

In some cases, a single manufacturer may manufacture both what it would consider an end product, and subcomponents of that end product. Manufacture of subcomponents and end products incorporating these subcomponents may be performed by a single entity, or may be distributed across a plurality of plants. For example, display manufacturer 241C may manufacture Thin-Film Transistor (TFT) 246A and Liquid Crystal Layer (LCL) 246B at a first plant 245A and may separately incorporate one or more of these subcomponents during manufacture of the LCD screen 247A and OLED screen 247B at a separate plant 245B. In such a scenario, the display manufacturer 241C may generate GHG emissions reports on a per-facility (e.g., plant 245A and plant 245B) basis.

The plant operator in such a scenario would likely maintain separate business records for each manufacturing line. For example, data pertaining to meter readings, sensor readings, raw materials delivery, product output, utilities consumption and billing would likely be maintained in one group pertaining to TFT manufacture and in another group pertaining to LCL manufacture. In such an embodiment, such manufacturers may determine GHG emissions attributable to each manufacturing line separately. The direct GHG emissions from each separate manufacturing line may then be divided by the number of units manufactured in that line to determine direct GHG emissions attributable to the manufacture of a single product. More specifically, the direct GHG emissions from the manufacture of all TFTs may be divided by the number of TFTs manufactured to provide the proportion of all direct GHG emissions attributable to manufacture of a single TFT 246A. This value may be added to indirect emissions generated during extraction, refinement and transportation of the gold 223 and copper 225 required to manufacture a single TFT 246A in order to determine the total distributed GHG emissions attributable to the manufacture of a single TFT 246A.

As another example, the direct GHG emissions from the manufacture of all LCLs may be divided by the number of LCLs manufactured to provide the proportion of all direct GHG emissions attributable to manufacture of a single LCL 246B. This value may be added to indirect emissions generated during extraction, refinement and transportation of the liquid crystals 227 required to manufacture a single LCL 246B in order to determine the total distributed GHG emissions attributable to the manufacture of a single LCL 246B.

In another case, manufacture of both subcomponents and end products containing those subcomponents may occur at the same facility. For example, motherboard manufacturer 241B may manufacture Central Processing Units (CPU) 244 for incorporation within motherboard 243, and manufacture motherboard 243 itself. The plant operator in such a scenario would likely maintain separate business records for each manufacturing line. For example, data pertaining to meter readings, sensor readings, raw materials delivery, product output, utilities consumption and billing would likely be maintained in one group pertaining to CPU manufacture and in another group pertaining to motherboard manufacture. In such an embodiment, such manufacturers may determine GHG emissions attributable to each manufacturing line separately. The proportion of overall GHG emissions from each separate manufacturing line may then be divided by the number of units manufactured in that line to determine direct GHG emissions attributable to the manufacture of a single product. More specifically, the direct GHG emissions from the manufacture of all CPUs 244 may be divided by the number of CPUs 244 manufactured to provide the proportion of all direct GHG emissions attributable to manufacture of a single CPU 244. This value may be added to indirect emissions generated during extraction, refinement and transportation of the silver 224 and copper 225 required to manufacture a single CPU 244 in order to determine the total distributed GHG emissions attributable to the manufacture of a single CPU 244.

In another example, the direct GHG emissions from the manufacture of all motherboards 243 may be divided by the number of motherboards 243 manufactured to provide the proportion of all direct GHG emissions attributable to manufacture of a single motherboard 243. In such a scenario, the direct emissions generated during manufacture of each CPU 244 and direct emissions generated during manufacture of each RAM unit 242 may be considered indirect emissions for manufacture of each motherboard 243 (assuming each motherboard contains a single CPU 244 and a single RAM unit 242). Thus, the direct GHG emissions attributable to manufacture of a single motherboard 243 may be added to indirect emissions generated during manufacture of a single CPU 244 and a single RAM unit 242 in order to determine the total distributed GHG emissions attributable to the manufacture of a single motherboard 243.

In order to determine GHG emissions attributable to a single product within a complex supply chain, data of varying types (e.g., reported GHG emissions, transportation details, production capacity per facility, utilities consumption per facility) may need to be gathered from several entities across the supply chain (e.g., raw materials suppliers 221A, 221B, or 221C, product manufacturers 241A, 241B, 241C, 241D). Some of these entities across the supply chain may not have authorized other entities to access such data required to determine a proportion of GHG emissions to a single product within the supply chain. As described below with respect to FIG. 2C, the transparent greenhouse gas emission validation and reporting service system provides a solution to this problem.

FIG. 2B is a block diagram illustrating several entities in the product manufacturing and consumer portions of a supply chain for an end product according to an embodiment of the present disclosure. The end of a supply chain for manufacture of a product in an embodiment, as described with reference to FIG. 2B may include a product manufacturing sector 240, and a second transportation sector 260 operating to transport end products (e.g., laptop 248A, or tablet 248B) to end consumers in the consumer sector 270. Further, each of these sectors (e.g., 240, 260, and 270) may access and consume one or more resources or services from a utilities sector 250. For example, each manufacturing plant, transportation entity, and consumer requires electricity 251, water 252, possible petroleum or natural gas 253 (e.g., to heat a facility), and waste management 254. Each of these sectors (e.g., 240, 250, 260, 270) may emit greenhouse gases (GHGs) during their course of business.

Each end product, such as a laptop 249A or tablet 248A may be shipped to an end consumer, such as the U.S. government 271, AT&T® 272, Verizon® 273, or an individual customer 274, for example. Transport of these end products through the second transportation sector 260 may directly emit GHGs through the burning of fossil of fuels (e.g., trains, planes, trucks, ships, etc.), or through consumption of electricity (e.g., hybrid vehicles, electric trains, etc.). The product manufacturer (e.g., computer manufacturer 241D) may be capable of determining the proportion of GHG emissions produced during this transport through analysis of the shipping vessel(s) used, the fuel consumed, and the number and type of products transported with the end product. This information may be obtained, in an embodiment from product tracking orders or shipping labels, for example. More specifically, such information may be obtained by reference to a manifest for transport of tablets 248B to the U.S. Government 271, a manifest for transport of tablets 248C to AT&T® 272, a manifest for transport of laptops 249B to Verizon® 273, or a manifest for transport of laptops 249C to another customer 274, for example.

As described above with reference to FIG. 2A, processes performed by the product manufacturer 240 that produce GHGs may further include packaging, and generation of waste. Product manufacturers 240 may engage in refurbishment and recycling programs to offset these GHG emissions. For example, computer manufacturer 241D in an embodiment may encourage (e.g., through credits, promotions, rebates) the end consumers (e.g., 271, 272, 273, or 274) to return old devices (e.g., desktop computers) upon purchase of a new product (e.g., laptop 248A, or tablet 248B). Computer manufacturer 241D in such an example embodiment may then recycle the old desktop computer by removing and reusing certain parts in newer devices, or may refurbish the old desktop computer for resale to another consumer. Parts from the old desktop computer that are not reusable in a product for resale to another consumer may be recycled in a proper recycling facility, thereby decreasing the volume of waste that would have been sent to waste management 254 (e.g., landfill) by the end consumer discarding the old desktop. Further, any parts that are refurbished or reused remove the need for manufacture of new parts, thereby decreasing the overall GHGs that would have been emitted in such manufacture of new parts.

FIG. 2C is a block diagram illustrating a database management system (DBMS) control platform in communication with multiple entities in a supply chain for an end product according to an embodiment of the present disclosure. As described herein, determination of GHGs emitted during manufacture of a product is a complex process that includes data gathering and analysis of procedures followed at every step of the supply chain, between the raw materials supplier and the end consumer of a single product. The transparent GHG emissions validation and reporting service system in an embodiment may gather, verify, and report information from each entity within the supply chain necessary to determine GHG emissions generated pursuant to manufacture of a single end product for consumers.

In an embodiment, the transparent GHG emissions validation and reporting service system may operate within a database management system (DBMS) control platform 280 that gathers, verifies, sorts, stores, queries, and retrieves operational data in databases for one or more entities within the supply chain for a single end-user product. For example, the DBMS control platform 280 in an embodiment may operate as a cloud-based service to store sensor data, shipping and tracking information, accounting information, inventory data, utility billing information, customer and vendor contact information, invoices, or any other form of data routinely collected or generated during the normal course of business for a manufacturing facility or resource extraction facility within the supply chain. For example, one or more suppliers within the raw materials sector 220, one or more product manufacturers within the product manufacture sector 240, or one or more consumers within the consumer sector 270 may use the DBMS control platform 280 as a cloud-based DBMS for storage, maintenance, and organization of data records routinely created, edited, and shared among divisions of a large business or corporation during its regular course of business. More specifically, many such corporations already use some form of DBMS to store, edit, organize and share information about accounting, billing, inventory, shipping, sensor data, and human resources, to name a few divisions.

In other embodiments, the DBMS control platform 280 may access similar information stored locally or in a separate cloud-based service by one or more entities within the supply chain, pursuant to agreements between parties within the supply chain. For example, one or more parties within the supply chain may store such data in separate, individual DBMS s. More specifically, raw materials suppliers of gold, copper, and silver may store information in the minerals supplier DBMS 281, silicon supplier may store information in the silicon supplier DBMS 282, and liquid crystal supplier may store information in the liquid crystal supplier DBMS 283. As another example, a product manufacturer of memory may store information in the memory manufacturer DBMS 286, a manufacturer of motherboards may store information in the motherboard manufacturer DBMS 287, and a computer manufacturer may store information in the computer manufacturer DBMS 288. As described above with reference to FIG. 2A, in some cases, a single manufacturer (e.g., display manufacturer 241C may operate two separate plants to manufacture its end products (e.g., displays). In such an example embodiment, all information from both plants may be stored in a single DBMS (e.g., cloud-based DBMS control platform 280), or each plant may store its information in a separate DBMS. More specifically, a first plant manufacturing thin-film transistors (TFTs) and liquid crystal layers (LCLs) may store its information in Plant A DBMS 284 and a second plant manufacturing liquid crystal display (LCD) screens and organic light emitting diode (OLED) screens may store its information in Plant B DBMS 285.

In some cases, each entity within the supply chain may use the same DBMS control platform to manage data. Many large corporations use the same DBMS control platforms to manage their data because very few DBMS companies can handle the large volume and high demands of these global corporations. Further, storing information that will be shared with vendors, suppliers, customers, and governmental agencies (e.g., U.S. EPA) is made easier when that information is stored and maintained by a single DBMS platform (e.g., 280) for each of these entities. Doing so may avoid complications associated with migration of large volumes of data, duplication, corruption, or incompatibility of such information across databases of differing architecture, rules, or schema.

Thus, data used to determine GHG emissions in embodiments may be routinely gathered and stored at the DBMS control platform 280 or other databases (e.g., 281, 282, 283, 284, 285, 286, 287, 288, or 275) accessible by the DBMS control platform 280. For example, even if one or more entities within the supply chain for a single product stores information needed to determine GHG emissions in a separate DBMS (e.g., 281, 282, 283, 284, 285, 286, 287, 288, or 275), the DBMS control platform 280 in an embodiment may be capable of querying and retrieving data stored at such separate DBMS s. This may be the case where, as part of the business agreement to purchase or sell raw materials or products, two or more entities within the supply chain further agree to the sharing of certain electronic records through application programming interfaces (APIs), for example. Such an electronic data agreement in an embodiment may be agreed upon prior to trading of any goods and may detail the types of data each party may query, retrieve, or share, and may outline permissions for each of those activities, as described in greater detail herein.

FIG. 3 is a block diagram illustrating a database management system (DBMS) control platform retrieving and verifying data from a plurality of supply chain entities according to an embodiment of the present disclosure. As described herein, data used to determine GHG emissions in embodiments may be routinely gathered and stored at the DBMS control platform 350 or other databases (e.g., supplier DBMS 321, product manufacturer DBMS 331, or consumer DBMS 341) accessible by the DBMS control platform 350. The DBMS control platform 350 in an embodiment may be capable of querying and retrieving data stored at such separate DBMSs (e.g., 321, 331, or 341) through application programming interfaces (APIs), for example.

Each entity of the supply chain (e.g., supplier, manufacturer, and consumer) may agree to share certain specifically identified electronic data records stored either directly at the DBMS control platform 350 or at individual and separate DBMSs (e.g., 321, 331, or 341). Such an agreement (e.g., a blockchain license agreement) may limit access by the DBMS control platform 350 to data records likely or known to be necessary in determination of GHG emissions for a single product. Each entity may identify these data records by data field name under which such data may be stored either directly at the DBMS control platform 350 or at individual and separate DBMSs (e.g., 321, 331, or 341). The DBMS control platform 350 in such an embodiment may routinely gather all such pre-identified data records from these sources and store these specific data records at a global data repository 360 accessible by any user of the DBMS control platform 350.

Equations used to determine GHG emissions based on these data records may also be stored at the global data repository 360 in an embodiment. For example, as described above with respect to FIG. 2A, the GHG emissions attributable to a single unit of RAM 242 may be determined, for example, by dividing the overall direct GHG emissions generated at the memory manufacturer 241A over a set reporting period by the number of RAM 242 units manufactured during that time. The DBMS control platform 350 in such an embodiment may provide a generic GHG emissions equation, below, and allow the RAM manufacturer to customize this equation for their specific needs:

$$CO 2 emitted per unit manufactured due to electricity consumption = \frac{\begin{matrix}CO 2 emitted per kWh for \\ electricity provider * number of kWh\end{matrix}}{Number of units manufactured} \qquad ( 1 a )$$

In such an embodiment, the RAM manufacturer may further use a GUI 391 to associate each variable within such a customized GHG emission determination equation with a data field name stored in the global data repository 360. For example, a RAM manufacturer may use GUI 391 to associate the variable “CO2 emitted per kWh for electricity provider” with the data field name “EPA_CO2_perkWh_Eprovider,” which may represent the CO2 emitted per kWh by the electricity provider (e.g., “Eprovider”) for the RAM manufacturer, as reported by the EPA and stored within the global data repository 360. As another example, the RAM manufacturer may use GUI 391 to associate the variable “number of kWh” with the data field name “kWh” which may be associated (e.g., within an electricity bill stored at the product manufacturer DBMS 331) with a number of kWh the RAM manufacturer used. In yet another example, the RAM manufacturer may use GUI 391 to associate the variable “number of units manufactured” with a data field name “RAM_output,” which may be associated (e.g., within a subcomponent or product accounting database stored at the product manufacturer DBMS 331) with a number of RAM units manufactured. Upon such an identification of data field names for each variable within equation (1a), above, a customized equation (1b) shown below may also be stored within the global data repository 360, for example:

$$[ Electricity\_CO 2 \_perRAM \_MMfg ] = \frac{[ EPA\_CO 2 \_perkWh \_Eprovider ] * [ kWh ]}{[ RAM\_output ]} \qquad ( 1 b )$$

The DBMS control platform 350 in an embodiment may also store metadata associated with such customized equations (e.g., 1(b) customized for use by the memory manufacturer) that identify the generic or generalized equation (e.g., 1(a) generally describing variables needed to determine GHG emitted during manufacture of a product due to electricity consumption) upon which the customized equation was based. This may enable the DBMS control platform 350 to compare GHG emissions determined using data from one entity to the same GHG emissions determined using data from another entity, to make sure all entities are reporting accurately in an example embodiment. Further, a similar process may be applied to plural reporting events from the same entity to identify outliers or errant reporting events. For example, information regarding shipment times, distances, and fuel consumption used to determine GHG emissions during transport of raw materials to an end product manufacturer may be drawn from a manifest controlled by the materials supplier DBMS 321 and from another manifest controlled by the same materials supplier or by a product manufacturer DBMS 331. Because both manifests describe the same trip, the data values gathered from these two manifests, and equations for calculating the same GHG emissions (e.g., CO2 emitted during transport of raw materials) should match within an acceptable variance amount as decided by an end-product manufacturer or even regulated. However, a raw materials supplier attempting to artificially deflate its GHG emissions may alter the data within the manifest controlled by the supplier DBMS 321, for example. In such a case, or in any case where data values from two separate sources do not match within a variance, the transparent GHG emissions validation and reporting service system operating at the DBMS control platform 350 may report this mismatch and identify the data field values that do not match and their time of entry, as well as the entities (e.g., employee name) that provided the mismatched information.

The transparent GHG validation and reporting service system operating at the DBMS control platform 350 in an embodiment may also compare determined GHG emissions values for multiple manufacturers of the same or similar components (e.g., multiple memory manufacturers) in an embodiment. For example, the DBMS control platform 350 may notify a motherboard manufacturer when the GHG emissions for one RAM manufacturer does not match or differs markedly from the GHG emissions for other RAM manufacturers. This may indicate that the outlier RAM manufacturer has tampered with or misreported data used during determination of its GHG emissions. In other instances, this may indicate the outlier RAM manufacturer has developed a more environmentally-friendly manufacturing process. In either case, identification of the RAM subcomponent manufacturer in an embodiment may assist the motherboard manufacturer in determining which RAM manufacturers to engage in the future (e.g., preferring a more environmentally-friendly RAM manufacturer or avoiding a RAM manufacturer erroneously reporting GHG emissions).

The DBMS control platform 350 in such an embodiment may gather data from the product manufacturer DBMS 331 identified by the memory manufacturer (e.g., through a process such as the one described directly above) as describing GHG emissions generated at the memory manufacturer over a preset reporting period due to consumption of electricity and data identifying the number of RAM units manufactured during that time. In another example embodiment, the DBMS control platform 350 may gather data from the product manufacturer DBMS 331 identified by the memory manufacturer as describing overall direct GHG emissions generated at the memory manufacturer over a preset reporting period. In some embodiments, the DBMS control platform 350 may further create a new data record that uses the stored equation to determine the portion of the overall GHG emissions attributable to a single unit of RAM and store that data record at the global data repository 360.

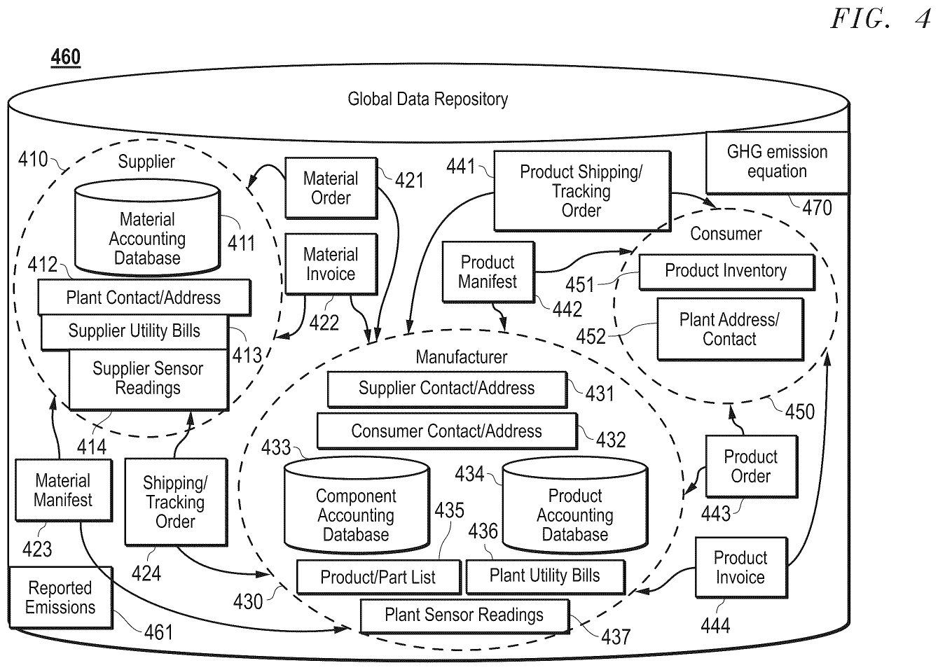

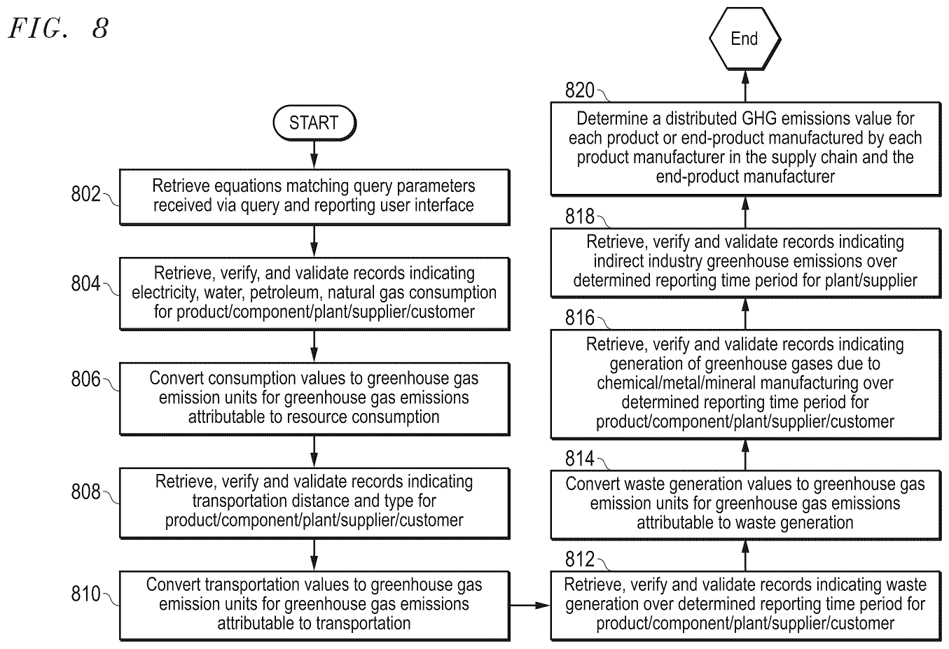

In another example embodiment described above with reference to FIG. 2A, GHG may be generated through consumption of electricity and other utilities by manufacturing facilities (e.g., even in portions of a plant not specifically dedicated to manufacturing processes, such as personnel administration, security, storage, computing servers, air conditioning, heating, etc.), and generation of waste (e.g., solid and liquid). Some utilities sector 250 entities (e.g., electricity provider 251) may be required to report GHG emissions for generation of electricity (e.g., through burning of fossil fuels) to the EPA or another governmental agency. When this occurs, reports for GHG emissions are provided on a per-facility or per-company basis untethered to the end product of the supply chain. However, as described in greater detail with respect to FIGS. 4 and 8, below, the transparent GHG emissions and validation reporting service system in an embodiment may determine an amount of resources consumed during manufacture of a single product, for example. More specifically, the transparent GHG emissions and validation reporting service system may determine a computer manufacturer consumed one kWh of electricity provided by its utility provider in the manufacture of a single laptop.

The DBMS control platform 350 operating the transparent GHG emissions validation and reporting service system may be in communication with a regulatory reporting agency tool 310 (e.g., EPA's Facilities Level Information on GHG Tool (FLIGHT)) that may be used to convert this resource consumption value to a GHG emission value. The transparent GHG emissions validation and reporting service system in an embodiment may use such a tool 310 to determine a GHG emissions value for each unit of resource consumed from each identified utilities provider. For example, the transparent GHG emissions validation and reporting service system in an embodiment may use tool 310 to determine that the electricity corporation supplying electricity to a memory manufacturer generates 0.85 pounds of CO2 during generation of one kWh of electricity.

Data may be gathered from various external DBMSs (e.g., 321, 331, or 341) and shared according to permissions preset by each of the entities within the supply chain prior to trading of goods or gathering of data from either the DBMS control platform 350 or any individual DBMSs (e.g., 321, 331, or 341) for determination of GHG emissions. For example, an entity (e.g., supplier of raw materials and owner of supplier DBMS 321) may preset authorization for storage of certain pre-identified data records known to be necessary in determination of GHG emissions at the global data repository 360, but may limit the parties capable of querying data attributable to the supplier within the global data repository 360. More specifically, the supplier of raw materials may restrict access to its data stored at the global data repository 360 to only a subset of product manufacturers with whom it does business. Each entity may further restrict the ability of other entities to edit or update any such data stored at the global data repository 360. For example, the supplier of raw materials may disallow product manufacturers or consumers from editing or updating any data gathered from the supplier DBMS 321 and stored at the global data repository 360, even though such product manufacturers or consumers may have other limited access to such data stored at the global data repository 360.

In another aspect of an embodiment, such a supplier of raw materials (or other entity within the supply chain) may further restrict the type of information returned pursuant to such a query of the global data repository 360. For example, a memory manufacturer may allow the DBMS control platform 350 to report overall GHG emissions generated by the memory manufacturer over a preset reporting period to one or more parties, but may not allow any outside parties to view the number of RAM units produced by that manufacturer over that time period. As another example, such a memory manufacturer may allow the DBMS control platform 350 to report the portion of overall GHG emissions generated by the memory manufacturer over the preset reporting period that may be attributable to a single unit of RAM, as determined and stored by the DBMS control platform 350 at the global data repository 360. In such an example embodiment, the memory manufacturer may disallow the DBMS control platform 350 from reporting to any outside party (e.g., any party other than the memory manufacturer) the data records underlying that determination, including the number of RAM units produced by the memory manufacturer of the reporting period. In such a way, the DBMS control platform 350 in an embodiment may report to multiple entities within the supply chain GHG emissions generated during manufacture of a specific subcomponent or end product, without compromising security of the underlying data used to determine such GHG emissions.

Reporting of GHG emissions to authorized users by the DBMS control platform 350, and the transparent GHG emissions validation and reporting service system operating therewithin may require: (1) identification of data field values to be routinely retrieved from supply chain entities for later determination of GHG emission values; (2) local validation of such identified data field values through e-signature or other identifying processes for specific personnel entering such data; (3) retrieval, validation, and storage of such identified data field values; and (4) determination of GHG emission values based on the gathered, verified, and stored data field values and upon user-specified reporting parameters; and (5) reporting of the determined GHG emission values according to user-specified reporting parameters and permissions. As a first step, multiple entities within the supply chain for a single product may agree to a blockchain license allowing the DBMS control platform 350 to control and validate blockchain metadata associated with any data field values gathered from those multiple entities. Further, each entity at this step may provide one or more data field names for data field values the transparent GHG emissions validation and reporting service system may later use to determine GHG emissions (e.g., as described above with respect to FIGS. 1(a) and 1(b)). For example, data from invoices, tracking and shipping labels, and receipts may be useful in determination of GHGs emitted during transport of an end product to an end customer. In such an example embodiment, the manufacturer of motherboards may identify data field names such as “MBD_output,” “kWh,” “Gallons_H2O,” or “RAM_MBD_Ratio” to determine GHG emitted during manufacture of a single motherboard due to consumption of electricity or water, or due to indirect emissions from the manufacture of RAM units incorporated within motherboards, as described in greater detail below with respect to FIG. 8. This may be only one example of several data records that may be accessed and cross-referenced to determine the type and amount of GHGs emitted during manufacture of an end product. Other examples may be described in greater detail below with respect to FIG. 8.

As a second step, each remote DBMS (e.g., supplier DBMS 321, manufacturer DBMS 331, or customer DBMS 341) may require local data validation. Each of the entities in control of these DBMS s (e.g., 321, 331, and 341) in an embodiment may agree to such a local data validation. Such a local validation may require each data field value identified by any entity as a value upon which GHG emissions may be determined (e.g., as described above with reference to equations (1a) and (1b)) to be associated with a valid e-signature or other identifying process that can particularly identify specific personnel entering such data.

As a third step, the transparent GHG emissions validation and reporting service system in an embodiment may routinely retrieve, validate, and store data field values associated with the data field name provided by the supply chain entity as potentially useful in determination of GHG gases. For example, the DBMS control platform 350 in an embodiment may routinely retrieve data field values associated with the data field name “MBD_output,” describing the number of motherboards manufactured within a specific time period, from the product manufacturer DBMS 331. At this point, the DBMS control platform 350 may additionally refer to the blockchain in metadata associated with the retrieved data field values to determine their authenticity. Data gathered from each of the subcomponent manufacturers may be included within immutable blockchain information ensuring the data has not been tampered with, or, if the data has been tampered with, providing a simple method of identifying the time and identity of the person or entity attempting to tamper with the data. Any data field values not passing such a blockchain verification may be discarded, while data field values that can be verified may be stored within the global data repository 360. Additionally, should any data field values fail to pass blockchain verification, the DBMS control platform 350 in an embodiment may notify any entity that has identified this data field as necessary to determine GHG emissions that the data field value has been discarded for failure to meet blockchain verification. Because the blockchain for such a discarded data field value contains an identification of the person or entity that entered the erroneous data, the DBMS control platform 350 in such an embodiment may further identify each entity of the source of the erroneous data.

As a fourth step, the transparent GHG emissions validation and reporting service system operating within the DBMS control platform 350 may determine GHG emission values based on a plurality of data field values previously gathered, verified, and stored within the global data repository. Such GHG emission value determinations may be made by the transparent GHG emissions validation and reporting service system routinely, or upon request by a supply chain entity or DBMS control platform 350 user. In some embodiments, the GHG emissions determinations may be made according to particular reporting parameters, such as GHG emissions for a specific manufacturer, product, subcomponent, raw material, supplier, manufacturing plant, or customer. These GHG emissions determinations may be stored within the global data repository 360, for later retrieval and reporting to authorized users of the DBMS control platform 350.

Also, as described above, the DBMS control platform 350 may compare GHG emissions determined using data from one entity to the same GHG emissions determined using data from another entity, to make sure all entities are reporting accurately. The DBMS control platform 350 may also compare determined GHG emissions values for multiple manufacturers of the same or similar components (e.g., multiple memory manufacturers) in an embodiment, as described above. This may indicate that the outlier manufacturer has tampered with or misreported data used during determination of its GHG emissions, or that the outlier manufacturer has developed a more environmentally-friendly manufacturing process. In such cases where data values or GHG emissions from two separate sources do not match or differ markedly, the transparent GHG emissions validation and reporting service system operating at the DBMS control platform 350 may report this mismatch and identify the data field values that do not match and their time of entry, as well as the entities (e.g., employee name) that provided the mismatched information. In such a way, the transparent GHG emissions validation and reporting service system and the DBMS control platform in an embodiment may gather from multiple entities within the supply chain and verify the authenticity of data used to determine GHG emissions generated during manufacture of a specific subcomponent or end product, while preventing tampering or misreporting.

As a fifth step, the transparent GHG emissions validation and reporting service system may report determined GHG emission values according to user-specified reporting parameters and permissions. As described directly above, these GHG emission values may be determined simultaneously with a report request, or prior to receipt of such a report request. The transparent GHG emissions validation and reporting service system may limit reporting of such information to authorized users of the DBMS control platform 350. Further, while the transparent GHG emissions validation and reporting service system may report determined GHG emissions for a specific manufacturer, product, subcomponent, raw material, supplier, manufacturing plant, or customer to any authorized end user, the transparent GHG emissions validation and reporting service system may restrict or deny access by any of these parties to portions or the entirety of data field values stored in the global data repository underlying such GHG emissions determinations. For example, the transparent GHG emissions validation and reporting service system in an embodiment may base transportation GHG emissions determinations, at least in part, on the data field values associated with the data field name “delivery date.” The transparent GHG emissions validation and reporting service system may later report the determined GHGs emitted during transportation, but may not report the actual delivery date given within the data field value previously gathered from the product manufacturer DBMS 331, for example. In such a way, the transparent GHG emissions validation and reporting service system and the DBMS control platform in embodiments described herein may report to multiple entities within the supply chain GHG emissions generated during manufacture of a specific subcomponent or end product, without compromising security of the underlying data used to determine such GHG emissions.

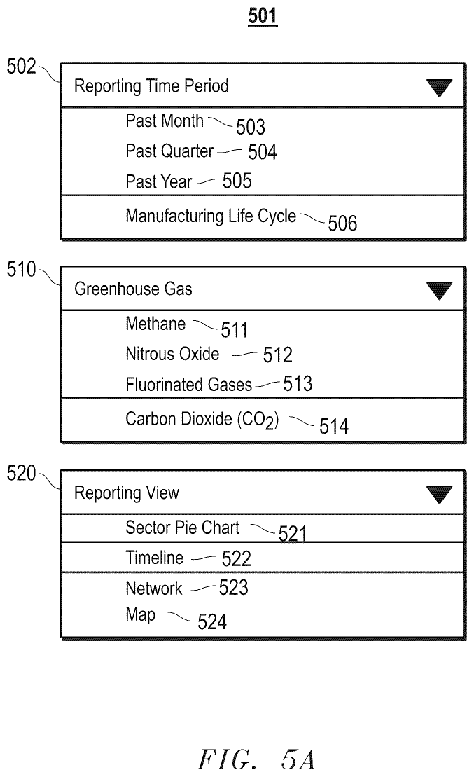

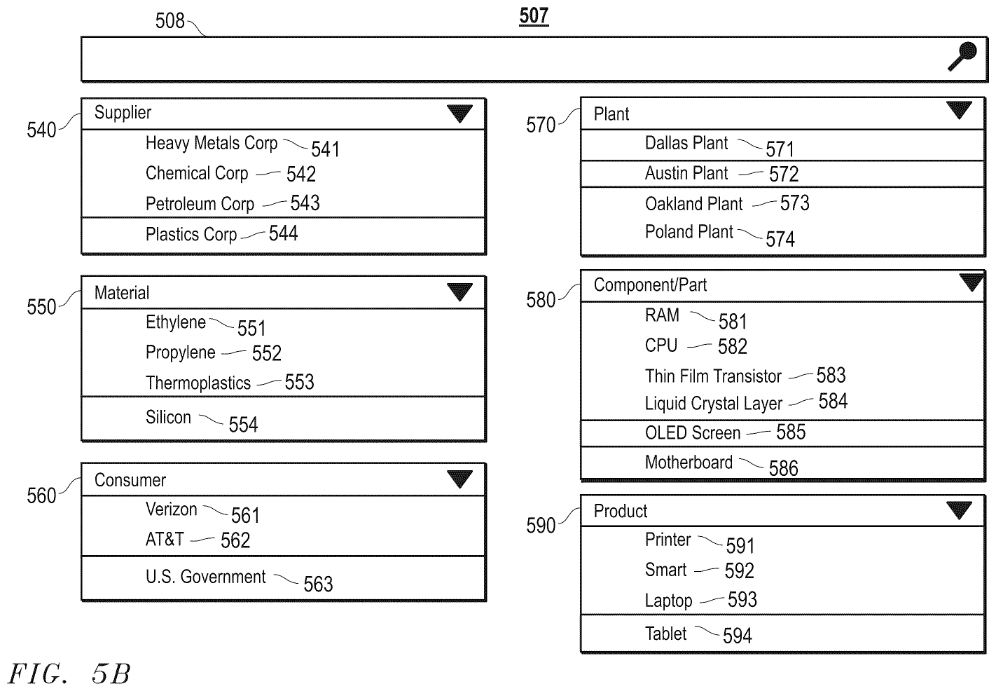

The DBMS control platform 350 in an embodiment may comprise several components common to database management systems. Each of these components (e.g., 390, 351, 352, 353, 354, 355, 356, 357, 358, 359, or 360) may comprise software or firmware, and may represent individual information handling systems. In some cases, one or more of such components may comprise a computing node in communication with other computing nodes executing operating instructions of other components of the DBMS control platform 350. For example, a query and reporting user interface 390 in an embodiment may be incorporated within the DBMS control platform 350, and may be in communication with an authorization control component 351. The query and reporting user interface 390 may be utilized by users of the DBMS control platform 350 (e.g., operator of supplier DBMS 321, operator of product manufacturer DBMS 331, or operator of consumer DBMS 341), or by the transparent GHG emissions validation and reporting service system in response to prompts from a graphical user interface (GUI) accessible by the users of the DBMS control platform 350. Users of DBMS control platform 350 in an embodiment may use this query and reporting user interface 390, for example, to specifically identify data field names routinely stored at individual and separate DBMS s (e.g., 321, 331, or 341) or at the DBMS control platform 350 that may be used to determine GHG emissions for one or more entities of the supply chain, or proportions of such GHG emissions that may be attributable to a single end product. This query and reporting user interface 390 may also be used to request a report of GHG emissions stored at the global data repository 360 according to specific parameters provided via a separate GUI 391, as described with reference to FIGS. 5A and 5B, below. Upon retrieval of such GHG emissions stored at the global data repository 360, the query and reporting user interface 390 in an embodiment may transmit the retrieved GHG emissions values to the GUI 391 for display in a user-specified reporting view.

An authorization control component 351 may be operatively connected to the query and reporting user interface 390 and to a data dictionary manager 352, and a command processor 353. The authorization control component 351 in an embodiment may refer to stored preset authorizations agreed upon by each of the DBMS control platform 350 users (e.g., multiple entities within the supply chain for a single end product) within a blockchain licensing agreement requiring local validation measures for gathering data. The authorization control component 351 in such an embodiment may limit query responses (e.g., to queries received via the query and reporting user interface 390) to data stored within the global data repository 360 to which the querying user has been previously granted access via the blockchain licensing agreement. The authorization control component 351 may be in communication with a data dictionary manager 352 which may operate to record what data records are stored in the global data repository 360, and descriptions of the data contained therein. For example, the data dictionary manager 352 may record metadata for one or more data records within the global data repository, including the blockchains associated with such data records, or local validation measures for gathering data.

A command processor 353 in an embodiment may be operatively connected to the authorization control component 351, an integrity checker 359, a query optimizer 354, and a blockchain verification component 355. The command processor 353 in an embodiment may receive query requests, communicate with the query optimizer 354 to optimize such requests, and may convert query language into a logical sequence of steps for searching and retrieving one or more data records stored within the global data repository 360. In another aspect of an embodiment, the command processor 353 may receive data records imported from one or more outside DBMS s (e.g., 321, 331, or 341), and may convert data field names associated with imported data field values to conform with the data dictionary manager requirements and constraints of the integrity checker 359. The integrity checker 359 in an embodiment may check to ensure that this logical sequence of steps satisfies all necessary constraints.

A blockchain verification component 355 in an embodiment may be operatively connected to the command processor 353, and to a scheduler 356. The scheduler 356 may ensure that concurrent operations or transactions (e.g., storage, querying, retrieval, editing of data records within the global data repository) proceed without conflicting with one another. The blockchain verification component 355 in an embodiment may operate to confirm the source of data (e.g., 321, 331, or 341) to confirm its authenticity. This may be performed, for example, by reference to a digital token (e.g., cyclic redundancy check (CRC), QR code, etc.) provided to each supply chain entity upon agreement of the blockchain licensing agreement. Any data records not validated by the blockchain verification component 355 in such a manner may be discarded by the DBMS control platform 350, and may not be stored within the global data repository 360. As a consequence, GHG emissions determinations made based on data records stored within the global data repository 360 in an embodiment may rely only upon data from verified authentic sources.

Additionally, should any data field values fail to pass blockchain verification, the blockchain verification component 355 in an embodiment may transmit an indication to GUI 391 to notify any entity that has identified this data field as necessary to determine GHG emissions that the data field value has been discarded for failure to meet blockchain verification. Because the blockchain for such a discarded data field value contains an identification of the person or entity that entered the erroneous data, the blockchain verification component 355 and GUI 391 in such an embodiment may further identify each entity that has identified this data field as necessary to determine GHG emissions of the source of the erroneous data.

A buffer manager 357 may be operatively connected to the blockchain verification component 355, a recovery manager 358, and the global data repository 360. The recovery manager in an embodiment may ensure that the database remains in a consistent state in the presence of failures. The buffer manager in an embodiment may be responsible for the transfer of data between the remote DBMS s (e.g., 321, 331, or 341) and the global data repository 360, pending verification by the blockchain verification component 355, for example.

Each entity of the supply chain (e.g., supplier, manufacturer, and consumer) may each agree to share certain specifically identified electronic data records stored either directly at the DBMS control platform 350 or at individual and separate DBMSs (e.g., 321, 331, or 341). Local verification measures specifically identifying personnel entering such data may be applied to all such data records, regardless of their storage location (e.g., at 350 or 321, 331, 341). Such an agreement may limit access by the DBMS control platform 350 to data records likely or known to be necessary in determination of GHG emissions for a single product. Each entity may identify these data records by data field name under which such data may be stored either directly at the DBMS control platform 350 or at individual and separate DBMSs (e.g., 321, 331, or 341). The DBMS control platform 350 in such an embodiment may routinely gather all such pre-identified data records from these sources and store these specific data records at a global data repository 360 accessible by any user of the DBMS control platform 350.

Equations used to determine GHG emissions based on these data records may also be stored at the global data repository 360 in an embodiment. For example, as described above with respect to FIG. 2A, the GHG emissions attributable to a single unit of RAM 242 may be determined, for example, by dividing the overall direct GHG emissions generated at the memory manufacturer 241A over a set reporting period by the number of RAM 242 units manufactured during that time. The DBMS control platform 350 in such an embodiment may gather data from the product manufacturer DBMS 331 identified by the memory manufacturer as describing an overall direct GHG emissions generated at the memory manufacturer over a preset reporting period and data identifying the number of RAM units manufactured during that time. In some embodiments, the DBMS control platform 350 may further create a new data record that uses the stored equation to determine the portion of the overall GHG emissions attributable to a single unit of RAM and store that data record at the global data repository 360.

Such data may be gathered from various external DBMSs (e.g., 321, 331, or 341) and shared according to permissions preset by each of the entities within the supply chain prior to trading of goods or gathering of data from either the DBMS control platform 350 or any individual DBMSs (e.g., 321, 331, or 341) for determination of GHG emissions. For example, an entity (e.g., supplier of raw materials and owner of supplier DBMS 321) may preset authorization for storage of certain pre-identified data records known to be necessary in determination of GHG emissions at the global data repository 360, but may limit the parties capable of querying data attributable to the supplier within the global data repository 360. More specifically, the supplier of raw materials may restrict access to its data stored at the global data repository 360 to only a subset of product manufacturers with whom it does business.

In another aspect of an embodiment, such a supplier of raw materials (or other entity within the supply chain) may further restrict the type of information returned pursuant to such a query of the global data repository 360. For example, a memory manufacturer may allow the DBMS control platform 350 to report overall GHG emissions generated by the memory manufacturer over a preset reporting period to one or more parties, but may not allow any outside parties to view the number of RAM units produced by that manufacturer over that time period. As another example, such a memory manufacturer may allow the DBMS control platform 350 to report the portion of overall GHG emissions generated by the memory manufacturer over the preset reporting period that may be attributable to a single unit of RAM, as determined and stored by the DBMS control platform 350 at the global data repository 360. In such an example embodiment, the memory manufacturer may disallow the DBMS control platform 350 from reporting to any outside party (e.g., any party other than the memory manufacturer) the data records underlying that determination, including the number of RAM units produced by the memory manufacturer of the reporting period. In such a way, the DBMS control platform 350 in an embodiment may report to multiple entities within the supply chain GHG emissions generated during manufacture of a specific subcomponent or end product, without compromising security of the underlying data used to determine such GHG emissions.

FIG. 4 is a block diagram illustrating a global data repository storing data retrieved from a plurality of supply chain entities and verified by a database management system (DBMS) control platform according to an embodiment of the present disclosure. As described herein, determination of GHGs emitted during manufacture of a product is a complex process that includes data gathering and analysis of procedures followed at every step of the supply chain, between the raw materials supplier and the end consumer of a single product. The transparent GHG emissions validation and reporting service system in an embodiment may gather, verify, and report information from each entity within the supply chain necessary to determine GHG emissions generated pursuant to manufacture of a single end product for consumers.

As described above with respect to FIG. 3, the transparent GHG emissions validation and reporting service system in an embodiment may gather, verify, and store such data within a global data repository 460 that may be queried by each user of the transparent GHG emissions validation and reporting service system in order to generate reports attributing a portion of overall GHG emissions to a single end product of the supply chain. Global data repository 460 may be a distributed data repository among plural database structures in various embodiments. As described herein, the DBMS control platform in an embodiment may either operate as the primary, cloud-based data storage and maintenance center in which multiple entities routinely enter and store data during routine operation of their businesses, or the DBMS control platform may gather such information from DBMS s operating separately from the DBMS control platform and the global data repository 460. In other words, various entities of the supply chain may store their data within the global data repository 460 during their normal course of business, separate and apart from their needs to determine and report GHG emissions. FIG. 4 illustrates such a scenario, in which multiple entities within the supply chain have directly stored data records or databases within the global data repository 460. In other embodiments, the transparent GHG emissions validation and reporting service system may gather data from one or more of the data records or databases located remotely from the DBMS control platform, as described in greater detail with respect to FIG. 2C, above.

GHG emissions may be determined for particular subcomponents products or an end product in an embodiment according to one or more equations 470 stored within global data repository 460 or within another memory accessible by the database management system (DBMS) control platform and the transparent GHG emissions validation and reporting service system. For example, as described with reference to FIG. 2A above, the GHG emissions attributable to a single unit of RAM 242 may be determined by dividing the overall direct GHG emissions generated at the memory manufacturer 241A over a set reporting period by the number of RAM 242 units manufactured during that time. The DBMS control platform 350 in such an embodiment may gather data from the memory manufacturer's DBMS identified as describing an overall direct GHG emissions generated at the memory manufacturer over a preset reporting period and data identifying the number of RAM units manufactured during that time. This is only one example of such an equation, and FIGS. 2A and 2B provide several other example equations for determining portions of overall GHGs emitted throughout the entirety of the supply chain attributable to a particular sub-component product or an end-product produced thereby.

Each equation 470 in an embodiment may determine such portions of overall GHGs emitted that are attributable to a single product using data field values drawn from many types of data records stored within the global data repository 460. For example, GHG emissions attributable to a single unit of RAM, as described in the paragraph directly above may require data such as the number of RAM units manufactured during a certain time period. Such information may be stored in an accounting database that tracks the number of value of sales, for example. More specifically, a memory manufacturer may store the number of units of RAM sold in an accounting database under the data field name “RAM unit sales,” for example. As described above with reference to FIG. 3, the memory manufacturer may use the query interface 390 to enter the data field name “RAM unit sales” to direct the transparent GHG emissions validation and reporting service system to routinely gather all datasets containing the data field name “RAM unit sales” from the accounting database for storage at the global data repository 460. The user in such an embodiment may further use the query and reporting interface described with reference to FIG. 3 to provide the equation (e.g., 470) that tells the transparent GHG emissions validation and reporting service system how to use the gathered datasets containing the data field name “RAM unit sales” to determine the portion of overall GHG emissions attributable a single unit of RAM, for example.

The above scenario is only one example of the type of data gathered and manipulated by the transparent GHG emissions validation and reporting service system to determine the portion of overall GHG emissions attributable to a single product manufactured and delivered to an end consumer. FIG. 4 illustrates further examples of data types that may be gathered from various sources within the supply chain to make such a determination. For example, the transparent GHG emissions validation and reporting service system may gather data owned and controlled by a raw materials supplier 410, a product manufacturer 430, or a consumer 450. More specifically, the transparent GHG emissions validation and reporting service system may gather data from a raw materials accounting database 411, contact information or address 412 for one or more plants operated by the raw materials supplier, utility bills and receipts 413 for utility resources consumed by the raw materials supplier at one or more operating facilities, or sensor readings 414 from sensors at one or more operating facilities.

As another example, the transparent GHG emissions validation reporting service system may gather data from a product manufacturer 430, which may include an end product manufacturer (e.g., computer manufacturer) or a component manufacturer (RAM manufacturer) (e.g., as described in greater detail with respect to FIG. 2A above). The transparent GHG emissions validation reporting service system in an embodiment may gather contact information or address for a raw materials supplier/vendor 431, contact information or address for a consumer 432, utility bills and receipts 436 for utility resources consumed by the product manufacturer at one or more operating facilities, or sensor readings 437 from sensors at one or more operating facilities.

In addition, the transparent GHG emissions validation reporting service system in an embodiment may gather information identifying which subcomponents are incorporated within each end product, and the number of units of each subcomponent or end product that have been manufactured or transported to an end consumer. For example, a computer manufacturer may incorporate more than one processor or motherboard within a single laptop, along with an OLED screen. This correlation between various internal subcomponents and an end product may be necessary in order to define the full supply chain for each end product (e.g., the laptop supply chain includes manufacture of multiple processors or even motherboards and an OLED screen), which may further impact the overall GHG emissions produced during manufacture of the end product (e.g., laptop). Data describing the total number of end products manufactured may be stored, for example, at a product accounting database 434, along with data describing purchases of various internal components (e.g., processors or motherboards, OLED screen) used in the manufacture of such an end product (e.g., laptop). The product accounting database 434 in an embodiment may further store data describing purchases for various raw materials from the supplier 410, for example.

The transparent GHG emissions validation reporting service system in such an embodiment may access data correlating components and end products at a product/part list 435, for example. Such a product/part list 435 may, for example, associate one or more component names (e.g., “processor,” “motherboard,” or “OLED”) with a single end product (e.g., “laptop”). In an embodiment in which a manufacturer 430 produces both an end product and components incorporated therewithin, the manufacturer 430 may further store data relating to manufacture of the subcomponents within a component accounting database 433. In such an embodiment, data describing the total number of subcomponents manufactured may be stored, for example, at the component accounting database 433, along with data describing purchases for various raw materials from the supplier 410, for example.

In yet another example, the transparent GHG emissions validation and reporting service system may gather data owned and controlled by a consumer 450, such as from a product inventory 451 identifying which manufacturer supplied which end product, and contact information or address 452 for one or more plants operated by that manufacturer. This will allow each end consumer (e.g., 450) to compare GHG emissions for a product purchased from one manufacturer to the same product purchased from another manufacturer, for example.

The transparent GHG emissions validation and reporting service system in an embodiment may further reference data stored in records accessible to multiple parties within the supply chain. For example, the global data repository 460 may contain data shared between the supplier 410 and the manufacturer 430, such as material orders 421, material invoices 422, material manifest forms 423, or material shipping or tracking orders 424. Such data may be used to determine volume of materials purchased by a specific manufacturer and data needed to determine GHGs emitted during transportation of such raw materials from the supplier 410 to the manufacturer 430, for example. As another example, the global data repository 460 may contain data shared between the manufacturer 430 and the end consumer 450, such as product shipping/tracking orders 441, product manifest 442, product orders 443, or product invoices 444. Such data may be used to determine the number of end products purchased from a specific manufacturer by a specific consumer and data needed to determine GHGs emitted during transportation of such end products from the manufacturer 430 to the consumer 450, for example.

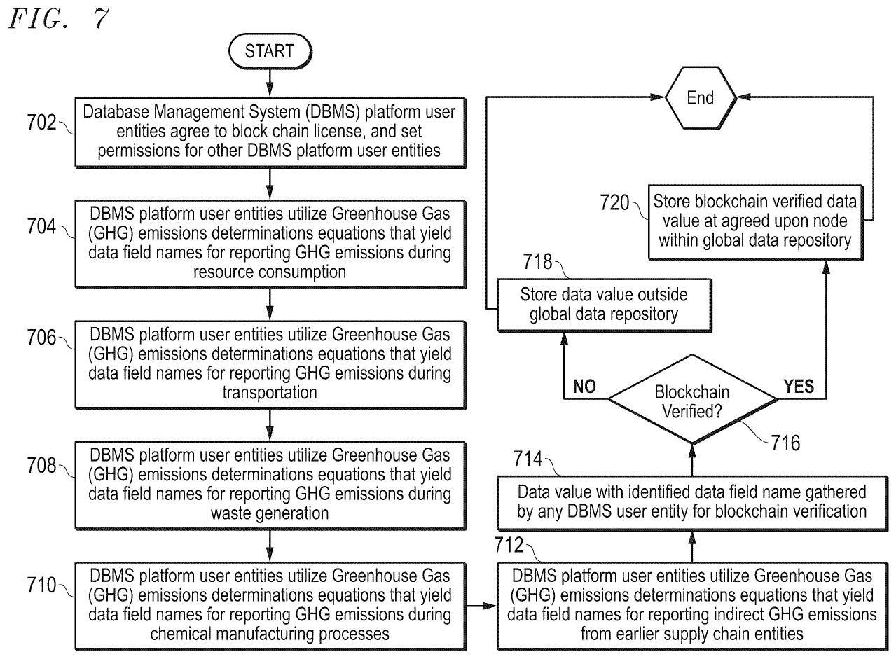

The global data repository 460 in an embodiment may also store one or more previously stored GHG emissions values, as determined using other data stored within the global data repository 460 according to equations 470 previously customized by DMBS control platform users to identify such data by data field name, as described in greater detail with respect to FIGS. 7, and 8, below. For example, some equations 470 may be customized by users to refer to conversion factors likely to be used by many users of the DMBS control platform, and widely reported by the EPA or other governmental agencies. More specifically, some equations 470 may refer to EPA conversion factors for converting a known volume of a specific fuel (e.g., diesel) into a volume of carbon dioxide or other GHG emitted during the burning of such fuel. As another example, some equations 470 may refer to the amount of carbon dioxide or other GHG emitted by various utilities providers, as reported to the EPA by those providers (e.g., electricity, water, waste, natural gas, petroleum). As yet another example, some equations 470 may refer to fuel efficiency for a specific vehicle used during transport within the supply chain for an end-product. In each of these example embodiments, such conversion factors or known values (e.g., fuel to CO2 conversion factor, utilities CO2 emissions, or fuel efficiency) may be stored within reported emissions 461.

In some cases, a GHG emission equation 470 may refer to a determination of GHG emissions made using another GHG emission equation stored within the global data repository 460. For example, a GHG emission equation for all distributed CO2 emissions generated during the manufacture of a single product may include CO2 emissions generated during the manufacture of that product due to electricity consumption, water consumption, or liquid natural gas or petroleum. Each of these resource consumption-based values (e.g., CO2 emissions due to electricity consumption, CO2 emissions due to water consumption, and CO2 emissions due to liquid natural gas or petroleum consumption) may have been previously determined using other GHG emission equations stored within the global data repository. Upon making such underlying determinations in an embodiment, the DMBS control platform may store those underlying determinations (e.g., CO2 emissions due to electricity consumption, CO2 emissions due to water consumption, and CO2 emissions due to liquid natural gas or petroleum consumption) within the reported emissions 461.

Similarly, determinations for GHG emissions during transportation of an end-product or subcomponent in an embodiment may depend upon determinations for GHG emissions during transportation of other subcomponents or raw materials. Additionally, equations 470 for determination of distributed GHG emissions during the manufacture of an end product in an embodiment may depend upon indirect emissions made by suppliers of raw materials or subcomponents incorporated within that end product. In such embodiments, GHG emissions determined for earlier portions of the supply chain (e.g., transportation or emissions relating to raw materials or subcomponents incorporated into an end product) may also be stored within reported emissions 461. These are only a few examples of the types of information that may be stored at the global data repository 460 in an embodiment and used to determine a portion of GHG emissions produced during manufacture of a single end product in an embodiment, as described in greater detail with respect to FIG. 8, below.

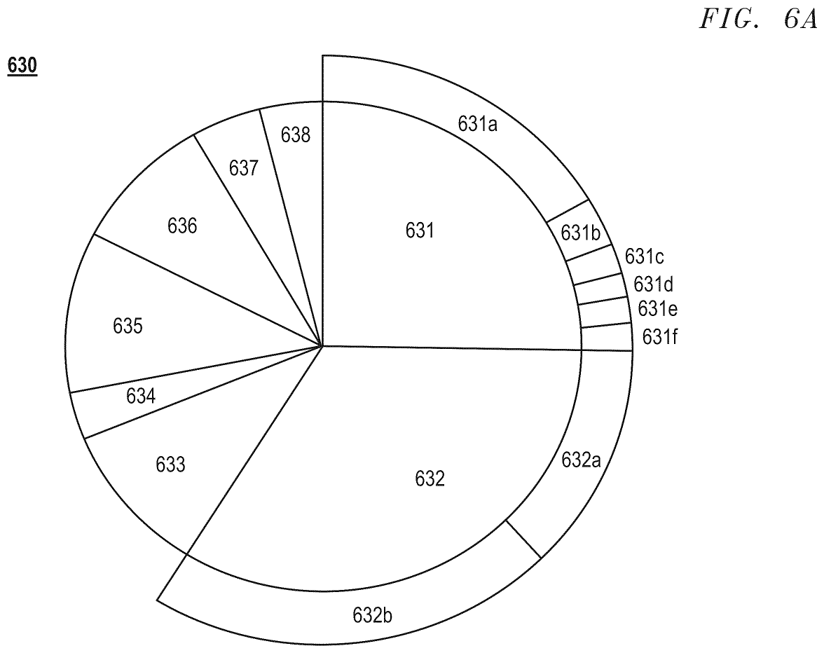

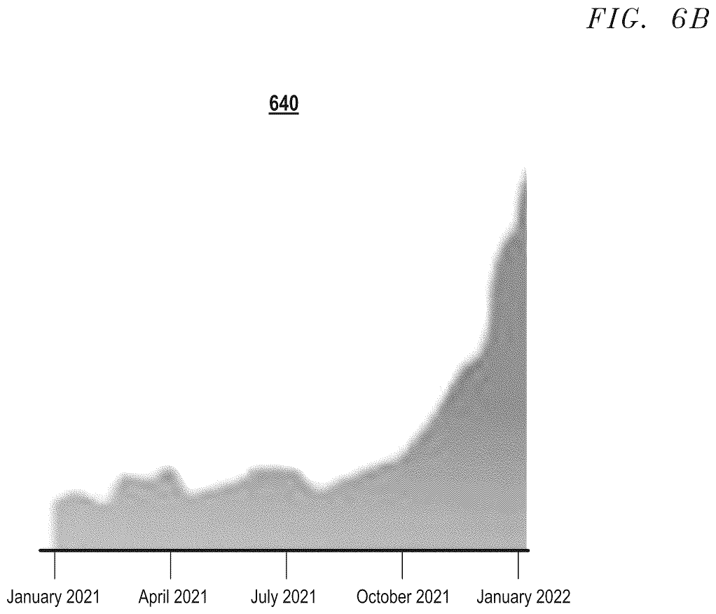

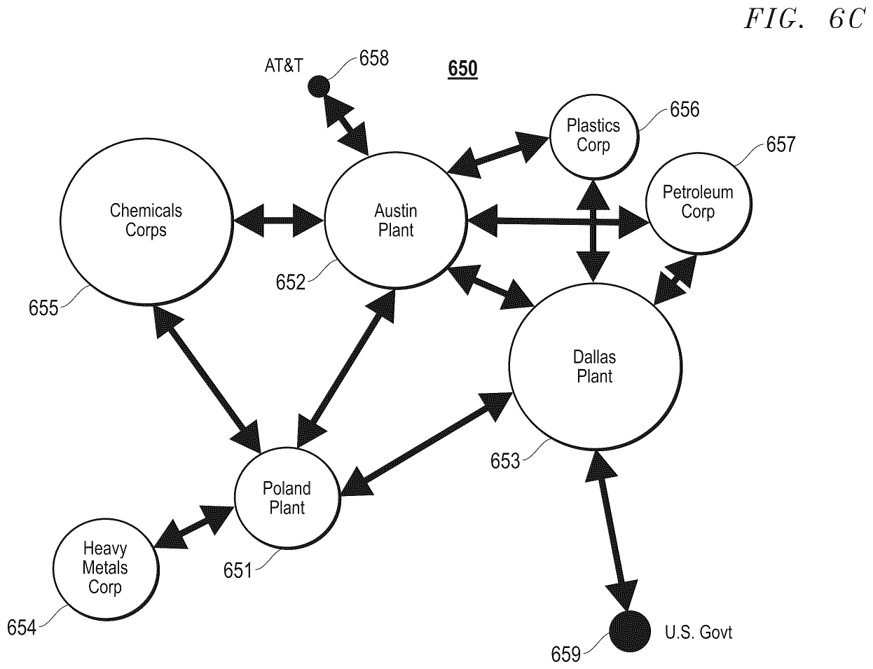

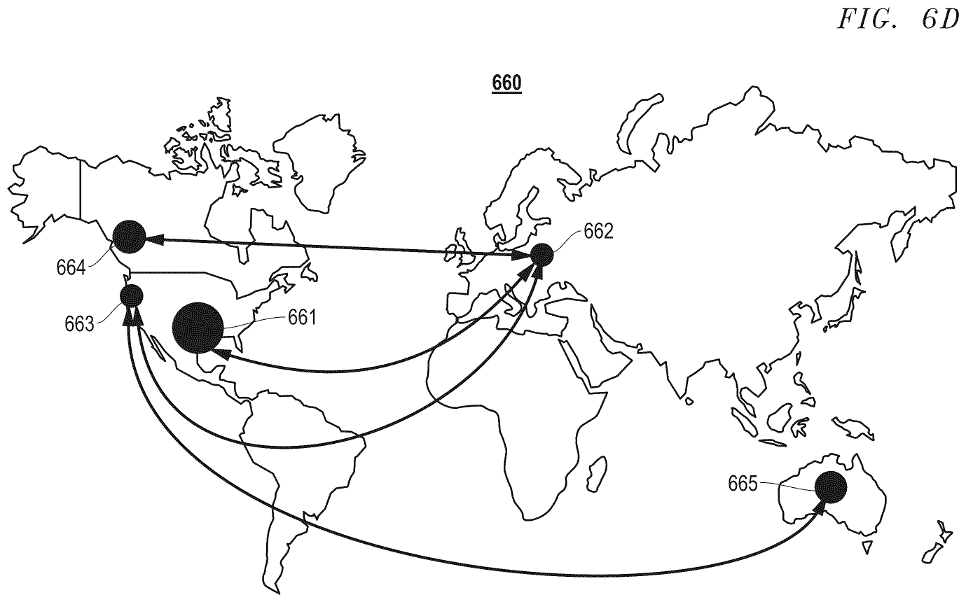

FIG. 5A is a graphical diagram illustrating a greenhouse gas (GHG) type and reporting view selector of a graphical user interface (GUI) according to an embodiment of the present disclosure. As described herein, a user of the transparent GHG emissions validation and reporting service system may request reports of various GHG emissions produced during manufacture of a particular product or over a particular time period in an embodiment. A user may use GUI 501 to identify a reporting time period, the type of GHG to track, as well as the format in which the user chooses to view such a report. For example, the GUI 501 may allow the user to select from a plurality of time periods over which GHGs were emitted, such as over the past month 503, over the past fiscal quarter 504, over the past year 505, or during the manufacture life cycle 506 of a particular product. In one example embodiment, the user may make such a selection using the drop down menu 502. In another example, the GUI 501 may allow the user to select from a plurality of GHGs (e.g., methane 511, nitrous oxide 512, fluorinated gases 513, or carbon dioxide (CO2) 514. In one example embodiment, the user may make such a selection using the drop down menu 510. A user may also use GUI 501 to identify the type of reporting view through a similar type of drop down menu 520, for example. More specifically, the user may select from a sector pie chart view 521, a timeline view 522, a network view 523, or a map view 524. FIGS. 6A, 6B, 6C, and 6D below provide examples of such reporting views.

FIG. 5B is a graphical diagram illustrating a greenhouse gas (GHG) emission determination filter of a graphical user interface (GUI) for display of in-depth emission data by supply chain entity, product, subcomponent, or end consumer according to an embodiment of the present disclosure. The transparent GHG emissions validation and reporting service system in an embodiment may provide a default report of all GHG emissions attributable to the user requesting such a report (e.g., a manufacturer, supplier, or customer), upon receiving the reporting time period, type of GHG to report, and reporting view described directly above with respect to FIG. 5A. The GUI 507 depicted in FIG. 5B allows the user to additionally filter or refine the reporting request to include GHG emissions attributable to a specific supplier, raw material, consumer, manufacturing facility (e.g., plant), subcomponent, or end product.

For example, GUI 507 may allow the user to report GHG emissions over the specified reporting time period specifically attributable to a particular raw materials supplier. More specifically, the user in an example embodiment may use the drop down menu 540 to narrow reporting of GHG emissions to those emissions attributable to plastics corporation 544, and to exclude emissions from heavy metals corporation 541, chemical corporation 542, and petroleum corporation 543. As another example, GUI 507 may allow the user to report GHG emissions over the specified reporting time period specifically attributable to a particular raw material. More specifically, the user in an example embodiment may use the drop down menu 550 to narrow reporting of GHG emissions to those emissions attributable to manufacture and transport of silicon 554, and to exclude emissions from manufacture and transport of ethylene 551, propylene 552, and thermoplastics 553. As yet another example, GUI 507 may allow the user to report GHG emissions over the specified reporting time period specifically attributable to a particular consumer. More specifically, the user in an example embodiment may use the drop down menu 560 to narrow reporting of GHG emissions to those emissions attributable to manufacture of all products manufactured and transported to the U.S. government 563 as an end consumer, and to exclude products manufactured and transported to Verizon 561 and to AT&T® 562.

In yet another example, GUI 507 may allow the user to report GHG emissions over the specified reporting time period specifically attributable to a particular raw materials plant, subcomponent manufacturing plant, or end product manufacturing plant. More specifically, the user in an example embodiment may use the drop down menu 570 to narrow reporting of GHG emissions to those emissions attributable to manufacturing at a plant located in Austin, TX 572, and to exclude emissions attributable to manufacturing at plants located in Dallas, TX 571, Oakland, CA 573, and Poland 574. The drop down menu 570 may be populated in some embodiments, only with facilities operated by the requesting user, and to which the user has authorization. In still another example, GUI 507 may allow the user to report GHG emissions over the specified reporting time period specifically attributable to a particular subcomponent incorporated within an end product. More specifically, the user in an example embodiment may use the drop down menu 580 to narrow reporting of GHG emissions to those emissions attributable to manufacture of OLED screens 585, and to exclude GHG emissions attributable to manufacture of RAM 581, CPU 582, thin-film transistor 583, liquid crystal layer 584, and motherboard 586. As yet another example, GUI 507 may allow the user to report GHG emissions over the specified reporting time period specifically attributable to a particular end product. More specifically, the user in an example embodiment may use the drop down menu 590 to narrow reporting of GHG emissions to those emissions attributable to manufacture of tablet 594, and to exclude GHG emissions attributable to manufacture of printers 591, smart phones 592, and laptop computers 593.

FIG. 6A is a graphical diagram illustrating a graphical user interface (GUI) reporting greenhouse gases (GHG) emitted during manufacture of a specific end product in a pie chart view 630 according to an embodiment of the present disclosure. As described herein with reference to FIGS. 2A and 2B above, a supply chain for manufacture of a product in an embodiment may include a raw materials manufacture or refining sector, a transportation sector, and direct emissions sources such as the consumption of resources or services from a utilities sector. As described above and in greater detail above with respect to FIG. 5B, the GHG emissions reflected in the pie chart view 630 may illustrate GHG emissions for a specific raw materials supplier, a specific type of raw material, a specific consumer of an end product, a specific manufacturer or manufacturing facility, a specific subcomponent incorporated within an end product, or a specific end product. Any combination or subset of GHG emissions may be tracked, verified, requested or presented in various embodiments.

The pie chart view 630 illustrated in FIG. 6A may break down a determination of GHG emitted (e.g., during manufacture of a specific product or subcomponent, by a specific entity within the supply chain, or at a particular facility within the supply chain) on a sector by sector basis. For example, in an embodiment in which the pie chart view 630 illustrates GHG emissions for a specific raw materials supplier, the pie chart may include slices describing GHG emissions generated by the raw materials supplier's consumption of electricity 631, water 634, and petroleum and natural gases 636, and generation of waste 635. The pie chart may further include slices describing GHG emissions generated by chemical manufacturing processes 637 (e.g., manufacture of liquid crystals) performed by the raw materials supplier, and GHG emissions generated during extraction and refinement of certain minerals 638 (e.g., operation of heavy machinery during extraction and refinement of gold). As described herein, indirect emissions comprise GHG emissions produced by entities earlier in the supply chain than the entity whose GHG emissions are illustrated in the pie chart view 630. In this example, because the raw materials supplier is the earliest entity within the supply chain, the pie chart may not include an apportionment for indirect GHG emissions 633.

As another example, in an embodiment in which the pie chart view 630 illustrates GHG emissions for a specific raw material, the pie chart may include slices describing GHG emissions generated by the raw materials supplier's consumption of electricity 631, water 634, and petroleum and natural gases 636, and generation of waste 635 for only one of several raw materials produced by that raw materials supplier. The pie chart may further include slices describing GHG emissions generated by chemical manufacturing processes 637 (e.g., manufacture of liquid crystals) performed during the manufacture of that specific raw material, and GHG emissions generated during extraction and refinement of that specific raw mineral 638 (e.g., operation of heavy machinery during extraction and refinement of gold).

In another example, in an embodiment in which the pie chart view 630 illustrates GHG emissions for a specific manufacturing plant or facility, the pie chart may include slices describing GHG emissions generated by the plant's consumption of electricity 631, water 634, and petroleum and natural gases 636, and generation of waste 635. The pie chart may further include slices describing GHG emissions generated by chemical manufacturing processes 637 (e.g., chemical etching of thin-film transistors (TFTs)) performed by the manufacturer, GHGs emissions generated during transportation of raw materials to the manufacturer 632, and indirect emissions produced by entities earlier in the supply chain than the manufacturer (e.g., raw materials supplier). The transparent GHG emissions validation and reporting service system in an embodiment may be capable of determining all raw materials suppliers delivering raw materials to a specifically identified manufacturing plant or facility, and the overall GHG emissions for that raw materials supplier, as would be required to generate a pie chart view of GHG emissions for such a raw materials supplier described directly above. This overall GHG emissions determination for each of the raw materials suppliers for the specifically identified manufacturing plant or facility may be reflected as the indirect emissions slice 633 for the pie chart view 630 for that manufacturing plant or facility, for example.

In still another example, in an embodiment in which the pie chart view 630 illustrates GHG emissions for a specific subcomponent, the pie chart may include slices describing GHG emissions generated during manufacture of that specific subcomponent through consumption of electricity 631, water 634, and petroleum and natural gases 636, and generation of waste 635. The pie chart may further include slices describing GHG emissions generated by chemical manufacturing processes 637 (e.g., chemical etching of thin-film transistors (TFTs)) performed during manufacture of that specific subcomponent (e.g., TFT), GHGs emissions generated during transportation of raw materials to the manufacturer of that specific subcomponent 632, and indirect emissions produced by entities earlier in the supply chain than the manufacturer of that subcomponent (e.g., raw materials supplier).

In yet another example, in an embodiment in which the pie chart view 630 illustrates GHG emissions for a specific end product, the pie chart may include slices describing GHG emissions generated during manufacture of that specific end product, which may contain multiple subcomponents, through consumption of electricity 631, water 634, and petroleum and natural gases 636, and generation of waste 635. The pie chart may further include slices describing GHG emissions generated by chemical manufacturing processes 637 performed during manufacture of that specific end product, GHGs emissions generated during transportation 632 of raw materials to the manufacturer of all incorporated subcomponents and transportation of all incorporated subcomponents to the end product manufacturer, and indirect emissions produced by entities earlier in the supply chain than the manufacturer of that end product (e.g., raw materials supplier and manufacturers of all incorporated subcomponents).

In still another example, in an embodiment in which the pie chart view 630 illustrates GHG emissions for a specific end consumer, the pie chart may include slices describing GHG emissions generated during transportation 632 of raw materials to the manufacturer of all subcomponents incorporated within an end product, transportation of all subcomponents to an end product manufacturer, and transportation of the end product to the end consumer. The pie chart view 630 in such an example embodiment may further include indirect emissions produced by entities earlier in the supply chain than the consumer (e.g., raw materials supplier, subcomponent manufacturers, and end product manufacturer).

In some embodiments, various portions of the pie chart view 630 may be further broken down, based on available data. For example, the transparent GHG emissions validation and reporting service system in some embodiments may be capable of accessing various sensor readings, utility bills, and shipping and tracking orders that allow for a more in-depth breakdown of GHGs emitted during transportation and consumption of electricity. More specifically, a pie chart view 630 for emissions at a single manufacturing facility may access such records to identify the portion of electricity consumed by facility servers 631a, by building occupancy (e.g., air conditioning, security, heating, lighting) 631b, by chiller units 631c, by computer room air conditioning 631d, by uninterruptable power sources 631e, or by a specific team such as the product development unit 631f. As another example, the transparent GHG emissions validation and reporting service system in an embodiment in which the pie chart view 630 reflects GHG emissions attributable to a specific subcomponent may break the transportation 632 slice into GHGs emitted during transportation of raw materials 632a to the subcomponent manufacturing plant, and GHGs emitted during transportation of the subcomponents 632b to the end product manufacturer. This pie chart view is only one reporting view illustrating GHG emissions attributable to varying entities, raw materials, subcomponents, and products within the supply chain.

FIG. 6B is a graphical diagram illustrating a graphical user interface (GUI) reporting greenhouse gases (GHG) emitted during manufacture of a specific end product in a timeline view 640 according to an embodiment of the present disclosure. As described above with reference to FIG. 6A, the transparent GHG emissions validation and reporting service system in an embodiment may be capable of determining GHG emissions occurring at various stages within the manufacturing supply chain for a final product (e.g., during raw materials extraction, transport of raw materials, subcomponent manufacture, transportation of subcomponents, end product manufacture, and transportation of end products). By referencing data records stored within the global data repository in an embodiment (e.g., shipping orders, tracking orders, inventory records, invoices, receipts), the transparent GHG emissions validation and reporting service system in an embodiment may determine a date or time at which each of these steps within the supply chain occurred.

The transparent GHG emissions validation and reporting service system in an embodiment may then map the cumulative GHG emissions for each of these dates in the timeline view 640. For example, the timeline view 640 in an embodiment in which reporting has been requested for GHGs emitted during manufacture of a specific product for a specific consumer may indicate GHGs emitted during extraction and refinement of a raw material between January of 2021 and April of 2021, and further GHGs emitted during transportation of that raw material to an end product manufacturer between April of 2021 and July 2021. The timeline view 640 in such an example embodiment may also include further GHGs emitted during manufacture of the end product between July of 2021 and October of 2021, and transportation of that end product to the end consumer between October 2021 and January of 2022.

FIG. 6C is a graphical diagram illustrating a graphical user interface (GUI) reporting greenhouse gases (GHG) emitted during manufacture of a specific end product in a network view 650 according to an embodiment of the present disclosure. As described above with reference to FIG. 6A, the transparent GHG emissions validation and reporting service system in an embodiment may be capable of determining GHG emissions occurring at various stages within the manufacturing supply chain for a final product (e.g., during raw materials extraction, transport of raw materials, subcomponent manufacture, transportation of subcomponents, end product manufacture, and transportation of end products). By referencing data records stored within the global data repository in an embodiment (e.g., shipping orders, tracking orders, inventory records, invoices, receipts), the transparent GHG emissions validation and reporting service system in an embodiment may determine the raw materials, subcomponents, or products shipped between various entities within the supply chain.

The network view 650 in an embodiment may illustrate the trade relationship between each of these various entities within the supply chain. For example, the network view 650 may illustrate that the heavy metals corporation 654 shipped a raw material to a specific manufacturing plant in Poland 651 which manufactures subcomponents that are later shipped to end product manufacturers at an Austin, TX, USA plant 652 and a Dallas, TX, USA plant 653. A separate raw materials supplier, chemicals corporation 655 may supply manufactured chemicals to both the Poland plant 651 and the Austin plant 652, in such an example embodiment, as reflected in the network view 650. Both the Austin plant 652 and the Dallas plant 653 in such an example embodiment may further purchase raw materials from plastics corporation 656, and petroleum corporation 657. In an embodiment in which the network view 650 is set by a user to illustrate the GHG emissions for a single end product, only suppliers for raw materials actually used in that specific product may be included within the network view 650, for example. Finally, the network view 650 may indicate that end products manufactured at the Austin plant 652 may be transported to AT&T® 658 as an end consumer, and end products manufactured at the Dallas plant 653 may be transported to the U.S. Government 659 as an end consumer.

The network view 650 may further indicate the volume of GHGs emitted by each of the entities within the supply chain and shown in the network view 650 by increasing or decreasing the size of the label for that entity. For example, the chemicals corporation 655 label (e.g., circle) represented in the network view 650 is considerably larger than the label 656 for plastics corporation. This may indicate that the GHGs emitted by the chemicals corporation and attributable to the specifically identified end product are significantly larger than the GHGs emitted by the plastics corporation and attributable to the specifically identified end product. As another example, the Austin plant label 652 is much larger than the label 658 for the AT&T® end consumer. This may indicate that the GHGs emitted during manufacture of the end product at the Austin plant 652 were much greater than the GHGs emitted during transportation of that specific end product to AT&T®.

FIG. 6D is a graphical diagram illustrating a graphical user interface (GUI) reporting greenhouse gases (GHG) emitted during manufacture of a specific end product in a map view 660 according to an embodiment of the present disclosure. The map view 650 in an embodiment may also illustrate the trade relationship between each of these various entities within the supply chain, as well as their geographic locations with respect to one another. For example, the network view 650 may illustrate that the heavy metals corporation 664 shipped a raw material to a specific manufacturing plant in Poland 662 which manufactures subcomponents that are later shipped to end product manufacturers at an Austin, TX, USA plant 661 and a California, USA plant 663. The map view 660 may also indicate that end products manufactured at the California plant 663 may be transported to a customer affiliate in Australia 665 as an end consumer. Like the network view described above with reference to FIG. 6C, the map view 660 may further indicate the volume of GHGs emitted by each of the entities within the supply chain as shown by increasing or decreasing the size of the label for that entity.

FIG. 7 is a flow diagram illustrating a method of gathering and verifying information from each entity within a supply chain for an end product necessary to determine GHG emissions generated pursuant to manufacture of that product for consumers according to an embodiment of the present disclosure. As described herein, data used to determine GHG emissions in embodiments may be routinely gathered and stored at the database management system (DBMS) control platform or other databases accessible by the DBMS control platform.

At block 702, a DBMS control platform user entity may agree to a block chain license, and set permissions for other DBMS control platform user entities. For example, in an embodiment described with reference to FIG. 3, each entity of the supply chain (e.g., supplier, manufacturer, and consumer) may agree to share certain specifically identified electronic data records stored either directly at the DBMS control platform 350 or at individual and separate DBMS s (e.g., 321, 331, or 341). Such a blockchain agreement may require any entity sharing such data to identify the person (e.g., employee) entering or editing such data through e-signature, username, or other type of electronic security measure. Data gathered from each of the subcomponent manufacturers may include immutable blockchain information ensuring the data has not been tampered with, or, if the data has been tampered with, providing a simple method of identifying the time and identity of the person or entity attempting to tamper with the data.

A blockchain agreement between entities at multiple stages of the supply chain (e.g., between the subcomponent manufacturer and the product manufacturer) may restrict or disallow entities within the supply chain to access or change data owned by other entities within the supply chain, stored within the global data repository, and used by the DBMS to determine the portion of GHG emissions generated during manufacture of various subcomponents or end-products. In such a way, the transparent GHG emissions validation and reporting service system and the DBMS control platform in embodiments described herein may gather from multiple entities within the supply chain and verify the authenticity of data used to determine GHG emissions generated during manufacture of a specific subcomponent or end product, while preventing tampering or misreporting.

Such a blockchain agreement in an embodiment may also limit access by the DBMS control platform 350 to data records likely or known to be necessary in determination of GHG emissions for a single product. For example, blockchain access keys for one or more block chains may have limited availability among supply chain contributors. As described in greater detail below with respect to blocks 704, 706, 708, and 710, each entity may identify these data records by data field name under which such data may be stored either directly at the DBMS control platform 350 or at individual and separate DBMSs (e.g., 321, 331, or 341). As described in greater detail with respect to block 712, below, the DBMS control platform 350 in such an embodiment may routinely gather all such pre-identified data records from these sources and store these specific data records at a global data repository 360 accessible by any user of the DBMS control platform 350.

Data may be gathered from various external DBMSs (e.g., 321, 331, or 341) and shared according to permissions preset by each of the entities within the supply chain prior to trading of goods or gathering of data from either the DBMS control platform 350 or any individual DBMSs (e.g., 321, 331, or 341) for determination of GHG emissions. For example, an entity (e.g., supplier of raw materials and owner of supplier DBMS 321) may preset authorization for storage of certain pre-identified data records known to be necessary in determination of GHG emissions at the global data repository 360, but may limit the parties capable of querying data attributable to the supplier within the global data repository 360. In another aspect of an embodiment, each supply chain entity may further restrict the type of information returned pursuant to such a query of the global data repository 360. In such a way, the DBMS control platform 350 in an embodiment may report to multiple entities within the supply chain GHG emissions generated during manufacture of a specific subcomponent or end product, without compromising security of the underlying data used to determine such GHG emissions.

At block 704, a DBMS control platform user entity may associate variables of GHG emission determination equations with data field names for reporting GHG emissions during resource consumption. In order to determine GHG emissions values in an embodiment, users of the DBMS control platform may customize one or more generic equations provided by the DBMS control platform for making such determinations. Such a customization may identify specific data field values as variables within the generic equations. For example, in an embodiment described above with respect to FIG. 3, the DBMS control platform 350 may provide a generic GHG emissions equation, below, and allow a RAM manufacturer to customize this equation for their specific needs:

$$CO 2 emitted per unit manufactured attributable to \\ electricity consumption = \frac{\begin{matrix}CO 2 emitted per kWh for \\ electricity provider * number of kWh\end{matrix}}{Number of units manufactured} \qquad ( 1 a )$$

In such an embodiment, the RAM manufacturer may associate each variable within such a customized GHG emission determination equation with a data field name stored in the global data repository 360. For example, a RAM manufacturer may associate the variable “CO2 emitted per kWh for electricity provider” with the data field name “EPA_CO2_perkWh_Eprovider,” which may represent the CO2 emitted per kWh by the electricity provider (e.g., “Eprovider”) for the RAM manufacturer, as reported by the EPA and stored within the global data repository 360. As another example, the RAM manufacturer may associate the variable “number of kWh” with the data field name “kWh” which may be associated (e.g., within an electricity bill stored at the product manufacturer DBMS 331) with a number of kWh the RAM manufacturer used. In yet another example, the RAM manufacturer may associate the variable “number of units manufactured” with a data field name “RAM_output,” which may describe (e.g., within a subcomponent or product accounting database stored at the product manufacturer DBMS 331) a number of RAM units manufactured. Upon such an identification of data field names for each variable within equation (1a), above, a customized equation (1b) shown below may also be stored within the global data repository 360, for example:

$$[ Electricity\_CO2 \_perRAM \_MMfg ] = \frac{[ EPA\_CO2 \_perkWh \_Eprovider ] * [ kWh ]}{[ RAM\_output ]} \qquad ( 1 b )$$

The variables the user identifies within such a customized equation (e.g., 1(b)) may identify data routinely gathered and stored by that user within the global data repository, by an agent of the DBMS control platform, or remotely accessible by the DBMS control platform at the user's separately maintained DBMS. Such data may be gathered with the verification requirements laid out within the blockchain agreement described above with respect to block 702, such as immutable blockchain verification and e-signature tracking of data editors. All of the information given within brackets in the equation above may reference a stored dataset within the global data repository in an embodiment. For example, in an embodiment described with reference to FIG. 4, in which manufacturer 430 is a memory manufacturer, the plant utility bills 436 may store a data field set containing the data field name “kWh” and the data field value “1000” to indicate that the facility manufacturing RAM consumed 1000 kWh of electricity. The product accounting database 434 in an embodiment may store a data field set containing the data field name “RAM_output” and the data field value “1000” to indicate that the plant manufactured 1000 RAM units. Plant utility bills 436 in an embodiment may include a dataset having a data field name “Eprovider” indicating the name of the electricity utilities corporation providing service to the memory manufacturer, and a data field value of “Electricity Corp.” or other identifying information that may be used to search emissions reported to the EPA or other governmental agency, as described directly below.

In some cases, the user of the DBMS control platform in an embodiment may associate one or more variables within a GHG emission determination equation with another customized GHG emission determination equation. For example, as described in an embodiment with respect to FIG. 3, a memory manufacturer may customize the below generic equation for distributed GHG emissions per product by summing the solutions for one or more other GHG emission determination equations that have also been customized by the user:

$$Distributed CO 2 per user ’ s product unit = CO 2 per unit \qquad ( 2 a )$$

$$manufactured by user attributable to electricity$$

$$consumption + CO 2 per unit manufactured by user attributable$$

$$to water consumption + CO 2 per unit manufactured by user$$

$$attributable to consumption of liquid natural gases or$$

$$petroleum + CO 2 per unit manufactured by user attributable to$$

$$transport of manufactured units + CO 2 per unit$$

$$manufactured by user attributable to generation of$$

$$waste + CO 2 per unit manufactured$$

$$by user attributable to chemical manufacturing$$

$$processes + CO 2 per unit manufactured by$$

$$user attributable to extraction and refinement of$$

$$minerals + CO 2 per unit manufactured$$

$$by user attributable to indirect emissions from suppliers$$

More specifically, the user of the DBMS control platform in such an embodiment may associate one or more of the variables in equation (2a) with one or more other equations previously customized by that user, such as the equation (1b), described above. For example, the memory manufacturer that customized equation (1a) to determine distributed CO2 per unit of RAM manufactured due to consumption of electricity, creating equation (1b), may customize equation (2a) to the below equation (2b) which references equation (1b) for [Electricity_CO2_perRAM_MMfg]:

[Distributed_CO2_perRAM_MMfg]=[Electricity_CO2_perRAM_MMfg]+[H2O_CO2_perRAM_MMfg]+[LNGPET_CO2_perRAM_MMfg]+[Transport_CO2_perRAM_MMfg]+[Waste_CO2_perRAM_MMfg]+[Indirect_CO2_perRAM_MMfg] 2(b)

As can be seen by reference to equations (2a) and (2b), users of the DBMS control platform in an embodiment may not include each variable from the generic GHG emission determination equation in a customized GHG emission determination equation. For example, the RAM manufacturer described directly above may not include the variables describing CO2 emissions due to chemical manufacturing processes or extraction or refinement of minerals. This may be due to the fact that the RAM manufacturer does not extract or refine minerals or perform any chemical manufacturing processes known to produce specific waste products tracked by the EPA (e.g., generation of emissions of perfluorocarbons (PFCs) and hydroperfluorocarbons (HFCs) during chemical etching). Other entities within the same supply chain for producing RAM units or end-products incorporating those RAM units, such as motherboards, may perform one or more of these processes, and may include those variables in determination of direct GHG emissions by those entities. For example, a minerals supplier of silver and copper which is incorporated into CPUs within the motherboard may include a variable and customized equation for determining CO2 emitted during extraction and refinement of such silver and copper. As another example, a display manufacturer may include a variable and a customized equation for determining an equivalent value of CO2 emitted during chemical etching to produce thin-film transistors (TFTs), as described in greater detail below with respect to FIG. 8 at block 816.

The memory manufacturer may further customize equations (3a) and (4a), below, to provide equations (3b) and (4b) for determination of GHG emitted due to water consumption and natural gas or petroleum consumption per RAM unit produced:

$$CO 2 emitted during manufacture of product unit by user due \\ to water consumption = \frac{CO 2 emitted per Gallon for water provider * number of Gallons}{Number of units manufactured} \qquad ( 3 a )$$

$$[ H2O\_CO2 \_perRAM \_MMfg ] = \frac{[ EPA\_CO2 \_perGallon \_Wprovider ] * [ Gallon\_H2O ]}{[ RAM\_output ]} \qquad ( 3 b )$$

$$CO 2 emitted during manufacture of \qquad ( 4 a )$$

$$product unit by user due to natural gas and petroleum$$

$$consumption = \frac{\begin{matrix}CO 2 emitted per Gallon for natural \\ gas or petroleum provider * number of Gallons\end{matrix}}{( Number of units manufactured )}$$

$$[ LNGPET\_CO 2 \_perRAM \_MMfg ] = \frac{[ EPA\_CO 2 \_perGallon \_LNGPETprovider ] * [ Gallons\_LNGPET ]}{[ RAM\_output ]} \qquad ( 4 b )$$

Customizing and storing such equations into the global data repository (e.g., via each entity's DBMS agent) in such a way may prompt the transparent GHG emissions validation and reporting service system in an embodiment to retrieve any data records having data field names matching variables within any of these equations. This may be performed routinely on a daily, weekly, monthly, quarterly, or annual basis, for example, as described in greater detail below with respect to FIG. 8.

As can be seen with reference to each of equations (1b), (3b), and (4b), a variable indicating the amount of the resource consumed (e.g., “kWh” for electricity, “Gallons_H2O” for water, and “Gallons_LNGPET” for natural gas or petroleum) is required in order to determine GHG emissions consumed due to utilities resources consumption. By customizing and storing these equations into the global data repository in such a way, the user of the DBMS control platform in an embodiment may grant permission for the DBMS control platform and the transparent GHG Emissions verification and reporting service system to access those data records, either within the global data repository or as stored in a separate DBMS controlled by the user and owner of that data. More specifically, customization and storage of equations (1b), (3b), and (4b) into the global data repository by the RAM manufacturer may grant the transparent GHG emission validation and reporting system access to datasets containing a data field value of “kWh,” “Gallons_H2O,” or “Gallons_LNGPET.” In an embodiment described with reference to FIG. 4, in which the memory manufacturer is the manufacturer 430, for example, these records may be stored in the global data repository 460 within plant utility bills 436.

A variable indicating the number of products manufactured during the reporting time period is also required in order to determine GHG emissions consumed due to utilities resources consumption, as can be seen with reference to FIGS. (1b), (3b), and (4b). More specifically, customization and storage of equations (1b), (3b), and (4b) into the global data repository by the RAM manufacturer may grant the transparent GHG emission validation and reporting system access to datasets containing a data field value of “RAM_output,” describing the number of RAM units manufactured. In an embodiment described with reference to FIG. 4, in which the memory manufacturer is the manufacturer 430, for example, these records may be stored in the global data repository 460 within product accounting database 434.

As can also be seen with reference to each of equations (1b), (3b), and (4b), a variable referencing carbon dioxide emissions reported to the EPA by the utilities provider is required in order to determine GHG emissions consumed due to utilities resources consumption. Most utilities providers within the United States and other nation parties to the Paris Agreement are required to report GHG emissions to a regulatory agency, such as the EPA. The amount of GHG emitted by each of these utilities providers may vary, based on the type of fossil fuels consumed during generation or transport of such utilities, for example, or for various other reasons. As described in an embodiment with reference to FIG. 3, the DBMS control platform 350 operating the transparent GHG emissions validation and reporting service system may be in communication with a regulatory reporting agency tool 310 (e.g., EPA's Facilities Level Information on GHG Tool (FLIGHT)). Such a tool may, in some embodiments, require the identification or location for the utilities provider (e.g., “LNGPET_provider” referenced in equation (4b) above). In such an embodiment, as described in greater detail with reference to FIG. 4, the transparent GHG emissions validation and reporting service system may reference plant utility bills 436 to retrieve such utilities provider addresses. The transparent GHG emissions validation and reporting service system in an embodiment may use such a regulatory reporting agency tool to determine a GHG emissions value for each unit of resource consumed from each identified utilities provider.

Similarly, other entities within the supply chain may also customize generic GHG emissions equations for determining the GHG emitted due to consumption of electricity, water, natural gas, or petroleum during manufacture of other products. Equations customized by separate entities within the supply chain may differ from one another in that they point to data field values stored in different locations, where each location is owned, maintained, and controlled by a separate entity within the supply chain. For example, in an embodiment described with reference to FIG. 2A, the motherboard manufacturer 241B may customize equation (1a) by providing the following equation (1c) for determination of carbon dioxide emitted due to consumption of electricity during manufacture of a single motherboard:

$$[ Electricity\_CO 2 \_perMBD \_PMfg ] = \frac{[ EPA\_CO 2 \_perkWh \_Eprovider ] * [ kWh ]}{[ MBD\_output ]} \qquad ( 1 c )$$

By customizing and storing the equation (1c) into the global data repository in such a way, the motherboard manufacturer user of the DBMS control platform in an embodiment may grant permission for the DBMS control platform and the transparent GHG Emissions verification and reporting service system to access datasets containing data field values of “kWh,” and “MBD_output” from data maintained, stored, owned, and controlled by the motherboard manufacturer.

Each user of the DBMS control platform 280 (e.g., memory manufacturer and owner of 286 and motherboard manufacturer and owner of 287) may set permissions for various entities within the supply chain and the transparent GHG emissions validation and reporting service system to access the data referenced in these customized equations and maintained by separate entities (e.g., memory manufacturer and motherboard manufacturer). Users of the DBMS control platform 280 may grant separate levels of permission for separate entities. For example, the memory manufacturer may grant the transparent GHG emissions validation and reporting service system access to query and retrieve data field values associated with data field names identified within the given equations, but may not grant the motherboard manufacturer the same access. Users of the DBMS control platform 280 may also grant permission for other supply chain entities to access only a portion of their data. For example, the memory manufacturer may grant permission to the motherboard manufacturer to access GHG emission values determined by the transparent GHG emissions validation and reporting service system using underlying data that the motherboard manufacturer does not have permission to access. More specifically, the memory manufacturer may grant permission for the motherboard manufacturer to view the carbon dioxide emissions generated due to electricity consumption during manufacture of a single unit of RAM, as determined by the transparent GHG emissions validation and reporting service system and according to equation (1b), and stored within the global data repository. However, the memory manufacturer may deny permission for the motherboard manufacturer to view the number of RAM units manufactured within the reporting time period (e.g., “RAM_output”) required to make such a determination.

Each entity within the supply chain in an embodiment may provide similar customized equations and similar authorizations within a DBMS agent at that entity executing a GUI to access data field values identified by data field names given within those customized equations. For example, in an embodiment described with reference to FIG. 2A, the display manufacturer 245A may provide similar customized equations for determination of GHG emissions due to consumption of utility resources (e.g., electricity, water, petroleum) during manufacture of thin film transistors (TFTs) 246A, liquid crystal layers (LCLs) 246B, liquid crystal display (LCD) screens 247A, and organic light emitting diode (OLED) screens 247B. As another example, the computer manufacturer 241D may provide similar customized equations for determination of GHG emissions due to consumption of utility resources (e.g., electricity, water, petroleum) during manufacture of laptops 248A.

Entities within the supply chain may also provide GHG emissions equations for determining the GHG emitted due to consumption of electricity, water, natural gas, or petroleum during manufacture of a plurality of products via a DBMS agent executing a GUI for those entities. Equations pertaining to different products may differ from one another in that they point to data field values indicating the number of different products manufactured. For example, equation (1b) represents the GHG emissions from electricity consumption during the manufacture of RAM units 242, and references the number of RAM units 242 manufactured (e.g., “RAM_output”). In contrast, the following equation, customized by a computer manufacturer 241D may represent the GHG emissions from electricity consumption during the manufacture of laptops 248A, and references the number of laptops 248A manufactured (e.g., “Laptop_output”):

$$[ Electricity\_CO 2 \_perLaptop \_TMfg ] = \frac{[ EPA\_CO2 \_perkWh \_Eprovider ] * [ kWh ]}{[ Laptop\_output ]} \qquad ( 1 d )$$

Equations pertaining to different products may also differ from one another in that they point to data field values indicating utilities consumption at different locations (e.g., electricity consumed at plant 245A for manufacture of TFTs versus electricity consumed at plant 245B for OLED screen 247B manufacture). As described above with respect to FIG. 2C, for example, data describing electricity consumption (e.g., “kWh”) at a first display manufacturer plant may be stored at Plant A DBMS 284 while data describing electricity consumption (e.g., “kWh”) at a second display manufacturer plant may be stored at Plant B DBMS 285. In other embodiments, data pertaining to plant A and plant B may be stored at separate nodes within the DBMS control platform 280. Similarly, in an embodiment where a single plant manufactures a plurality of products (e.g., motherboard manufacturer producing CPUs and motherboards), the DBMS for that manufacturer (e.g., motherboard manufacturer DBMS 287) or a portion of data stored within DBMS control platform 280 on behalf of that manufacturer may separate data for each manufacturing line (e.g., CPUs versus motherboards) into separate nodes.

At block 706, a DBMS control platform user entity may provide a GHG emission determination equations identifying data field names for reporting GHG emissions during transport of raw materials or subcomponents used in the manufacture of a product. For example, in an embodiment described with respect to FIG. 4 in which manufacturer 430 is a memory manufacturer (e.g., 241A of FIG. 2), the manufacturer 430 may customize the following generic equation (5a) via a DBMS agent for determination of carbon dioxide emissions during transport of raw materials used in the manufacture of a single manufactured unit:

CO2 emitted during transportation of a user's manufactured product unit=(CO2 emitted during transportation of a first raw material or subcomponent*Amount of first raw material or subcomponent used in manufacture of user's product unit)+(CO2 emitted during transportation of a second raw material or subcomponent*Amount of second raw material or subcomponent used in manufacture of user's product unit) (5a)

More specifically, memory manufacturer 430 may customize generic equation (5a) to provide equation (5b) for determination of carbon dioxide emissions during transport of silicon used in the manufacture of a single RAM unit, for storage as a GHG emission equation 470:

[Transport_CO2_perRAM_MMfg]=[Transport_CO2_perSilicon_SSupp]*[Silicon_RAM_Ratio] (5b)

As can be seen by reference to equations (5a) and (5b), users of the DBMS control platform in an embodiment may not include each variable from the generic GHG emission determination equation in a customized GHG emission determination equation. For example, the RAM manufacturer described directly above may not include the variables describing CO2 emissions due to transport of a second raw material. This may be due to the fact that the primary or only raw material used in the manufacture of RAM units is silicon, for example. Other entities within the same supply chain for producing RAM units or end-products incorporating those RAM units, such as motherboards, may include more variables when customizing equation (5a) above. For example, motherboard manufacturer 241B may include CO2 emitted during transportation of both silver and copper used in the manufacture of a single CPU in an embodiment.

The data field name “Silicon_RAM_Ratio” in an embodiment described directly above with respect to equation (5b) may describe an amount of silicon that is used in the manufacture of each unit of RAM (e.g., 2 oz.). In such an embodiment, the data field name “transport_CO2_perSilicon_SSupp” may refer to another equation stored within GHG emission equations 470 that describes the determined CO2 emissions for the specific shipment of Silicon used to manufacture RAM units during the reporting time period. For example, the memory manufacturer may customize the following generic equation for determining CO2 emissions during transport of a raw material, subcomponent, or end-product:

CO2 emitted during transportation of raw material,subcomponent, or end product=Total fuel consumed during transport*Percentage of shipment weight attributable to raw material,subcomponent, or end product*Conversion value for fuel to CO2 (6a)

More specifically, the memory manufacturer may customize equation (6a) to provide equation (6b) below for determining CO2 emissions during transport of silicon, specifically:

[Transport_CO2_perSilicon_SSupp]=[Transport_fuel_perManifest]*[Manifest_date_Silicon_Shipment_Ratio]*[EPA_CO2_Fuel_Conversion] (6b)

The data field name “EPA_CO2_Fuel_Conversion” may refer to a dataset stored as reported emissions 461. In an embodiment, the reported emissions 461 may contain a conversion factor with a data field name “EPA_CO2_fuel_conversion” describing the number of pounds of carbon dioxide that are emitted per consumption of each gallon of fuel (e.g., “[CO2]/[Gallon_fuel]”. Each of the other data field names referenced within this equation (6b) above may refer to still other customized equations stored within the GHG emissions equations 470 in an embodiment. For example, a user may customize the following generic equation (7a) to create equation (7b) for [Transport_fuel_perManifest]. Generic equation (7a) may describe the amount of fuel burned during transport of a specific shipment of a raw material, subcomponent used to manufacture an end-product during a given reporting time period:

$$Total fuel consumed during transport = \frac{Mileage during transport}{Vehicle fuel efficiency} \qquad ( 7 a )$$

More specifically, the memory manufacture may customize equation (7a) to create equation (7b) below to describe the amount of fuel burned during transport of a specific shipment of silicon used to manufacture RAM units during the reporting time period, as determined with reference to material manifests 423 describing that transport:

$$[ Transport\_fuel \_perManifest ] = \frac{[ silicon\_manifest \_date \_mileage ]}{[ vehicle\_make \_model \_fuel \_efficiency ]} \qquad ( 7 b )$$

The data field name “silicon_manifest_date_mileage” may define a material manifest 423 for a shipment of silicon on a specific date. Such a material manifest 423 may include a data field name “mileage”, a data field name “vehicle_make,” and a data field name “vehicle_model.” The reported emissions 461 in an embodiment may store a dataset containing a data field name that includes the phrase “fuel_efficiency” and identifies the vehicle_make and model retrieved from the manifest 442. Such manifests 423 in an embodiment may also be blockchain verified and include an e-signature or other electronic identification of the shipment personnel that entered or edited these values into the manifest 423, as required by the blockchain agreement described with respect to block 702 above.

Equation (6b) above may also reference another equation named “[Manifest_date_Silicon_Shipment_Ratio],” which may have been customized by the user from the below generic equation describing the proportion of an entire shipment that comprised a specific raw material or subcomponent:

$$Percentage of shipment weight attributable to raw material , subcomponent , or end product = \frac{\begin{matrix}weight of raw material or quantity of \\ subcomponent or end product\end{matrix}}{\begin{matrix}total weight of shipment or total \\ quantity of subcomponents and end products\end{matrix}} \qquad ( 8 a )$$

More specifically, the memory manufacturer in an embodiment may customize the above equation (8a) to create the following equation (8b) describing the proportion of the entire shipment that comprised silicon, as determined with reference to material manifest 423 describing that transport:

$$[ Manifest\_Date \_Silicon \_shipment \_Ratio ] = \frac{[ Silicon \_UID \_QTY ]}{[ Total \_QTY ]} \qquad ( 8 b )$$

Shipment manifests often refer to specific materials by their unique identifiers (UIDs), rather than by the name of the material or the name of the product manufactured. In an embodiment, the data field name “Silicon_UID_QTY” may direct the transparent GHG emissions validation and reporting service system to query the materials accounting database 411 to determine the UID (e.g., “1234”) associated with the material “silicon.” The same material manifest 423 referenced with respect to equation (7b) above may include a data field name “UID_1234_QTY” indicating a quantity of products having the UID associated with Silicon, and a data field name “Total_QTY” indicating a total quantity of all products in the shipment.

Each entity within the supply chain may provide similar equations for transportation of raw materials or subcomponents used in the manufacture of their respective end products. For example, a manufacturer of CPUs may customize generic equation (5a) to create the following equation (5c) for determination of carbon dioxide emitted during transport of silver and copper per each manufactured CPU:

[Transport_CO2_perCPU_PMfg]={[Transport_CO2_perSilver_MSupp]*[Silver_CPU_Ratio]}+{[Transport_CO2_perCopper_MSupp]*[Copper_CPU_Ratio]} (5c)

The data field names “transport_CO2_perSilver_MSupp” and “transport_CO2_perCopper_Msupp” may refer to other equations, similar to equation (7b) above, that determine carbon dioxide emitted during the transport of silver and copper used in the manufacture of CPUs. In an embodiment, the data field names “silver_CPU_Ratio” and “copper_CPU_ratio” may indicate stored values for the amount of silver and the amount of copper used in the manufacture of each CPU, respectively.

The manufacture of CPUs may differ from the manufacture of RAM units in such an embodiment in that the CPU employs two materials (e.g., silver and copper), and the RAM unit employs a single material (e.g., silicon). Thus, equation (5c) provided by the CPU manufacturer may differ from equation (5b) provided by the RAM manufacturer in that equation (5c) references two separately determined carbon dioxide emissions values, each determined for a different mineral (e.g., “transport_CO2_perSilver_MSupp” and “transport_CO2_perCopper_Msupp”). Further, the equations used to determine each of these values may refer back to two separate manifests, including one for the shipment of copper used during the manufacture of certain CPUs, and one for the shipment of silver used during the manufacture of those CPUs. Such equations may be provided for each product manufactured using raw materials received from a mineral or other raw material supplier in an embodiment (e.g., for liquid crystals used in the manufacture of liquid crystal layers (LCLs)).

Each manufacturer of a product incorporating one or more subcomponents made using such raw materials may also provide such customized equations. In another example embodiment, a manufacturer of motherboards incorporating RAM units may customize equation (5a) to create the following equation (5d) for determination of carbon dioxide emitted during transport of RAM units and CPUs per each motherboard manufactured:

[Transport_CO2_perMBD_MMfg]={[Transport_CO2_perRAM_MMfg]*[RAM_MBD_Ratio]}+{[Transport_CO2_perCPU_PMfg]*[CPU_MBD_Ratio]} (5d)

The data field names “transport_CO2_perRAM_MMfg” and “transport_CO2_perCPU_PMfg” may refer to equations (5b) and (5c) given above by other entities within the supply chain. In an embodiment, the data field names “RAM_MBD_Ratio” and “CPU_MBD_ratio” may indicate stored values for the number of RAM units and the number of CPUs incorporated into each motherboard, respectively. Thus, for entities later in the supply chain (e.g., entities incorporating subcomponents rather than raw materials into manufactured products), the equations provided by a product manufacturer may refer back to equations provided by other entities.

Such equations may be provided for each stage of transportation within a given supply chain in an embodiment. For example, these equations may be provided for determining the GHG emissions due to transportation of copper and gold for the manufacture of thin film transistors (TFTs), or liquid crystals for the manufacture of liquid crystal layers (LCLs). As another example, equations may be provided to determine the GHG emissions due to transportation of TFTs for incorporation within organic light emitting diode (OLED) screens, or due to transportation of motherboards and OLED screens within laptops.

At block 708, DBMS platform users may provide GHG emission determination equations identifying data field names for reporting GHG emissions during waste generation in an embodiment. For example, in an embodiment described with reference to FIG. 4 in which manufacturer 430 is a memory manufacturer, the memory manufacturer may customize the following generic equation for determining CO2 emissions attributable to the generation of waste during the manufacture of a user's manufactured subcomponent or end product:

$$C O 2 emitted by generation of waste during manufacture of user ’ s subcomponent or end product = \frac{\begin{matrix}C O 2 emitted by waste disposal company per \\ pound * Pounds of waste generated\end{matrix}}{\begin{matrix}Number of user ’ ssubcomponent \\ or end product manufactured\end{matrix}} \qquad ( 9 a )$$

More specifically, a memory manufacturer may have customized this equation (9a) to create the following equation (9b) for determining carbon dioxide emissions attributable to the generation of waste during the manufacture of a single RAM unit in an embodiment:

$$[ Waste \_CO 2 \_perRAM \_MMfg ] = \frac{[ EPA\_CO 2 \_perLB \_Wprovider ] * [ Lbs\_ Waste ]}{[ RAM\_ output ]} \qquad ( 9 b )$$

In such an example embodiment, plant utility bills 436 may store a data field set containing the data field name “Lbs_waste” and the data field value “1000” to indicate that the facility manufacturing RAM produced 1,000 pounds of waste. The product accounting database 434 in an embodiment may store a data field set containing the data field name “RAM_output” and the data field value “1000” to indicate that the plant manufactured 1000 RAM units. Plant utility bills 436 in an embodiment may include a dataset having a data field name “Wprovider” indicating the name of the waste management company providing service to the memory manufacturer, and a data field value of “Waste Management Corp.” or other identifying information that may be used to search emissions reported to the EPA or other governmental agency, as described directly below. Such utility bills 436 in an embodiment may also be blockchain verified and include an e-signature or other electronic identification of the employee of the utilities provider or the product manufacturer that entered or edited these values into the utility bills 436, as required by the blockchain agreement described with respect to block 702 above.

As can be seen with reference to each of equation (9b) a variable referencing carbon dioxide emissions reported to the EPA by the utilities provider is required in order to determine GHG emissions consumed due to utilities resources consumption. As described in an embodiment with reference to FIG. 3, the DBMS control platform 350 operating the transparent GHG emissions validation and reporting service system may be in communication with a regulatory reporting agency tool 310 (e.g., EPA's Facilities Level Information on GHG Tool (FLIGHT)). Such a tool may, in some embodiments, require the identification or location for the utilities provider (e.g., “Wprovider” referenced in equation (9b) above). In such an embodiment, as described in greater detail with reference to FIG. 4, the transparent GHG emissions validation and reporting service system may reference plant utility bills 436 to retrieve such utilities provider addresses. The transparent GHG emissions validation and reporting service system in an embodiment may use such a regulatory reporting agency tool to determine a GHG emissions value for each unit of resource consumed from each identified utilities provider.

Similarly, other entities within the supply chain may also customize generic equation (9a) to provide customized GHG emissions equations for determining the GHG emitted due to generation of waste. Equations customized by separate entities within the supply chain may differ from one another in that they point to data field values stored in different locations, where each location is owned, maintained, and controlled by a separate entity within the supply chain. For example, in an embodiment described with reference to FIG. 2A, the motherboard manufacturer 241B may customize equation (9a) above to create the following equation (9c) for determination of carbon dioxide emitted due to generation of waste during manufacture of a single motherboard:

$$[ Waste \_CO 2 \_ perMBD\_PMfg ] = \frac{[ EPA\_CO 2 \_perLB \_Wprovider ] * [ Lb\_Waste ]}{[ MBD\_ output ]} \qquad ( 9 c )$$

By customizing equation (9a) and storing equation (9c) via the user's DBMS agent into the global data repository for use with secure, gathered data therein in such a way, the motherboard manufacturer user of the DBMS control platform in an embodiment may grant permission for the DBMS control platform and the transparent GHG Emissions verification and reporting service system to access datasets containing data field values of “Lb_Waste,” and “MBD_output” from data maintained, stored, owned, and controlled by the motherboard manufacturer.

Each entity within the supply chain in an embodiment may provide similar customized equations and similar authorizations to access data field values identified by data field names given within those customized equations. For example, in an embodiment described with reference to FIG. 2A, the display manufacturer 245A may provide similar customized equations for determination of GHG emissions due to generation of waste during manufacture of thin film transistors (TFTs) 246A, liquid crystal layers (LCLs) 246B, liquid crystal display (LCD) screens 247A, and organic light emitting diode (OLED) screens 247B. As another example, the computer manufacturer 241D may provide similar customized equations for determination of GHG emissions due to generation of waste during manufacture of laptops 248A.

Entities within the supply chain may also provide customized GHG emissions equations for determining the GHG emitted due to generation of waste during manufacture of a plurality of products. Customized equations pertaining to different products may differ from one another in that they point to data field values indicating the number of different products manufactured. For example, equation (9b) represents the GHG emissions from generation of waste during the manufacture of RAM units 242, and references the number of RAM units 242 manufactured (e.g., “RAM_output”). In contrast, equation (9c) references the number of Motherboards 243 manufactured (e.g., “MBD_output”).

Equations pertaining to different products may also differ from one another in that they point to data field values indicating waste generation at different locations, for disposal by different waste management companies (e.g., waste generated at plant 245A for manufacture of TFTs versus waste generated at plant 245B for OLED screen 247B manufacture). As described above with respect to FIG. 2C, for example, data describing waste generated (e.g., “Lb_waste”) at a first display manufacturer plant may be stored at Plant A DBMS 284 while data describing waste generated (e.g., “Lb_waste”) at a second display manufacturer plant may be stored at Plant B DBMS 285. In other embodiments, data pertaining to plant A and plant B may be stored at separate nodes within the DBMS control platform 280. Similarly, in an embodiment where a single plant manufactures a plurality of products (e.g., motherboard manufacturer producing CPUs and motherboards), the DBMS for that manufacturer (e.g., motherboard manufacturer DBMS 287) or a portion of data stored within DBMS control platform 280 on behalf of that manufacturer may separate data for each manufacturing line (e.g., CPUs versus motherboards) into separate nodes.

At block 710, a DBMS platform user may customize generic GHG emission determination equations to identify data field names for reporting GHG emissions during chemical or minerals manufacturing processes in an embodiment. Various governmental reporting agencies may require GHG emissions reporting from certain manufacturers of chemicals or materials refining companies. These emissions may be limited to GHGs emitted specifically during certain chemical processes or refinement processes, such as chemical etching to produce TFTs. Each entity within the supply chain may provide an equation for determining such GHG emissions, where applicable. For example, in an embodiment described with reference to FIG. 4, in which the product manufacturer 430 is a display manufacturer of TFTs, the display manufacturer may customize the following generic equation (10a) for determination of GHG emissions generated during a chemical process:

CO2 equivalent emitted during generation of chemical process by-products=(amount of first by-product*CO2 equivalent of first by-product)+(amount of second by-product*CO2 equivalent of second by-product) (10a)

More specifically, a display manufacturer of TFTs may customize equation (10a) to create equation (10b), below for determination of the equivalent CO2 generated during chemical etching of TFTs that produces the by-products perfluorocarbons (PFCs) and hydroperfluorocarbons (HFCs):

[Etching_CO2e_perTFT_DMfg]={[PFC_Sensor_Value]*[EPA_PFC_CO2e]}+{[HFC_Sensor_Value]*[EPA_HFC_CO2e]} (10b)

This customized equation may describe a value of carbon dioxide gases that is equivalent to actually observed emissions of PFCs and HFCs during chemical etching, for example. These actual emissions may be monitored in various embodiments by sensors within a manufacturing or refining facility. More specifically, such sensor readings may be taken from supplier sensor readings 414 or plant sensor readings 437 in an embodiment. Governmental reporting agencies may provide conversion factors, which may be stored within GHG emissions equations 470 for converting these actually observed emissions from sensors 414 or 437 into an equivalent of carbon dioxide (or other greenhouse gas) emission. For example, “EPA_PFC_CO2e” data field name may point to a data field value of 0.044 kg PFC per ton of carbon dioxide, as stored in GHG emissions equations 470.

A DBMS platform user in an embodiment may provide GHG emission determination equations identifying data field names for reporting indirect GHG emissions from earlier supply chain entities at block 712. As described herein, all GHG emissions generated prior to beginning the manufacturing process for a particular product (e.g., extraction, refinement, and transportation of raw materials) may be referred to herein as indirect emissions with respect to manufacture of that product. Indirect emissions incorporate all emissions generated at earlier stages of the supply chain for a given product. For example, in an embodiment described with reference to FIG. 4 in which manufacturer 430 is a memory manufacturer, the memory manufacturer may customize the following equation (11a) for indirect emissions by entities earlier in the supply chain than the memory manufacturer:

$$Indirect C O 2 emissions attributable to manufacture of a single subcomponent or end product = \frac{C O 2 emissions generated by first raw material supplier}{Total volume of first raw material extracted or refined} * Volume of first raw material used in each subcomponent or end product manufactured \qquad ( 11 a )$$

More specifically, the memory manufacturer may customize equation (11a) by creating the following equation (11b) for determination of indirect emissions generated prior to manufacture of RAM units, but attributable to each RAM unit so manufactured:

$$[ Indirect \_CO 2 \_perRAM \_MMfg ] = \frac{[ EPA\_CO 2 \_SSupp ]}{[ Silicon\_output ]} * [ Silicon\_RAM \_R atio ] \qquad ( 11 b )$$

In order to determine the indirect GHG emissions produced by a raw materials supplier that may be attributable to a single end product (e.g., RAM), equation (11a) divides a total carbon dioxide emissions value over a preset time period by the volume of a raw material (e.g., silicon as shown in equation (11b)) produced in that time period and multiplies this by the ratio of that raw material used in each subcomponent or end-product manufactured (e.g., single unit of RAM as shown in equation (11b)). As can be seen with reference to equation (11b), a variable referencing carbon dioxide emissions reported to the EPA by the raw materials supplier (e.g., Silicon Supplier “SSupp”) is required in order to determine GHG emissions during extraction, refinement, or manufacture of certain raw materials, including silicon, rare earth minerals (e.g., copper, silver, gold), and other chemicals (e.g., liquid crystals). Most raw materials suppliers within the United States and other nation parties to the Paris Agreement are required to report GHG emissions to a regulatory agency, such as the EPA. The amount of GHG emitted by each of these raw materials suppliers may vary, based on the type of fossil fuels consumed during extraction, refinement, or manufacture, for example, or for various other reasons. As described in an embodiment with reference to FIG. 3, the DBMS control platform 350 operating the transparent GHG emissions validation and reporting service system may be in communication with a regulatory reporting agency tool 310 (e.g., EPA's Facilities Level Information on GHG Tool (FLIGHT)). These tools may report GHG emissions over preset time periods of required reporting, such as monthly, quarterly, or annually. The transparent GHG emissions validation and reporting service system in an embodiment may use such a regulatory reporting agency tool to determine a GHG emissions value for each unit of raw materials (e.g., pounds of silicon) incorporated into a manufactured product (e.g., one unit of RAM).

Such a tool may, in some embodiments, require the identification or location for the raw materials supplier (e.g., “SSupp” referenced in equation (11b) above). In such an embodiment, as described in greater detail with reference to FIG. 4, the transparent GHG emissions validation and reporting service system may reference Supplier contact information 431 to retrieve such information. The data field name “Silicon_output” may reference a data field value stored in the material accounting database 411 representing the volume of silicon manufactured over the preset time period in which the tool reported GHG emissions, as described directly above. The data field name “Silicon_RAM_Ratio” may reference another value stored in the product accounting database 434 for the memory manufacturer 430 describing the volume of silicon used to produce each unit of RAM.

In other embodiments, a product manufacturer may incorporate a plurality of raw materials into a single product. For example, a CPU manufacturer in an embodiment may incorporate both silver and copper into a single CPU. In such an embodiment, a CPU manufacturer may customize equation (11a) to create the following customized equation via an agent of the DBMS control platform for determination of indirect emissions generated during manufacture of a single CPU.

$$[ Indirect \_CO 2 \_perCPU \_MMfg ] = \{ \frac{[ EPA\_CO 2 \_MSupp \_PlantA ]}{[ Silver\_output ]} * [ Silver \_CPU \_ Ratio ] \} + \{ \frac{[ EPA\_CO 2 \_MSupp \_PlantB ]}{[ Copper\_output ]} * [ Copper \_CPU \_ Ratio ] \} \qquad ( 11 c )$$

In order to determine the indirect GHG emissions produced by a raw materials supplier that may be attributable to a single end product (e.g., CPU) manufactured using a plurality of raw materials, equation (11c) divides a total carbon dioxide emissions value over a preset time period for a first plant refining silver by the volume of silver produced in that time period and multiplies this by the ratio of silver used in each CPU. Equation (11c) may also divide a total carbon dioxide emissions value over a preset time period for a second plant refining copper by the volume of copper produced in that time period and multiply this by the ratio of copper used in each CPU. The data field names “Silver output” and “Copper output” may reference data field values stored in the material accounting database 411 representing the volumes of silver and copper refined, respectively, over the preset time period in which the EPA reported GHG emissions for each plant. The data field names “Silver_CPU_Ratio” and “Copper_CPU_Ratio” may reference other values stored in the product accounting database 434 for the CPU manufacturer 430 describing the amounts of silver and copper, respectively, used to produce each CPU.

In still other embodiments, a product manufacturer may incorporate a plurality of subcomponents into a final product. For example, a motherboard manufacturer may incorporate one or more RAM units and one or more CPUs into a single motherboard. In such an embodiment, the motherboard manufacturer may customize equation (11a) above to create the following customized equation (11d) for determination of indirect GHG emissions generated during the manufacture of the RAM and CPUs incorporated into each motherboard:

[Indirect_CO2_perMBD_PMfg]={[Distributed_CO2_perRAM_MMfg]*[RAM_MBD_Ratio]}+{[Distributed_CO2_perCPU_MMfg]*[CPU_MBD_Ratio]} (11d)

As can be seen with reference to equation (11d), determination of indirect emissions for each motherboard manufactured may be determined using stored values for determinations made using the equations (e.g., 11b and 11c above) provided by other entities in the supply chain that supply subcomponents (e.g., RAM, CPU) to the end product manufacturer (e.g., motherboard manufacturer). More specifically, the data field name “Distributed_CO2_perRAM_MMfg” may refer to a reported emission 461 generated and stored by the transparent GHG emissions validation and reporting service system (e.g., as described in greater detail below with respect to FIG. 8 at block 818) pursuant to equation (11b) provided by the memory manufacturer and pursuant to equation (11c) provided by the CPU manufacturer. Each of these values may be multiplied by a ratio of memory units or CPUs to each motherboard, respectively. More specifically, the data field name “RAM_MBD_Ratio” may refer to a data field value stored in the motherboard manufacturer's product accounting database 434 describing the number of RAM units incorporated within each motherboard. Similarly, the data field name “CPU_MBD_Ratio” may refer to a data field value stored in the motherboard manufacturer's product accounting database 434 describing the number of CPUs incorporated within each motherboard.

As described in greater detail below with respect to FIG. 8, the transparent GHG emissions validation and reporting service system in an embodiment may perform one or more forms of validation or verification of GHG emissions values determined using these customized equations. For example, the transparent GHG emissions validation and reporting service system may compare GHG emissions values determined using equations generated by two separate entities customizing the same generic equation. More specifically, two separate memory manufacturers may customize equation (1a) to create a customized equation (e.g., (1b)) for determining CO2 emissions generated during manufacture of a single RAM unit due to electricity consumption. Each of these customized equations may manipulate data gathered from separate sources (e.g., one equation based on data gathered by a first memory manufacturer and a second equation based on data gathered by a second memory manufacturer). The transparent GHG emissions validation and reporting service system in an embodiment may compare the GHG emissions determined using the first manufacturer's equation and data with the GHG emissions determined using previous reporting instances or the second manufacturer's equation and data. If a significant discrepancy is found between these two GHG emissions determinations, the transparent GHG emissions validation and reporting service system in an embodiment may alert each of the memory manufacturers, as well as any other entity within the supply chain whose customized GHG emission equations reference either of those memory manufacturer's GHG emission values. In such a way, the transparent GHG emissions validation and reporting service system in various embodiments may provide transparent, verified determinations of GHG emissions across multiple stages of the supply chain. This is only one example of such additional verification, and other examples may be provided below with respect to FIG. 8.

Similar customized equations may be provided by each subcomponent or end product manufacturer in various embodiments. For example, in an embodiment described with reference to FIG. 2A, the display manufacturer 245A may provide similar customized equations for determination of GHG emissions due to generation of waste during manufacture of thin film transistors (TFTs) 246A, liquid crystal layers (LCLs) 246B, liquid crystal display (LCD) screens 247A, and organic light emitting diode (OLED) screens 247B. As another example, the computer manufacturer 241D may provide similar customized equations for determination of GHG emissions due to generation of waste during manufacture of laptops 248A.

A data value with the data field name provided by a DBMS user at block 702 may be gathered by any DBMS user entity for blockchain verification in an embodiment at block 714. For example, data field values for any of the data field names given in any of the customized equations above (e.g., equations 1b, 1c, 1d, 2b, 3b, 4b, 5b, 5c, 5d, 6b, 7b, 8b, 9b, 9c, 10b, 11b, 11c, or 11d) may be routinely gathered from various external DBMSs (e.g., 321, 331, or 341) and shared according to permissions preset by each of the entities within the supply chain prior to trading of goods or gathering of data from either the DBMS control platform 350 or any individual DBMSs (e.g., 321, 331, or 341) for determination of GHG emissions.

At block 716, the transparent GHG emissions validation and reporting service system may determine whether the blockchain for the data field value gathered from the DBMS user entity can be verified. For example, as described in an embodiment with reference to FIG. 3, the DBMS control platform 350 may refer to the blockchain in metadata associated with the retrieved data field values to determine their authenticity. Any data field values not passing such a blockchain verification may be discarded, while data field values that can be verified may be stored within the global data repository 360. A blockchain verification component 355 in an embodiment may operate to confirm the source of data (e.g., 321, 331, or 341) to confirm its authenticity. This may be performed, for example, by reference to a digital token (e.g., cyclic redundancy check (CRC), QR code, etc.) provided to each supply chain entity upon agreement of the blockchain licensing agreement.

Each remote DBMS (e.g., supplier DBMS 321, manufacturer DBMS 331, or customer DBMS 341) may require local data validation. Each of the entities in control of these DBMS s (e.g., 321, 331, and 341) in an embodiment may agree to such a local data validation, which may require each data field value identified by any entity as a value upon which GHG emissions may be determined (e.g., as described above with reference to equations (1a) and (1b)) to be associated with a valid e-signature or other identifying process that can particularly identify specific personnel entering such data. The transparent GHG emissions validation and reporting service system in an example embodiment may routinely retrieve data field values associated with the data field name “MBD_output,” describing the number of motherboards manufactured within a specific time period, from the product manufacturer DBMS 331. At this point, the DBMS control platform 350 may additionally refer to the blockchain in metadata associated with the retrieved data field values to determine their authenticity. Data gathered from each of the subcomponent manufacturers may be included within an immutable blockchain information ensuring the data has not been tampered with, or, if the data has been tampered or is errant with, providing a simple method of identifying the time and identity of the person or entity attempting to tamper with the data or reporting errant data.

If the blockchain cannot be verified, the transparent GHG emissions validation and reporting service system may not store the data field value within the global data repository from which GHG emissions determinations are made, because the data field value may not be reliable or accurate information. The method may then proceed to block 718. If the blockchain can be verified, the data field value may be reliably used to determine GHG emissions for one or more entities within the supply chain, and the method may proceed to block 720 for storage of the data field value within the global data repository.

In an embodiment in which the blockchain for the data field value cannot be verified by the transparent GHG emissions validation and reporting service system, the transparent GHG emissions validation and reporting service system may store the data field value outside of the global data repository, or may discard the data field value if it was retrieved from an external DBMS user entity operated independently from the DBMS control platform at block 718. For example, any data records not validated by the blockchain verification component 355 in such a manner may be discarded by the DBMS control platform 350, and may not be stored within the global data repository 360. Additionally, should any data field values fail to pass blockchain verification, the DBMS control platform 350 in an embodiment may notify any entity that has identified this data field as necessary to determine GHG emissions that the data field value has been discarded for failure to meet blockchain verification. Because the blockchain for such a discarded data field value contains an identification of the person or entity that entered the erroneous data, the DBMS control platform 350 in such an embodiment may further identify each entity of the source of the erroneous data. The method for gathering and verifying information from each entity within a supply chain for an end product necessary to determine GHG emissions may then end.

At block 720, the blockchain verified data value may be stored at an agreed upon node within the global data repository in an embodiment. For example, any data records validated by the blockchain verification component 355 in such a manner may be stored within the global data repository 360. As a consequence, GHG emissions determinations made based on data records stored within the global data repository 360, such as described below with respect to FIG. 8 in an embodiment may rely only upon data from verified authentic sources. The method for gathering and verifying information from each entity within a supply chain for an end product necessary to determine GHG emissions generated pursuant to manufacture of that product for consumers may then end.

FIG. 8 is a flow diagram illustrating a method of retrieving information from each entity within a supply chain for an end product and determining GHG emissions generated pursuant to manufacture of that product according to an embodiment of the present disclosure. As described herein, determination of GHGs emitted during manufacture of a product is a complex process that includes data gathering and analysis of procedures followed at every step of the supply chain, between the raw materials supplier and the end consumer of a single product. The transparent GHG emissions validation and reporting service system in an embodiment may gather, verify, and report information from each entity within the supply chain necessary to determine GHG emissions generated pursuant to manufacture of a single end product for consumers.

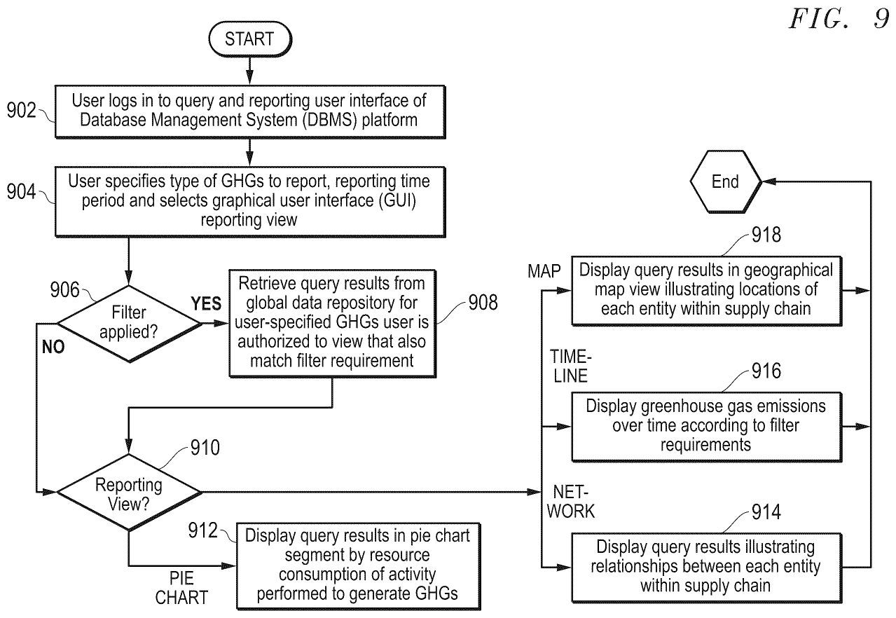

At block 802, the transparent GHG emissions validation and reporting service system in an embodiment may retrieve customized GHG emissions equations matching data gathering query parameters received via a query and reporting user interface. As described herein, the transparent GHG emissions verification and reporting service system in an embodiment may routinely gather data from multiple entities within a supply chain and determine GHG emissions pursuant to user-customized equations, prior to reporting of any such data. The data gathering query parameters in an embodiment may define datasets by data field name that are required to make such determinations. These data gathering query parameters may differ from reporting query parameters (e.g., as described in greater detail with respect to FIG. 9, below) in that the data gathering query parameters are input by the transparent GHG emissions verification and reporting service system, while the reporting query parameters may be supplied by a user of the system via a GUI, as described in greater detail below with respect to FIG. 9. Thus, the process described with reference to FIG. 8 may occur entirely prior to the reporting process described with reference to FIG. 9 in some embodiments. In other embodiments, portions of each of those processes may overlap one another.

As described above with reference to FIG. 7, customizing equations for determination of GHG emissions during manufacture of specific products for storage within the global data repository may prompt the transparent GHG emissions validation and reporting service system in an embodiment to retrieve any data records having data field names matching variables within any of these customized equations. This may be performed routinely on a daily, weekly, monthly, quarterly, or annual basis, for example. The data field names within these equations may comprise the data gathering query parameters described directly above.

The transparent GHG emissions validation and reporting service system in an embodiment may retrieve all equations identifying a specific DBMS control platform user (e.g., “MMfg” identifying a memory manufacturer) in an embodiment. For example, the manufacturer of RAM may have provided equation (2b) above to determine distributed GHG emissions due to manufacture of a single RAM unit, which may reference further equations having data field names “Electricity_CO2_perRAM_MMFg,” “H2O_CO2_perRAM_MMfg,” and “LNGPET_CO2_perRAM_MMfg,” for determination of GHG emissions during consumption of various utilities per unit of RAM manufactured, as described in greater detail below with respect to block 804. Equation (2b) above in an embodiment may also reference a further equation having a data field name “Transport_CO2_perRAM_MMfg,” for determination of GHG emissions during transport of raw materials per unit of RAM manufactured, as described in greater detail below with respect to block 808. In an embodiment, equation (2b) above may also reference a further equation having a data field name “Waste_CO2_perRAM_MMfg,” for determination of GHG emissions during consumption of water per unit of RAM manufactured, as described in greater detail below with respect to block 812. Additionally, equation (2b) above may also reference a further equation in an embodiment having a data field name “indirect_CO2_perRAM_MMfg,” for determination of indirect GHG emissions made by entities earlier in the supply chain, as described in greater detail with respect to block 818. The transparent GHG emissions validation and reporting service system in an embodiment may gather each of these customized equations in an embodiment at block 802.

At block 804, the transparent GHG emissions validation and reporting service system in an embodiment may retrieve records indicating electricity, water, petroleum, and natural gas consumption over the determined reporting time period for the user specified manufacturer, product, component, plant, supplier, or customer. As described above with reference to block 802, the transparent GHG emissions validation and reporting service system in an embodiment may retrieve all customized equations matching the reporting query parameters received via the GUI and the query and reporting user interface. Further, the system may assess that validation data, e-signatures or source information is attached for validation, where required, or that the block chain passes a verification check for access.

In an embodiment described with reference to FIG. 4, in which the memory manufacturer (e.g., 241A from FIG. 2) is the manufacturer 430, the transparent GHG emissions validation and reporting service system in such an embodiment may retrieve, for example, the GHG emission equation 470 for determining the direct GHG emissions value for electricity consumption per RAM unit manufactured:

$$[ Electricity \_CO 2 \_perRAM \_MMfg ] = \frac{[ EPA\_CO 2 \_perkWh \_Eprovider ] * [ kWh ]}{[ RAM\_ output ]} \qquad ( 1 b )$$

For example, in an embodiment described with reference to FIG. 4, in which manufacturer 430 is a memory manufacturer, the transparent GHG emissions validation and reporting service system in an embodiment may query plant utility bills 436 to retrieve a data field set containing the data field name “kWh” and the data field value “1000” to indicate that the facility manufacturing RAM consumed 1000 kWh of electricity. As described above with respect to FIG. 7 at blocks 716-720, only data that has been blockchain verified may be accessible during such a query. Data gathered from each of the subcomponent manufacturers may include or be included within immutable blockchain information ensuring the data has not been tampered with, or, if the data has been tampered with or reports errant data, providing a method of identifying the time and identity of the person or entity attempting to tamper with the data or report errant data via access to attached data validation with reported data (e.g, within the blockchain.

The transparent GHG emissions validation and reporting service system in an embodiment may query the product accounting database 434 in an embodiment to retrieve a data field set containing the data field name “RAM_output” and the data field value “1000” to indicate that the plant manufactured 1000 RAM units. The transparent GHG emissions validation and reporting service system in an embodiment described with reference to FIG. 3 may use tool 310 to determine that the electricity corporation supplying electricity to a RAM manufacturer generates 0.85 pounds of CO2 during generation of one kWh of electricity.

This process may be repeated for equations (3b) and (4b), referenced above with respect to FIG. 7 at block 704, for determination of the GHG emissions during consumption of other utilities resources by the same manufacturer (e.g., memory manufacturer). This process may also be performed to determine GHG emissions due to consumption of electricity, water, natural gas, or petroleum by other manufacturers, on a per product basis, for other products manufactured by those manufacturers.

As described in an embodiment with reference to FIG. 3, above, the DBMS control platform 350 may also store metadata associated with such customized equations (e.g., 1(b) customized for use by the memory manufacturer) that identify the generic or generalized equation (e.g., 1(a) generally describing variables needed to determine GHG emitted during manufacture of a product due to electricity consumption) upon which the customized equation was based. This may enable the DBMS control platform 350 to compare determined GHG emissions values for multiple manufacturers of the same or similar components (e.g., multiple memory manufacturers) that created their respective customized equations by customizing the same generic equation (e.g., equation (1a)) in an embodiment. For example, the DBMS control platform 350 may notify a motherboard manufacturer when the GHG emissions for one RAM manufacturer does not match or differs markedly from the GHG emissions for other RAM manufacturers. This may indicate that the outlier RAM manufacturer has tampered with or misreported data used during determination of its GHG emissions. In other instances, this may indicate the outlier RAM manufacturer has developed a more environmentally-friendly manufacturing process. In either case, identification of the RAM subcomponent manufacturer in an embodiment may assist the motherboard manufacturer in determining which RAM manufacturers to engage in the future (e.g., preferring a more environmentally-friendly RAM manufacturer or avoiding a RAM manufacturer erroneously reporting GHG emissions).

In such cases where data values or GHG emissions from two separate sources do not match or differ markedly, the transparent GHG emissions validation and reporting service system operating at the DBMS control platform 350 may report this mismatch and identify the data field values that do not match and their time of entry, as well as the entities (e.g., employee name) that provided the mismatched information. In such a way, the transparent GHG emissions validation and reporting service system and the DBMS control platform in an embodiment may gather from multiple entities within the supply chain and verify the authenticity of data, via attached validation data and block chain verification, used to determine GHG emissions generated during manufacture of a specific subcomponent or end product, while preventing tampering or misreporting.

The transparent GHG emissions validation and reporting service system in an embodiment may convert consumption values to GHG emission units for GHG emissions attributable to resource consumption at block 806. The transparent GHG emissions validation and reporting service system in an embodiment may enter the data field values associated with the data field names given within each retrieved equation (e.g., as described with reference to block 802 above) into each equation in order to determine a GHG emission value. For example, in an embodiment in which the transparent GHG emissions validation and reporting service system has retrieved equation (1b) for carbon dioxide emissions due to consumption of electricity during manufacture of a single RAM unit, the transparent GHG emissions validation and reporting service system may enter the data field value of 10 as the value of the variable “EPA_CO2_perkWh_Eprovider” describing the GHG emissions per kWH generated, as reported to the EPA from the provider of electricity for the memory manufacturing plant into equation (1b). As another example, the transparent GHG emissions validation and reporting service system may enter the data field value of 1,000 as the value of the variable “kWh” describing the number of kWh of electricity consumed during the reporting time period, and may enter the data field value of 1,000 as the value of the variable “RAM_output” identifying the number of RAM units manufactured during the reporting time period. Using equation (1b) and each of these variable values, the transparent GHG emissions validation and reporting service system in such an embodiment may determine that 1.2 pounds of carbon dioxide were generated during the manufacture of each unit of RAM during the reporting time period in one particular embodiment. The transparent GHG emissions validation and reporting service system may then store a data field value of 1.2 associated with the data field name “Electricity_CO2_perRAM_MMfg” and associated with the date upon which all supporting datasets were gathered in an embodiment. This determined and stored carbon dioxide emissions value per RAM unit produced may be stored in an embodiment described with reference to FIG. 4 as a reported emission 461, for example.

This process may be repeated for each of the equations returned at block 802 in an embodiment. For example, the transparent GHG emissions validation and reporting service system in an embodiment may retrieve all records identified within the equation (3b) for “H2O_CO2_perRAM_MMfg,” and store a determined GHG emission value calculated using that equation and the referenced data records within reported emissions 461. The data may be validated from attached validation data and verified from within a blockchain to ensure transparency. Similarly, the same process may be repeated for an equation describing carbon dioxide emissions due to natural gas or petroleum consumption during manufacture of a single unit of RAM. In other embodiments, the transparent GHG emissions validation and reporting service system may perform this process for other manufacturers (e.g., motherboard manufacturer 241B, display manufacturer 241C, or computer manufacturer 241D in FIG. 2). In still other embodiments, the transparent GHG emissions validation and reporting service system may perform this process for other products (e.g., CPU 244, motherboard 243, thin-film transistor (TFT) 246A, liquid crystal layer (LCL) 246B, liquid crystal display (LCD) screen 247A, organic light-emitting diode (OLED) screen 247B, laptop 248A, or tablet 248B in FIG. 2A).

At block 808, the transparent GHG emissions validation and reporting service system in an embodiment may retrieve records indicating transportation distance and type for the user specified manufacturer, product, component, plant, supplier, or customer. As described above with reference to block 802, the transparent GHG emissions validation and reporting service system in an embodiment may retrieve all equations matching the reporting query parameters received via the GUI and the query and reporting user interface. As described above with respect to FIG. 7 at blocks 716-720, only data that has been blockchain verified may be accessible during such a query. Data gathered from each of the subcomponent manufacturers may include immutable blockchain information which may include reporting data as well as attached validation data from a source to ensure the data has not been tampered with or misreported, or, if the data has been tampered with misreported, providing a method of identifying the time and identity of the person or entity attempting to tamper with the data or misreporting the data.

In an embodiment described with reference to FIG. 4, in which the memory manufacturer (e.g., 241A from FIG. 2) is the manufacturer 430, the transparent GHG emissions validation and reporting service system in such an embodiment may retrieve, for example, the GHG emission equation 470 (e.g., FIG. 7, above) for determining the direct GHG emissions value for transportation of raw materials used in the manufacture or RAM:

[Transport_CO2_perRAM_MMfg]=[Transport_CO2_perSilicon_SSupp]*[Silicon_RAM_Ratio] (5b)

In an embodiment described with reference to FIG. 4, in which the memory manufacturer is the manufacturer 430 and the silicon supplier is supplier 410, the transparent GHG emissions validation and reporting service system may retrieve a data field value (e.g., 2 oz.) associated with the data field name “Silicon_RAM_Ratio” as stored within the product accounting database 434 by the memory manufacturer 430. Again, such a query may only retrieve blockchain verified data and may ensure validation data is available. In such an embodiment, the data field name “transport_CO2_perSilicon_SSupp” may refer to another customized equation stored within GHG emission equations 470 that describes the determined CO2 emissions for the specific shipment of Silicon used to manufacture RAM units during the reporting time period:

[Transport_CO2_perSilicon_SSupp]=[Transport_fuel_perManifest]*[Manifest_date_Silicon_Shipment_Ratio]*[EPA_CO2_Fuel_Conversion] (6b)

The reported emissions 461 in an embodiment may contain a conversion factor with a data field name “EPA_CO2_fuel_conversion” describing the number of pounds of carbon dioxide that are emitted per consumption of each gallon of fuel (e.g., “[CO2]/[Gallon_fuel]”), having a data field value of 22.38 pounds of CO2. Each of the other data field names referenced within this equation (5b) above may refer to still other equations stored within the GHG emissions equations 470 in an embodiment. For example, the following equation may describe the amount of fuel burned during transport of the specific load of silicon used to manufacture RAM units during the reporting time period, as determined with reference to material manifests 423 describing that transport:

$$[ Transport\_fuel \_perManifest ] = \frac{[ silicon\_manifest \_date \_mileage ]}{[ vehicle\_make \_model \_fuel \_efficiency ]} \qquad ( 7 b )$$

The transparent GHG emissions validation and reporting service system in an embodiment may query the product accounting database 434 for memory manufacturer 430, for example, to determine a date of shipment for a load of silicon used during manufacture of RAM units produced at the time of data gathering. A material manifest 423 having that shipment date may then be queried by the transparent GHG emissions validation and reporting service system to determine mileage of that transport and the vehicle make and model. For example, the manifest 423 may include a data field name “mileage” having a data field value of 1,000 miles, a data field name “vehicle_make” having a data field value of “Freightliner,” and a data field name “vehicle_model” having a data field value of “Columbia_2007.” The reported emissions 461 in an embodiment may store a dataset containing a data field name that includes the phrase “fuel_efficiency” and identifies the vehicle make and model retrieved from the manifest 442. For example, a reported emissions dataset 461 with a data field name “Freightliner_Columbia_2007_fuel_efficiency” and a data field value of “6.2” may indicate the fuel efficiency for the 2007 Columbia Freightliner truck is 6.2 miles per gallon. The transparent GHG emissions validation and reporting service system in an embodiment may use these retrieved values for “Freightliner_Columbia_2007_fuel_efficiency,” and “silicon_manifest_date_mileage” to generate and store within the global data repository 460 a data field name “Transport_fuel_perManifest” having a data field value of 161.3 gallons of fuel. The transparent GHG emissions validation and reporting service system may only retrieve blockchain verified data and may ensure validation data is available to ensure reporting transparency.

The following customized equation may describe the proportion of the entire shipment that comprised silicon, as determined with reference to material manifest 423 describing that transport:

$$[ Manifest\_Date \_Silicon \_shipment \_Ratio ] = \frac{[ Silicon \_UID \_QTY ]}{[ Total \_QTY ]} \qquad ( 8 b )$$

The transparent GHG emissions validation and reporting service system may query the materials accounting database 411 to determine the UID (e.g., “1234”) associated with the material “silicon.” The same material manifest 423 referenced with respect to equation (7b) above may then be queried by the transparent GHG emissions validation and reporting service system to determine a quantity of silicon in that shipment (e.g., in pounds) and a quantity of all materials within that shipment (e.g., including but not limited to the silicon). For example, the manifest 423 may include a data field name “UID_1234_QTY” having a data field value of 1,000 pounds, a data field name “Total_QTY” having a data field value of 3,000 pounds.

This process may be repeated for all equations pertaining to transport between all entities within the supply chain in an embodiment. As described with respect to FIG. 7, at block 708, each entity within the supply chain may provide similar equations for transportation of raw materials or subcomponents used in the manufacture of their respective end products. For example, a manufacturer of CPUs may provide equation (5c) for determination of a data field name “transport_CO2_perCPU_PMfg” having a data field value indicating carbon dioxide emitted during transport of silver and copper for manufacture of a single CPU. As another example, a manufacturer of a motherboard may provide equation (5d) for determination of a data field name “transport_CO2_perMBD_PMfg” having a data field value indicating a carbon dioxide emitted during transport of RAM and CPUs for manufacture of a single motherboard. As can be seen the variables within equation (5d) may include the product or output for equations (5b) and (5c). In other words, gathering data according to equation (5d) on behalf of the motherboard manufacturer may require accessing data (e.g., determinations made according to equation (5b)) generated by the transparent GHG emissions validation and reporting service system on behalf of the RAM manufacturer. In such an embodiment, the product or output from other parties within the supply chain may be stored within the global data repository 460 as reported emissions 461.

As described in an embodiment with respect to FIG. 3, the DBMS control platform 350 in an embodiment may also store metadata associated with such customized equations (e.g., customized for use by the memory manufacturer) that identify the generic or generalized equation (e.g., 5(a) generally describing variables needed to determine GHG emitted during manufacture of a product due to transportation) upon which the customized equation was based. This may enable the DBMS control platform 350 to compare GHG emissions determined using data from one entity to the same GHG emissions determined from previous reporting from that one entity or by using data from another entity, to make sure all entities are reporting accurately. For example, information regarding shipment times, distances, and fuel consumption used to determine GHG emissions during transport of raw materials to an end product manufacturer may be drawn from a manifest controlled by the materials supplier DBMS 321 and from another manifest controlled by the product manufacturer DBMS 331. Because both manifests describe the same trip, the data values gathered from these two manifests, and equations for calculating the same GHG emissions (e.g., CO2 emitted during transport of raw materials) should match within some variance. However, a raw materials supplier attempting to artificially deflate its GHG emissions may alter the data within the manifest controlled by the supplier DBMS 321, for example. In such a case, or in any case where data values from two separate sources do not match, the transparent GHG emissions validation and reporting service system operating at the DBMS control platform 350 may report this mismatch and identify the data field values that do not match and their time of entry, as well as the entities (e.g., employee name) within the attached validation data that provided the mismatched information. In such a way, the transparent GHG emissions validation and reporting service system and the DBMS control platform in an embodiment may gather from multiple entities within the supply chain and verify the authenticity of data and provide validation of that data used to determine GHG emissions generated during manufacture of a specific subcomponent or end product, while preventing tampering or misreporting.

The transparent GHG emissions validation and reporting service system in an embodiment may convert the transportation values to GHG emissions units for GHG emissions attributable to transportation at block 810. The transparent GHG emissions validation and reporting service system may access a stored equation (e.g., 470) for converting the proportion of fuel or electricity consumed during transport that is attributable to a single unit of RAM (e.g., as described directly above) to various GHG emissions, such as CO2 and methane.

For example, in an embodiment described with reference to FIG. 4, in which the memory manufacturer (e.g., 241A from FIG. 2) is the manufacturer 430, the transparent GHG emissions validation and reporting service system in such an embodiment may use equation (10) above, and retrieved values for data field names “silicon_manifest_date_mileage,” and “vehicle_make_model_fuel_efficiency” to store a new dataset having the data field name “transport_fuel_perManifest,” associated with the date of the manifest, as reported emissions 461 and having a data field value of 161.3 gallons of fuel. The transparent GHG emissions validation and reporting service system in such an embodiment may use equation (11) above, and retrieved values for data field names “silicon_UID_QTY,” and “TOTAL_QTY” to store a new dataset having the data field name “Manifest_Date_Silicon_Shipment_Ratio,” associated with the date of the manifest, as reported emissions 461 and having a data field value of one third. In such an embodiment, the transparent GHG emissions validation and reporting service system may also use these stored values for “Transport_fuel_perManifest,” “Manifest_date_Silicon_Shipment_Ratio,” and “EPA_CO2_Fuel_Conversion” to create a new dataset for storage as reported emissions 461 with a data field name “transport_CO2_perSilicon_SSupp” having a data field value of 1203.3 pounds of CO2.

At block 812, the transparent GHG emissions validation and reporting service system in an embodiment may retrieve records indicating waste generation for the user-specified manufacturer, product, subcomponent, plant, supplier, or customer. As described above with reference to block 802, the transparent GHG emissions validation and reporting service system in an embodiment may retrieve all equations matching the reporting query parameters received via the GUI and the query and reporting user interface.

In an embodiment described with reference to FIG. 4, in which the memory manufacturer (e.g., 241A from FIG. 2) is the manufacturer 430, the transparent GHG emissions validation and reporting service system in such an embodiment may retrieve, for example, the GHG emission equation 470 for determining the direct GHG emissions value for generation of waste:

$$[ Waste \_CO 2 \_perRAM \_MMfg ] = \frac{[ EPA\_CO 2 \_perLB \_Wprovider ] * [ Lb\_ Waste ]}{[ RAM\_ output ]} \qquad ( 9 b )$$

For example, in an embodiment described with reference to FIG. 4, in which manufacturer 430 is a memory manufacturer, the transparent GHG emissions validation and reporting service system in an embodiment may query plant utility bills 436 to retrieve a data field set containing the data field name “Lb_waste” and the data field value “1000” to indicate that the facility manufacturing RAM generated 1000 pounds of waste. As described above with respect to FIG. 7 at blocks 716-720, only data that has been blockchain verified may be accessible during such a query. Again, such a query may only retrieve blockchain verified data and may ensure validation data is available with reported data. Data gathered from each of the subcomponent manufacturers may include immutable blockchain information ensuring the data has not been tampered with or misreported, or, if the data has been tampered with or misreported, providing a simple method of identifying the time and identity of the person or entity attempting to tamper with the data or providing errant data.

The transparent GHG emissions validation and reporting service system in an embodiment may query the product accounting database 434 in an embodiment to retrieve a data field set containing the data field name “RAM_output” and the data field value “1000” to indicate that the plant manufactured 1000 RAM units. The transparent GHG emissions validation and reporting service system in an embodiment described with reference to FIG. 3 may use tool 310 to determine that waste management company disposing of waste from a RAM manufacturer generates 451 pounds of CO2 during disposal of one pound of waste. This process may be repeated to determine GHG emissions due to generation of waste by other manufacturers, on a per product basis, for other products manufactured by those manufacturers.

The transparent GHG emissions validation and reporting service system in an embodiment may convert waste generation values to GHG emission units for GHG emissions attributable to waste generation at block 814. The transparent GHG emissions validation and reporting service system in an embodiment may enter the data field values associated with the data field names given within each retrieved equation (e.g., as described with reference to block 802 above) into each equation in order to determine a GHG emission value associated with generation of waste. For example, in an embodiment in which the transparent GHG emissions validation and reporting service system has retrieved customized equation (9b) for carbon dioxide emissions due to generation of waste during manufacture of a single RAM unit, the transparent GHG emissions validation and reporting service system may enter the data field value of 451 as the value of the variable “EPA_CO2_perLB_Wprovider” describing the GHG emissions per pound of solid waste stored, as reported to the EPA from the waste management company for the memory manufacturing plant into equation (9b). As another example, the transparent GHG emissions validation and reporting service system may enter the data field value of 1,000 as the value of the variable “Lb_waste” describing the pounds of waste generated, and may enter the data field value of 1,000 as the value of the variable “RAM_output” identifying the number of RAM units manufactured during the reporting time period. As described above with respect to FIG. 7 at blocks 716-720, only data that has been blockchain verified may be accessible during such a query. Again, such a query may only retrieve blockchain verified data and may ensure validation data is available with reported data. Data gathered from each of the subcomponent manufacturers may include immutable blockchain information ensuring the data has not been tampered with or misreported, or, if the data has been tampered with or misreported, providing a simple method of identifying the time and identity of the person or entity attempting to tamper with the data or providing errant data.

Using equation (9b) and each of these variable values, the transparent GHG emissions validation and reporting service system in such an embodiment may determine that 451 pounds of carbon dioxide were generated during the manufacture of each unit of RAM due to generation of waste. The transparent GHG emissions validation and reporting service system may then store a data field value of 451 associated with the data field name “Waste_CO2_perRAM_MMfg” and associated with the date upon which all supporting datasets were gathered. This determined and stored carbon dioxide emissions value per RAM unit produced due to production of waste may be stored in an embodiment described with reference to FIG. 4 as a reported emission 461, for example.

In other embodiments, the transparent GHG emissions validation and reporting service system may perform this process for other manufacturers (e.g., motherboard manufacturer 241B, display manufacturer 241C, or computer manufacturer 241D in FIG. 2). In still other embodiments, the transparent GHG emissions validation and reporting service system may perform this process for other products (e.g., CPU 244, motherboard 243, thin-film transistor (TFT) 246A, liquid crystal layer (LCL) 246B, liquid crystal display (LCD) screen 247A, organic light-emitting diode (OLED) screen 247B, laptop 248A or tablet 248B in FIG. 2A).

At block 816, the transparent GHG emissions validation and reporting service system in an embodiment may retrieve records indicating generation of GHG due to chemical/metal/mineral manufacturing over the determined reporting time period for the user-specified manufacturer, product, subcomponent, plant, supplier, or customer. For example, in an embodiment described with reference to FIG. 4, in which the product manufacturer 430 is a display manufacturer of TFTs, the display manufacturer may provide the following equation for the GHG emissions generated during chemical etching of TFTs:

[Etching_CO2e_perTFT_DMfg]={[PFC_Sensor_Value]*[EPA_PFC_CO2e]}+{[HFC_Sensor_Value]*[EPA_HFC_CO2e]} (10b)

This equation may describe a value of carbon dioxide gases that is equivalent to actually observed emissions of perfluorocarbons (PFCs) and hydroperfluorocarbons (HFCs) during chemical etching, for example. More specifically, the transparent GHG emissions validation and reporting service system in an embodiment may retrieve datasets from supplier sensor readings 414 having a data field name of “PFC_sensor_value” and a data field value of 6 kg, and having a data field name of “HFC_sensor_value” and a data field value of 1 kg. The transparent GHG emissions validation and reporting service system in an embodiment may also retrieve datasets from stored in GHG emissions equations 470 having data field name “EPA_PFC_CO2e” and a data field value of 0.044 kg PFC per ton of carbon dioxide, and a data field name “EPA_HFC_CO2e” and a data field value of 0.068. The transparent GHG emissions validation and reporting service system in an embodiment may then generate a new dataset having a data field name “Etching_CO2e_perTFT_DMfg” and a value of 0.332 tons of carbon dioxide, and store this dataset within reported emissions 461 for the display manufacturer generating TFTs.

In an embodiment, the transparent GHG emissions validation and reporting service system in an embodiment may retrieve records indicating indirect industry GHG emissions at block 818. As described above with reference to block 802, the transparent GHG emissions validation and reporting service system in an embodiment may retrieve all equations matching the reporting query parameters received via the GUI and the query and reporting user interface.

In an embodiment described with reference to FIG. 4, in which the memory manufacturer (e.g., 241A from FIG. 2) is the manufacturer 430, the transparent GHG emissions validation and reporting service system in such an embodiment may retrieve, for example, the GHG emission equation 470 for determining the indirect GHG emissions value for manufacture of raw materials or subcomponents incorporated within an end product. For example, in an embodiment described with reference to FIG. 4 in which manufacturer 430 is a memory manufacturer, the memory manufacturer may provide the following equation for determination of indirect emissions:

$$[ Indirect \_CO 2 \_perRAM \_MMfg ] = \frac{[ EPA\_CO 2 \_SSupp ]}{[ Silicon\_output ]} * [ Silicon \_RAM \_ Ratio ] \qquad ( 11 b )$$

The transparent GHG emissions validation and reporting service system in an embodiment may query a regulatory reporting agency tool (e.g., 310 in FIG. 3) to determine carbon dioxide emissions reported to the EPA by the raw materials supplier (e.g., Silicon Supplier “SSupp”) having a value of 20,000 pounds. The transparent GHG emissions validation and reporting service system in such an embodiment may retrieve the name of the Silicon supplier (or other raw materials provider) in such an embodiment by referencing the supplier contact/address 431, for example. A data field value of 10,000 lbs for the data field name “Silicon_output” may retrieved by the transparent GHG emissions validation and reporting service system from the material accounting database 411, and a data field value of 2 oz. for the data field name “Silicon_RAM_Ratio” may be retrieved from the product accounting database 434 for the memory manufacturer 430. The transparent GHG emissions validation and reporting service system in an embodiment may generate and store within reported emissions 461 for the memory manufacturer a new dataset having a data field name “Indirect_CO2_perRAM_MMfg” and a data field value of 0.25 pounds of CO2.

In other embodiments, a product manufacturer may incorporate a plurality of subcomponents into a final product. For example, a motherboard manufacturer may incorporate one or more RAM units and one or more CPUs into a single motherboard. In such an embodiment, the motherboard manufacturer may provide the following equation for determination of indirect GHG emissions generated during the manufacture of the RAM and CPUs incorporated into each motherboard:

[Indirect_CO2_perMBD_PMfg]={[Distributed_CO2_perRAM_MMfg]*[RAM_MBD_Ratio]}+{[Distributed_CO2_perCPU_MMfg]*[CPU_MBD_Ratio]} (11d)

As can be seen with reference to equation (11d), determination of indirect emissions for each motherboard manufactured may be determined using stored values for determinations made using the equations (e.g., 11b and 11c above) provided by other entities in the supply chain that supply subcomponents (e.g., RAM, CPU) to the end product manufacturer (e.g., motherboard manufacturer). More specifically, the transparent GHG emissions validation and reporting service system in such an embodiment may retrieve a data field value having data field name “Distributed_CO2_perRAM_MMfg,” stored as a reported emission 461 by the transparent GHG emissions validation and reporting service system on behalf of the memory manufacturer.

At block 820, the transparent GHG emissions validation and reporting service system in an embodiment may determine a distributed GHG emissions value for each product manufactured in the supply chain. For example, in an embodiment described with reference to FIG. 4, in which the product manufacturer 430 is a memory manufacturer, the memory manufacturer may provide the following equation for determination of distributed carbon dioxide emissions generated during manufacture of a single unit of RAM:

[Distributed_CO2_perRAM_MMfg]=[Electricity_CO2_perRAM_MMfg]+[H2O_CO2_perRAM_MMfg]+[LNGPET_CO2_perRAM_MMfg]+[Transport_CO2_perRAM_MMfg]+[Waste_CO2_perRAM_MMfg]+[Indirect_CO2_perRAM_MMfg] (2b)

As described above with respect to blocks 806, 810, 814, and 816, the transparent GHG emissions validation and reporting service system in an embodiment may have stored within reported emissions 461, values for the data field names “Electricity_CO2_perRAM_MMfg,” “H2O_CO2_perRAM_MMfg,” “LNGPET_CO2_perRAM_MMfg,” “Waste_CO2_perRAM_MMfg,” “Transport_CO2_perRAM_MMfg,” and “Indirect_CO2_perRAM_MMfg.” In other embodiments, such as when the product manufacturer is manufacturing TFTs, this equation may also include a value for “Etching_CO2e_perTFT,” as described with reference to block 818, above. The transparent GHG emissions validation and reporting service system in an embodiment may insert each of those values as stored at 461 and referenced by equation (2b) above, to find a determined GHG emissions value attributable to the manufacture of a single unit of RAM. This process may be repeated for each product for which the manufacturer has provided such an equation in an embodiment.

As described in an embodiment with respect to FIG. 3, the DBMS control platform 350 in an embodiment may store metadata associated with such customized equations (e.g., 2(b) customized for use by the memory manufacturer) that identify the generic or generalized equation (e.g., 2(a) generally describing variables needed to determine GHG emitted during manufacture of a product unit) upon which the customized equation was based. This may enable the DBMS control platform 350 to compare GHG emissions determined using data from one entity to the same GHG emissions determined using data from another entity, to make sure all entities are reporting accurately. Further, any data gathered pursuant to inclusion of that data as a variable within a customized equation in an embodiment be required to have attached validation data and to be verified through immutable blockchain metadata confirming accuracy and transparency of such data across multiple entities of the supply chain. The method for retrieving information from each entity within a supply chain for an end product and determining GHG emissions generated pursuant to manufacture of that product may then end.

FIG. 9 is a flow diagram illustrating a method of reporting information from each entity within a supply chain for an end product necessary to determine GHG emissions generated pursuant to manufacture of that product for consumers according to an embodiment of the present disclosure. As described herein, the transparent GHG emissions validation and reporting service system and the DBMS control platform in embodiments described herein may report to multiple entities within the supply chain GHG emissions generated during manufacture of a specific subcomponent or end product, while verifying the security of the underlying data and determining validity of such data gathered and used to determine such GHG emissions.

At block 902, a user of the transparent GHG emissions validation and reporting service system may log into a query and reporting user interface of the DBMS platform. As described above at block 702, each user of the transparent GHG emissions validation and reporting service system in an embodiment may agree to a blockchain license setting out permissions for several entities within a supply chain to access data owned, maintained, and controlled by a single entity. For example, such an agreement may limit access by the DBMS control platform to data records likely or known to be necessary in determination of GHG emissions for a single product, as identified by equations supplied by each entity (e.g., as described with respect to blocks 704, 706, 708, and 710). Each entity may further restrict the ability of other entities to edit or update any such data stored at the global data repository 360. For example, the supplier of raw materials may disallow product manufacturers or consumers from editing or updating any data gathered from the supplier DBMS 321 and stored at the global data repository 360, even though such product manufacturers or consumers may have other limited access to such data stored at the global data repository 360. In such an embodiment, one or more blockchains may be used with limitations on access keys provided to the blockchain or blockchains with containing GHG reporting data for example.

Such an agreement may further define which of the entities within the supply chain may query such gathered data or reported emissions determined using such data. For example, an entity (e.g., supplier of raw materials and owner of supplier DBMS 321) may preset authorization for storage of certain pre-identified data records known to be necessary in determination of GHG emissions at the global data repository 360, but may limit the parties capable of querying data attributable to the supplier within the global data repository 360. In another aspect of an embodiment, each supply chain entity may further restrict the type of information returned pursuant to such a query of the global data repository 360.

As another aspect of such a blockchain agreement in an embodiment, each of the entities in control of these DBMS s (e.g., 321, 331, and 341) in an embodiment may agree to a local data validation requiring each data field value identified by any entity as a value upon which GHG emissions may be determined (e.g., as described above with reference to equations (1a) and (1b)) to be associated with a valid e-signature or other identifying process that can particularly identify specific personnel entering such data. The transparent GHG emissions validation and reporting service system in an embodiment may only store data field values associated with the data field name provided by the supply chain entity as potentially useful in determination of GHG gases if that value passes blockchain verification, as described in greater detail above with respect to FIG. 7 at blocks 716-720. Again, such a query may only retrieve blockchain verified data and may ensure validation data is available with reported data. Data gathered from each of the subcomponent manufacturers may include immutable blockchain information ensuring the data has not been tampered with or misreported, or, if the data has been tampered with or misreported, providing a simple method of identifying the time and identity of the person or entity attempting to tamper with the data or providing errant data. Any data field values not passing such a blockchain verification may be discarded, while data field values that can be verified may be stored within the global data repository 360. Additionally, should any data field values fail to pass blockchain verification, the DBMS control platform 350 in an embodiment may notify any entity that has identified this data field as necessary to determine GHG emissions that the data field value has been discarded for failure to meet blockchain verification. Because the blockchain for such a discarded data field value contains an identification of the person or entity that entered the erroneous data, the DBMS control platform 350 in such an embodiment may further identify each entity of the source of the erroneous data.

The transparent GHG emissions and validation reporting service system in an embodiment may ensure that the user requesting a GHG emissions report receives only data to which it has been granted access according to such agreements. For example, in an embodiment described with reference to FIG. 3, an authorization control component 351 may refer to stored preset authorizations agreed upon by each of the DBMS control platform 350 users (e.g., multiple entities within the supply chain for a single end product) within a blockchain licensing agreement. The authorization control component 351 in such an embodiment may limit query responses (e.g., to queries received via the query and reporting user interface 390) to data stored within the global data repository 360 to which the querying user has been previously granted access via the blockchain licensing agreement. As described directly above, any data stored within the global data repository 360 and accessible through such a query may have previously been validated using blockchain verification. In such a way, the DBMS control platform 350 in an embodiment may report to multiple entities within the supply chain GHG emissions generated during manufacture of a specific subcomponent or end product, while ensuring security of the underlying data used to determine such GHG emissions.

The user in an embodiment may specify a type of GHGs to report, a reporting time period, and select a graphical user interface (GUI) reporting view at block 904. For example, in an embodiment described with reference to FIG. 5A, a user of GUI 501 may use pull-down menu 502 to select a reporting time period 506 of the manufacturing life cycle for a product. In another example, a user may use pull-down menu 510 to select carbon dioxide 514 as the GHG for reporting, and use pull-down menu 520 for selection of the timeline view 522 for reporting. In still other examples, a user may select only a portion of a manufacturing life cycle for a product. For example, a user may choose to exclude any portion of the manufacturing life cycle prior to the subcomponent or product manufacturing sector (e.g., excluding raw materials extraction, refinement, and transport). As another example, a user may choose to view GHG emissions occurring in the supply chain prior to their receipt of raw materials or subcomponents that user will later incorporate into a final product. As yet another example, a user may choose to view GHG emissions excluding transport of a final product (e.g., laptop) to an end consumer.

In an embodiment in which the user has selected the manufacturing life cycle for an end product as the reporting time period via the GUI, the transparent GHG emissions validation and reporting service system may determine the manufacturing life cycle for the user-specified end product. For example, as described with reference to FIG. 5A, the user in an embodiment may use GUI 501 to select the manufacturing life cycle 506 for a product as the reporting time period. In such an example embodiment, the user may be prompted to select a specific end product. For example, in an embodiment described with reference to FIG. 5B, the user may use GUI 507 to select laptop 594 as the product whose manufacturing GHG emissions the user would like to view.

Based on this user-specified information, the transparent GHG emissions validation and reporting service system may then access data stored within the global data repository to trace each step of the supply chain, as selected in an embodiment, contributing to manufacture of the user-specified laptop in order to identify a beginning date for the manufacturing life cycle of the product. For example, in an embodiment described with reference to FIG. 2A, the transparent GHG emissions validation and reporting service system may determine the laptop 248A was manufactured by incorporating OLED screen 247B and motherboard 243, which respectively further incorporated thin film transistor (TFT) 246A and random access memory (RAM) 242 and CPU 244. The transparent GHG emissions validation and reporting service system may also determine the RAM 242 was manufacturing using silicon 226 from silicon supplier 221B, the CPU 244 was made using copper 225 and silver 224 from minerals supplier 221A, and the TFT 246A was made using copper 225 and gold 223 from minerals supplier 221A. The transparent GHG emissions validation and reporting service system in such an embodiment may then determine the earliest recorded date for any manufacturing, extraction, refinement, or chemical production processes relating to the gold 223, silver 224, copper 225, or silicon 226, where applicable. This may identify the beginning of the reporting time period for the manufacturing life cycle of laptop 241A.

These determinations may be made in an embodiment with reference to data stored within the global data repository, as described in greater detail with respect to FIG. 4, above. For example, the transparent GHG emissions validation and reporting service system in an embodiment may determine the date of shipment of the user-specified laptop by referencing a product tracking order 441 or a product shipping label 442. The transparent GHG emissions validation and reporting service system may then identify each of the components or even raw materials incorporated within the user-specified laptop by referencing the product/part list 435. The specific transport load of raw materials used in the manufacture of each component of the laptop in an embodiment may then be determined by the transparent GHG emissions validation and reporting service system with reference to materials order 421, materials invoice 422, material manifest forms 423, or material shipping/tracking order 424, for example.

At block 906, the transparent GHG emissions validation and reporting service system may determine whether the user has selected one or more filters to narrow the reporting of GHG emissions to a specific supplier, manufacturer, customer, subcomponent, product, or facility in an embodiment. For example, in an embodiment described with reference to FIG. 5B, the user of GUI 507 may use drop-down menu 540 to filter results to only include GHG emissions by plastics corporation 544. As another example, the user of GUI 507 may use drop-down menu 550 to filter results to only include GHG emissions for manufacturing of silicon 554. In another example, the user of GUI 507 may use drop-down menu 560 to filter results to only include GHG emissions by the U.S. Government 563 pursuant to purchase of end products. In still another example, the user of GUI 507 may use drop-down menu 570 to filter results to only include GHG emissions by the Austin manufacturing plant 572. As yet another example, the user of GUI 507 may use drop-down menu 580 to filter results to only include GHG emissions for the manufacture of OLED screen 585. In still another example, the user of GUI 507 may use drop-down menu 590 to filter results to only include GHG emissions in the manufacture of laptop 594. If the user has selected a filter to narrow the reporting of GHG emissions, the method may proceed to block 908 for retrieval of data field values from the global data repository matching the filter settings provided by the user. If the user has not selected a filter to narrow the reporting of GHG emissions, the method may proceed to block 910 for determination of the reporting view selected by the user for display of GHG emissions by the user, as a default report.

In an embodiment when the user has selected a filter to narrow the reporting of GHG emissions at block 906, the transparent GHG emissions validation and reporting service system may retrieve query results from the global data repository for user-specified GHG emissions the user is authorized to view that also match the filter requirements at block 908. Again, such a query may only return data meeting blockchain verification as well as having attached validation data from the reporting data source, as described in greater detail with respect to blocks 716-720. The data gathering query parameters in an embodiment may associate information input into a GUI via a DBMS control platform user with one or more reported emissions stored within the global data repository in an embodiment. For example, as described in an embodiment with respect to FIG. 3, the query and reporting user interface 390 may receive user-specified query parameters for reporting of GHG emissions determined based on data stored within the global data repository 360 via communication with the GUI 391. Further, as described with reference to FIG. 8, the transparent GHG emissions validation and reporting service system in an embodiment may routinely gather all data necessary to make such determinations, and store reported emissions values determined based on such gathered data and user-specified GHG emissions equations in the global data repository.

Upon receipt of query parameters matching the user selections given in blocks 902 and 904, above, the transparent GHG emissions validation and reporting service system in an embodiment may retrieve one or more of these stored reported emissions values, determined based on blockchain verified underlying data and having attached validation data identifying reporting data sources for transparency. For example, in an embodiment described with reference to FIG. 4, in which a user has selected CO2 emissions during the manufacture of a single unit of RAM, the transparent GHG emissions validation and reporting service system may query the global data repository 460 to retrieve a dataset having a data field name “Distributed_CO2_perRAM_MMfg,” as generated and stored as a reported emission 461 (e.g., as described in greater detail above with respect to FIG. 8 at block 820. The method may then proceed to block 910 to determine the reporting view the user has selected for display of the results of the query from block 908.

At block 910, in an embodiment in which the transparent GHG emissions validation and reporting service system has retrieved data from the global data repository describing GHG emissions (e.g., either filtered as described at block 908 or reported in a default mode), the transparent GHG emissions validation and reporting service system may determine the reporting view selected by the user at block 910. For example, the transparent GHG emissions validation and reporting service system in an embodiment described with reference to FIG. 5A may determine whether the user of GUI 501 has chosen the pie chart view 521, the timeline view 522, the network view 523, or the map view 524. If the user has selected the pie chart reporting view, the method may proceed to block 912 for display of GHG emissions broken down into segments of a pie chart. If the user has selected the network view, the method may proceed to block 914 for display of GHG emissions illustrating relationships between each entity within the supply chain. If the user has selected the timeline view, the method may proceed to block 916 for display of GHG emissions over the user-specified reporting time period. If the user has selected the map view, the method may proceed to block 918 to display GHG emissions in a geographical map view.

At block 912, in an embodiment in which the user has selected the pie chart reporting view, the transparent GHG emissions validation and reporting service system may display GHG emissions in a pie chart view, segmented by resource consumption or activity performed to generate GHGs over the reporting time period. For example, in an embodiment described with reference to FIG. 6A, the transparent GHG emissions validation and reporting service system in an embodiment may display GHG emissions in a pie chart view, segmented into GHG emissions due to electricity consumption 631, transportation 632, indirect emissions 633, water consumption 634, natural gas or petroleum consumption 634, waste generation 635, chemical processes 637, and materials extraction/refinement 638. The method for gathering and verifying information from each entity within a supply chain for an end product necessary to determine GHG emissions may then end.

In an embodiment in which the user has selected the network view, the transparent GHG emissions validation and reporting service system may display GHG emissions illustrating relationships between each entity within the supply chain at block 914. For example, in an embodiment described with reference to FIG. 6B, the transparent GHG emissions validation and reporting service system in an embodiment may map the cumulative GHG emissions for dates of manufacture of a product in the timeline view 640. More specifically, the timeline view 640 in an embodiment in which reporting has been requested for GHGs emitted during manufacture of a specific product for a specific consumer may indicate GHGs emitted during extraction and refinement of a raw material between January of 2021 and April of 2021, and further GHGs emitted during transportation of that raw material to an end product manufacturer between April of 2021 and July 2021. The timeline view 640 in such an example embodiment may also include further GHGs emitted during manufacture of the end product between July of 2021 and October of 2021, and transportation of that end product to the end consumer between October 2021 and January of 2022. The method for reporting information from each entity within a supply chain for an end product necessary to determine GHG emissions generated pursuant to manufacture of that product may then end.

In an embodiment in which the user has selected the timeline view, the transparent GHG emissions validation and reporting service system may display GHG emissions over the reporting time period according to any filter requirements applied by the user at block 916. For example, in an embodiment described with reference to FIG. 6C, the transparent GHG emissions validation and reporting service system in an embodiment may determine the raw materials, subcomponents, or products shipped between various entities within the supply chain. The network view 650 in an embodiment may illustrate the trade relationship between each of these various entities within the supply chain. The network view 650 may further indicate the volume of GHGs emitted by each of the entities within the supply chain and shown in the network view 650 by increasing or decreasing the size of the label for that entity. The method for gathering and verifying information from each entity within a supply chain for an end product necessary to determine GHG emissions may then end.

At block 918, in an embodiment in which the user has selected the map view, the transparent GHG emissions validation and reporting service system may display GHG emissions in a geographical map view illustrating locations of each entity within the supply chain. For example, in an embodiment described with reference to FIG. 6D, the map view 650 in an embodiment may also illustrate the trade relationship between each of these various entities within the supply chain, as well as their geographic locations with respect to one another. Like the network view described above with reference to FIG. 6C, the map view 660 may further indicate the volume of GHGs emitted by each of the entities within the supply chain as shown by increasing or decreasing the size of the label for that entity. The method for gathering and verifying information from each entity within a supply chain for an end product necessary to determine GHG emissions may then end.

The blocks of the flow diagrams of FIGS. 7, 8, and 9 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another may communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A transparent greenhouse gas (GHG) emissions validation and reporting service system for an information handling system of a database management control platform comprising:
a network interface device receiving, from a first platform user, a first data field value associated with a data field name within a stored GHG emission equation;
a processor executing code instructions of the transparent GHG emissions validation and reporting service system to:
confirm the first data field value includes attached validation data to identify a data reporting source from within a manufacturing facility or a supply chain for an end-product;
verify a secure source and chain of possession for the first data field value;
store the first data field value and data field name in a database repository;
determine an overall GHG emission value describing GHG emissions from a manufacturing facility over a user-specified reporting period based on the first data field value among a plurality of data field values, and the GHG emission equation;
determine a distributed GHG emission value describing GHG emitted during manufacture of an end-product at the manufacturing facility for end-user consumption, based on the overall GHG emission value and a number of the end-products manufactured over a period of time in which the first data field value was recorded by the first platform user; and
a graphical user interface (GUI) displaying the distributed GHG emission value for an end-product of a plurality of end-products.

2. The information handling system of claim 1 further comprising:
processor executing code instructions of the transparent GHG emissions validation and reporting service system to determine a distributed GHG emission value describing GHG emitted during manufacture of the end-product at the manufacturing facility based on the overall GHG emission value and a number of the end-products manufactured over a period of time in which a plurality of data field values were recorded by a plurality of platform users within the supply chain.

3. The information handling system of claim 1 further comprising:
the GUI receiving a query from one of a group of platform users that includes the first platform user identifying the end-product and the GHG.

4. The information handling system of claim 1 further comprising:
the processor executing code instructions of the transparent GHG emissions validation and reporting service system to allow a previously authorized group of platform users that includes the first platform user to perform a query of the first data field value for determination of the distributed GHG emission value.

5. The information handling system of claim 1 further comprising:
the processor executing code instructions of the transparent GHG emissions validation and reporting service system to display the distributed GHG emission value determined based on the first data field value to a previously authorized group of platform users that includes the first platform user.

6. The information handling system of claim 1, wherein the GUI displays the distributed GHG emission value in a pie chart format that identifies a portion of the distributed GHG emission value attributable to electricity consumed during manufacture of the end-product.

7. The information handling system of claim 1, wherein the GUI displays the distributed GHG emission value in a pie chart format that identifies a portion of the distributed GHG emission value attributable to transportation of the end-product to an end consumer.

8. The information handling system of claim 1, wherein the GUI displays the distributed GHG emission value in a timeline format showing greenhouse gases emitted over the time of manufacture and transport of the end-product.

9. A method of reporting greenhouse gas emissions based on transparently gathered and verified data comprising:
receiving a query, via a graphical user interface (GUI), identifying an end-product for end-user consumption, a reporting period, and a type of greenhouse gas emission (GHG);
retrieving from a database repository, via a query and reporting user interface, an overall GHG emission value determined based on a GHG emission equation and a plurality of data field values of GHG emission values from a manufacturing facility of the end-product and from at least one supply chain provider to the manufacturing facility, where at least a portion of the plurality of data field values has attached validation data to identify a data reporting source of the data field values and the data field values have a secure source and chain of possession as verified by a database management system (DBMS) platform orchestrating access to the database repository;
determining, via a processor, a distributed GHG emission value describing GHG emitted during manufacture of the end-product, based on the overall GHG emission value for the manufacturing facility that manufactures the end-product over the reporting period and a number of the end-products manufactured over a period of time in which each of the plurality of data field values were stored at the database repository; and
displaying the distributed GHG emission value via the GUI.

10. The method of claim 9 further comprising:
receiving the plurality of data field values, each associated with a data field name identified within a stored GHG emission equation; and
storing the plurality of data field values in the database repository.

11. The method of claim 9 further comprising:
verifying that the plurality of data field values have been received via a secure and authorized source, via an authorization controller of the DBMS platform confirming receipt from a platform user of a digital token previously issued to the platform user.

12. The method of claim 9 further comprising:
verifying that the plurality of data field values have not been manipulated by unauthorized sources, via a blockchain controller of the DBMS platform confirming conformity of time stamps within blockchains for each of the plurality of data field values.

13. The method of claim 9 further comprising:
displaying the distributed GHG emission value in a network format showing a proportion of overall GHG emissions emitted by each of a plurality of entities operating within a supply chain to manufacture and transport the end-product to an end consumer, raw materials for manufacture of the end-product, and sub-components of the end-product.

14. The method of claim 9 further comprising:
displaying the distributed GHG emission value in a pie chart identifying a portion of the distributed GHG emission value attributable to consumption of petroleum products during manufacture of the end-product.

15. A transparent greenhouse gas (GHG) emissions validation and reporting service system for an information handling system of a database management control platform comprising:
a network interface device receiving, from a first platform user, a first data field value associated with a data field name within a stored GHG emission equation;
a processor executing code instructions of the transparent GHG emissions validation and reporting service system to:
confirm the first data field value includes attached validation data to identify a data reporting source from within a manufacturing facility or a supply chain for an end-product;
verify a secure source and chain of possession for the first data field value;
store the first data field value and data field name in a crowd-sourced database repository containing a plurality of data field values from a plurality of platform users that includes the first platform user;
receive a query from a second platform user, via a graphical user interface (GUI), identifying an end-product for end-user consumption, a reporting period, and a type of GHG, wherein the first and second platform users are entities involved in the supply chain for manufacture and transport of the end-product to the end-user;
retrieve the first data field value from the crowd-sourced database repository;
determine an overall GHG emission value for a manufacturing facility that manufactures the end-product, based on the first data field value, and the GHG emission equation;
determine a distributed GHG emission value describing GHG emitted during manufacture of the end-product, based on the overall GHG emission value and a number of the end-products manufactured over the reporting period in which the first data field value was recorded by the first platform user; and
the GUI displaying the distributed GHG emission value to the second platform user.

16. The information handling system of claim 15 further comprising:
the processor executing code instructions of the transparent GHG emissions validation and reporting service system to:
determine the second platform user does is not authorized to view the first data field value but is authorized to view the distributed GHG emission value determined based on the first data field value.

17. The information handling system of claim 15 further comprising:
the processor executing code instructions of the transparent GHG emissions validation and reporting service system to:
query the crowd-sourced database repository to identify a sub-component manufactured by the first platform user that is integrated into the end-product by the second platform user;
query the crowd-sourced database repository to determine a number of the sub-components manufactured by the first platform user over the reporting period;
determine a distributed indirect GHG emission value describing GHG emitted during manufacture of the sub-component, based on the overall GHG emission value and a number of the sub-component manufactured over the reporting period; and
the GUI displaying the distributed indirect GHG emission value to the second platform user.

18. The information handling system of claim 15, wherein the GUI displays the distributed GHG emission value in a pie chart format that identifies a portion of the distributed GHG emission value attributable to the manufacture of a chemical.

19. The information handling system of claim 15, wherein the GUI displays the distributed GHG emission value in a pie chart format that identifies a portion of the distributed GHG emission value attributable to the extraction of a raw material.

20. The information handling system of claim 15, wherein the GUI displays the distributed GHG emission value in a pie chart format that identifies a portion of the distributed GHG emission value attributable to indirect GHG emissions occurring at steps in the supply chain prior to manufacturing by second platform user, as determined through mandatory reporting to a governmental regulatory agency.
